(19) United States
(12) Patent Application Publication
(10) Pub. No.: US 2025/0274860 A1
(43) Pub. Date: Aug. 28, 2025

(54) COMMUNICATION METHOD, USER EQUIPMENT, NETWORK ENTITY, AND STORAGE MEDIUM

(71) Applicant: SAMSUNG ELECTRONICS CO., LTD., Suwon-si, Gyeonggi-do (KR)

(72) Inventors: Weiwei WANG, Beijing (CN); Hong WANG, Beijing (CN); Lixiang XU, Beijing (CN); Yanru WANG, Beijing (CN)

(21) Appl. No.: 18/864,372

(22) PCT Filed: May 9, 2023
(86) PCT No.: PCT/KR2023/006307

§ 371 Date: Nov. 8, 2024

(30) Foreign Application Priority Data
May 9, 2022 (CN) 202210502418.7
Aug. 30, 2022 (CN) 202211070424.6
Apr. 10, 2023 (CN) 202310376578.6

(51) Int. Cl. H04W 52/02

(52) U.S. Cl. CPC H04W 52/0225

(57) ABSTRACT

The disclosure relates to a 5G or 6G communication system for supporting a higher data transmission rate. Embodiments of the present application provide a communication method, a user equipment, a network entity, and a storage medium. The method comprises: by a UE, obtaining a first output result by inputting a first input parameter related to a to-be-monitored time unit into a first model; and determining, based on the first output result, whether to monitor a first signal transmitted by a network entity within the to-be-monitored time unit, wherein the method performed by a UE or a network entity may use an artificial intelligence model. The embodiments of the present application can enable a UE to effectively determine whether to monitor signals.

### TECHNICAL FIELD

The present application relates to the technical field of wireless communication, and in particular to a communication method, a user equipment (UE), a network entity, and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 preprocessing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In a wireless mobile communication system, the base station will notify the scheduled UE by signaling during the resource scheduling, and the UE determines whether to receive or transmit data according to the received signaling.

However, for a UE, it does not know when the base station will transmit the scheduling signaling and thus it needs to monitor signals all the time. This causes great energy consumption of the UE.

### DISCLOSURE OF INVENTION

### Technical Problem

The purpose of embodiments of the present application is to solve the problem of how to reduce energy consumption of UEs.

### Solution to Problem

In an aspect of the embodiments of the present application, provided is a method performed by a UE in a communication system, including:
obtaining a first output result by inputting a first input parameter related to a to-be-monitored time unit into a first model; and
determining, based on the first output result, whether to monitor a first signal transmitted by a network entity within the to-be-monitored time unit.
optionally, obtaining a first output result by inputting a first input parameter related to a to-be-monitored time unit into a first model includes:
obtaining a first output result respectively corresponding to at least one service, by respectively inputting the first input parameter related to the at least one service into the first model respectively corresponding to the at least one service;
determining, based on the first output result, whether to monitor a first signal transmitted by a network entity within the to-be-monitored time unit includes:
determining, based on the first output result respectively corresponding to the at least one service, whether to monitor the first signal within the to-be-monitored time unit.

Optionally, determining, based on the first output result respectively corresponding to the at least one service, whether to monitor a first signal transmitted by a network entity within the to-be-monitored time unit includes:
not monitoring the first signal within the to-be-monitored time unit, if the first output result respectively corresponding to the at least one service indicates not to monitor the first signal within the to-be-monitored time unit; and
otherwise, monitoring the first signal within the to-be-monitored time unit.

Optionally, the method further comprises:
obtaining the first model in at least one of the following ways:
training, based on collected first data set, to generate the first model; and
receiving the first model from a network entity.

Optionally, receiving the first model from a network entity, further includes:
receiving, a first message transmitted by the network entity, the first message comprising at least one of the following:
information related to models;
indication information of applicable services;
first assistant information, the first assistant information is used to assist the UE to generate an input parameter of the first model and/or to assist the UE to perform the first model;
indication information of applicable UEs;
fallback indication information;
indication information of applicable areas;
indication information of applicable rates;
activation indication information.

Optionally, receiving, from the network entity, the first model, including at least one of the followings:
receiving, from a network entity, the first model updated in a synchronous manner;
receiving, from a network entity, the first model updated in an asynchronous manner;
receiving, from a network entity, the directly updated first model.

Optionally, receiving, from a network entity, the first model updated in a synchronous manner includes at least one of the following situations:
periodically receiving, from a network entity, the first model updated in a synchronous manner; and
receiving, from a network entity, the first model updated in a synchronous manner, if the number of UEs for which the first model needs to be updated is greater than a first threshold value.

Optionally, receiving, from a network entity, the first model updated in an asynchronous manner includes:
receiving, from a network entity, the first model updated in an asynchronous manner, if the number of UEs for which the first model needs to be updated is not greater than a first threshold value when it is needed to update the first model.

Optionally, by at least one of the following information, it is determined that the first model needs to be updated:
a detection result of a network performance in using the first model and a second threshold value;
a detection result of the UE performance in using the first model and a third threshold value; and
the number of update times of the first model and a fourth threshold value.

Optionally, if it is to receive the first model from the network entity, the method further includes:
transmitting, to the network entity, information indicative of used first models and/or unused first models.
optionally, obtaining a first output result by inputting a first input parameter related to a to-be-monitored time unit into a first model includes:
in at least one of the following situations, obtaining a first output result by inputting a first input parameter related to a to-be-monitored time unit into a first model or requesting the first model from the network entity:
an occurrence ratio of a related signal is less than a fifth threshold value;
a potential energy saving by using the first model is greater than a sixth threshold value; and
an accuracy of the first model is greater than a seventh threshold value.
optionally, obtaining a first output result by inputting a first input parameter related to a to-be-monitored time unit into a first model includes:
obtaining a first output result by inputting a first input parameter related to a to-be-monitored time unit into a first model, if it is determined that there is no related signal that must be received.

The method further includes:
monitoring the first signal within the to-be-monitored time unit, if it is determined that there are related signals that must be received.

Optionally, if it is determined, based on the first output result, not to monitor a first signal transmitted by a network entity within the to-be-monitored time unit, the method further includes:
in at least one of the following situations, also monitoring the first signal within the to-be-monitored time unit:
the predetermined QoS is not satisfied; and
the number of times that the related signal is not received continuously is greater than an eighth threshold value.

Optionally, the first input parameter is obtained based on at least one of the following parameters:
channel state information;
QoS information;
indication information of actual performance;
indication information of predicted performance; and
indication information of network state.

Optionally, the first input parameter related to the to-be-monitored time unit includes at least one of the following:
accumulation rate related information;
a predicted accumulation rate;
scheduling probability indication related information;
non-scheduling indication related information;
QoS indication related information;
indication information of a service type;
indication information of predicated QoS.

Optionally, the accumulation rate related information includes an actual accumulation rate respectively corresponding to at least one time unit included in a first time window before the to-be-monitored time unit; and

Optionally, the actual accumulation rate in a time unit is determined in at least one of the following ways:
determining an actual average rate within a second time window, the second time window including a time unit and at least one time unit before the time unit, and using the actual average rate as the actual accumulation rate in a time unit; and
determining, based on an actual instantaneous rate respectively corresponding to at least one time unit included in a first time window, the smoothened actual accumulation rate respectively corresponding to at least one time unit included in the first time window, and using the smoothened actual accumulation rate corresponding to a time unit as the actual accumulation rate in a time unit.

Optionally, the predicted accumulation rate is determined based on the predicted maximum rate in the to-be-monitored time unit and/or the actual accumulation rate in a time unit before the to-be-monitored time unit.

In an aspect of the embodiments of the present application, provided is a method performed by a network entity in a communication system, including:
obtaining a second output result by inputting a second input parameter related to a to-be-monitored time unit of a first UE into a second model; and
determining, based on the second output result, whether to transmit a second signal to the first UE or whether to select a first UE for scheduling within the to-be-monitored time unit.

Optionally, the obtaining a second output result by inputting a second input parameter related to a first UE in a current time unit into a second model comprises at least one of the following situations:
obtaining a second output result respectively corresponding to at least one service, by respectively inputting the second input parameter related to the at least one service into the second model respectively corresponding to the at least one service; and
obtaining a second output result respectively corresponding to the at least one first UE, by respectively inputting the second input parameter related to the at least one first UE into the second model respectively corresponding to the at least one first UE;
the determining, based on the second output result, whether to transmit a signal to the first UE or whether to select a first UE for scheduling within the current time unit comprises at least one of the following situations:
determining, based on the second output result respectively corresponding to the at least one service, whether to transmit a signal to the first UE or whether to select a first UE for scheduling within a current time unit; and
determining, based on the second output result respectively corresponding to the at least one first UE, whether to transmit the signal to the at least one first UE or whether to select at least one first UE for scheduling within the current time unit.

Optionally, determining, based on the second output result respectively corresponding to the at least one service, whether to transmit the second signal to the first UE or whether to select a first UE for scheduling within the to-be-monitored time unit includes:
not transmitting the second signal to the first UE within the to-be-monitored time unit, if the second output result respectively corresponding to the at least one service indicates not to transmit the second signal to the first UE within the to-be-monitored time unit; otherwise, transmitting the second signal to the first UE within the to-be-monitored time unit, or,
if the second output result respectively corresponding to at least one service indicates not to select the first UE for scheduling, not selecting the first UE for scheduling within the to-be-monitored time unit; otherwise, selecting the first UE for scheduling within the to-be-monitored time unit.

Optionally, the method further includes at least one of the following operations:
training, based on collected second data set, to generate a second model; and
training, based on collected third data set, to generate a first model, and transmitting the first model to a second UE.

Optionally, transmitting the first model to a second UE further includes:
transmitting a first message to the second UE, the first message comprising at least one of the following:
information related to models;
indication information of applicable services;
first assistant information, the first assistant information is used to assist the UE to generate an input parameter of the first model and/or to assist the UE to perform the first model;
indication information of applicable UEs;
fallback indication information;
indication information of applicable areas;
indication information of applicable rates;
activation indication information.

Optionally, transmitting the first model to a second UE includes:
transmitting the first model to the second UE, if it is determined that a model performance of the first model is better than a preset performance standard.

Optionally, transmitting the first model to a second UE includes at least one of the following situations:
transmitting, to the second UE, the updated first model in a synchronous manner; and
transmitting, to the second UE, the updated first model in an asynchronous manner;
directly transmitting, to the second UE, the updated first model.

Optionally, transmitting, to the second UE, the first model in a synchronous manner includes at least one of the following situations:
periodically transmitting, to the second UE, the updated first model in a synchronous manner; and
transmitting, to the second UE, the updated first model in a synchronous manner, if the number of second UEs for which the first model needs to be updated is greater than a ninth threshold value.

Optionally, transmitting the first model to a second UE in an asynchronous manner includes:
transmitting, to the second UE for which the first model needs to be updated, the updated first model in an asynchronous manner, if the number of second UEs for which the first model needs to be updated is not greater than the ninth threshold value.

Optionally, the method further comprises:
it is determined, that the second UE of the first model needs to be updated by the at least one of the following information:
a detection result of a network performance of the second UE in using the first model and a tenth threshold value;
a detection result of the UE performance of the second UE in using the first model and an eleventh threshold value; and
the number of update times of the first model of the second UE and a twelfth threshold value.

Optionally, the method further comprises:
receiving, from a third UE, information indicative of a first model used by the third UE and/or a first model not used by the third UE.
optionally, obtaining a second output result by inputting a second input parameter related to a to-be-monitored time unit of a first UE into a second model includes:
in at least one of the following situations, obtaining a second output result by inputting a second input parameter related to a to-be-monitored time unit of a first UE into a second model:
an occurrence ratio of a second signal is less than a thirteenth threshold value;
a potential energy saving by using the second model is greater than a fourteenth threshold value; and
an accuracy of the second model is greater than a fifteenth threshold value.
optionally, obtaining a second output result by inputting a second input parameter related to a to-be-monitored time unit of a first UE into a second model includes:
obtaining a second output result by inputting a second input parameter related to a to-be-monitored time unit of a first UE into a second model, if it is determined that there is no second signal that must be transmitted to the first UE.

The method further includes:
if it is determined that there is a second signal that must be transmitted to the first UE, transmitting the second signal to the first UE within the to-be-monitored time unit.

Optionally, if it is determined, based on the second output result, not to transmit the second signal to the first UE or not select the first UE for scheduling within the to-be-monitored time unit, the method further includes:
in at least one of the following situations, also transmitting the second signal to the first UE within the to-be-monitored time unit:
a predetermined QoS of the first UE is not satisfied; and
the number of times that the related signal is not received continuously by the first UE is greater than a sixteenth threshold value.

Optionally, if it is determined based on the second output result that the second signal is transmitted to multiple UEs or multiple UEs are selected for scheduling within the to-be-monitored time unit, the method further includes at least one of the following situations:
scheduling, by a scheduling algorithm, the multiple UEs and/or UEs for which a first model is not deployed; and
allocating, by a scheduling algorithm, resources to the multiple UEs and/or UEs for which a first model is not deployed.

Optionally, the second input parameter is obtained based on at least one of the following parameters:
channel state information;
QoS information;
indication information of actual performance;
indication information of predicted performance; and
indication information of network state.

Optionally, the second input parameter related to the to-be-monitored time unit of the first UE includes at least one of the following:
accumulation rate related information;
a predicted accumulation rate;
scheduling probability indication related information;
non-scheduling indication related information;
Quality of Service (QoS) indication related information;
indication information of a service type;
indication information of predicated QoS.

Optionally, the accumulation rate related information includes an actual accumulation rate of the first UE respectively corresponding to at least one time unit included in a first time window before the to-be-monitored time unit.

Optionally, the actual accumulation rate in a time unit is determined in at least one of the following ways:
determining an actual average rate within a second time window, the second time window including a time unit and at least one time unit before the time unit, and using the actual average rate as the actual accumulation rate in a time unit; and
determining, based on an actual instantaneous rate respectively corresponding to at least one time unit included in a first time window, the smoothened actual accumulation rate respectively corresponding to at least one time unit included in the first time window, and using the smoothened actual accumulation rate corresponding to a time unit as the actual accumulation rate in a time unit.

Optionally, the predicted accumulation rate is determined based on the predicted maximum rate in the to-be-monitored time unit and/or the actual accumulation rate in a time unit before the to-be-monitored time unit.

In an aspect of the embodiments of the present application, provided is a method performed by a UE in a communication system, including:
determining a mode for monitoring a first signal transmitted by a network entity;
determining, based on the determined mode, a time unit for monitoring the first signal; and
monitoring the first signal within the time unit;
wherein, a mode for monitoring a first signal transmitted by a network entity comprises at least one of the following:
a mode indicating a time unit to monitor the first signal; and
a mode indicating whether to monitor the first signal at any time unit.

Optionally, determining a mode for monitoring a first signal transmitted by a network entity includes:
determining a mode for monitoring a first signal transmitted by a network entity, according to a ratio of the number of time units in which a related signal is found to time units in which the related signal is monitored.

Optionally, determining a mode for monitoring a first signal transmitted by a network entity includes:
for at least one service, respectively determining a mode for monitoring a first signal transmitted by a network entity respectively corresponding to at least one service.

In another aspect of the embodiments of the present application, provided is a user equipment, including:
a transceiver configured to transmit and receive signals; and
a controller coupled to the transceiver and configured to perform steps of the method performed by a UE in the present application.

In another aspect of the embodiments of the present application, provided is a network entity, including:
a transceiver configured to transmit and receive signals; and
a controller coupled to the transceiver and configured to perform steps of the method performed by a network entity in the present application.

In still another aspect of the embodiments of the present application, provided is a computer-readable storage medium having computer programs stored thereon that, when executed by a processor, implement steps of the method performed by a UE in the embodiment of the present application.

In yet another aspect of the embodiments of the present application, provided is a computer-readable storage medium having computer programs stored thereon that, when executed by a processor, implement steps of the method performed by a network entity in the embodiment of the present application.

In further another aspect of the embodiments of the present application, provided is a having computer program product including computer programs that, when executed by a processor, implement steps of the method performed by a UE in the embodiment of the present application.

In further another aspect of the embodiments of the present application, provided is a having computer program product including computer programs that, when executed by a processor, implement steps of the method performed by a network entity in the embodiment of the present application.

By the communication method, user equipment, network entity, and storage medium provided in the embodiments of the present application, a UE obtains a first output result by inputting a first input parameter related to a to-be-monitored time unit into a first model; and determines, based on the first output result, whether to monitor a first signal transmitted by a network entity within the to-be-monitored time unit. In this way, the UE is enabled to effectively determine whether to monitor signals. This avoids the situation that a UE needs to monitor signals within all configured time units in the traditional technologies, and thus saves energy consumed by the UE to receive signals.

### Advantageous Effects of Invention

The present disclosure provides a method for reducing energy consumption of UEs.

### BRIEF DESCRIPTION OF DRAWINGS

To describe the technical solutions of the embodiments of the present disclosure more clearly, the drawings to be used in the description of the embodiments of the present disclosure will be described briefly.

FIG. 1a is a schematic diagram of a model usage mode 1 in an embodiment of the present disclosure;

FIG. 1b is a schematic diagram of a model usage mode 2 in an embodiment of the present disclosure;

FIG. 1c is a schematic diagram of a model usage mode 3 in an embodiment of the present disclosure;

FIG. 1d is a schematic diagram of a model usage mode 4 in an embodiment of the present disclosure;

FIG. 2 is a schematic flowchart of a method performed by a UE in an embodiment of the present disclosure;

FIG. 3 is a schematic diagram of input parameters in an embodiment of the present disclosure;

FIG. 4a is a schematic diagram 1 of model training in an embodiment of the present disclosure;

FIG. 4b is a schematic diagram 2 of model training in an embodiment of the present disclosure;

FIG. 4c is a schematic diagram 3 of model training in an embodiment of the present disclosure;

FIG. 4d is a schematic diagram 4 of model training in an embodiment of the present disclosure;

FIG. 4e is a schematic diagram of model inference in an embodiment of the present disclosure;

FIG. 4f is a schematic diagram of model inference and base station scheduling in an embodiment of the present disclosure;

FIG. 5 is a schematic diagram 1 of model update in an embodiment of the present disclosure;

FIG. 6 is a schematic diagram 2 of model update in an embodiment of the present disclosure;

FIG. 7 is a schematic diagram of model triggering in an embodiment of the present disclosure;

FIG. 8 is a schematic diagram of UE side model execution in an embodiment of the present disclosure;

FIG. 9 is a schematic flowchart of a method performed by a network entity in an embodiment of the present disclosure;

FIG. 10 is a schematic diagram of initial deployment of a model in an embodiment of the present disclosure;

FIG. 11 is a schematic diagram of model performance detection in an embodiment of the present disclosure;

FIG. 12 is a schematic diagram of base station side model execution in an embodiment of the present disclosure;

FIG. 13a is a schematic diagram 1 of a model execution method in an embodiment of the present disclosure;

FIG. 13b is a schematic diagram 2 of a model execution method in an embodiment of the present disclosure;

FIG. 13c is a schematic diagram 3 of a model execution method in an embodiment of the present disclosure;

FIG. 14 is a schematic diagram of model transmission in an embodiment of the present disclosure;

FIG. 15 is a schematic flowchart 1 of scheduling of a UE by a base station in an embodiment of the present disclosure;

FIG. 16a is a schematic flowchart 2 of scheduling of a UE by a base station in an embodiment of the present disclosure;

FIG. 16b is a schematic diagram 4 of a model execution method in an embodiment of the present disclosure;

FIG. 16c is a schematic diagram 5 of a model execution method in an embodiment of the present disclosure;

FIG. 17a is a schematic flowchart 3 of scheduling of a UE by a base station in an embodiment of the present disclosure;

FIG. 17b is a schematic diagram 6 of a model execution method in an embodiment of the present disclosure;

FIG. 17c is a schematic diagram 7 of a model execution method in an embodiment of the present disclosure;

FIG. 18a is a schematic flowchart 4 of scheduling of a UE by a base station in an embodiment of the present disclosure;

FIG. 18b is a schematic diagram 8 of a model execution method in an embodiment of the present disclosure; and

FIG. 18c is a schematic diagram 9 of a model execution method in an embodiment of the present disclosure;

FIG. 19 is a schematic diagram of interactions between base stations for executing models by UEs in a mobile state in an embodiment of the present disclosure;

FIG. 20 is a schematic diagram of an overall structure of the wireless network in an embodiment of the present disclosure;

FIG. 21a is a schematic diagram of a transmission path in an embodiment of the present disclosure;

FIG. 21b is a schematic diagram of a reception path in an embodiment of the present disclosure;

FIG. 22a is a schematic diagram of a structure of a UE in an embodiment of the present disclosure;

FIG. 22b is a schematic diagram of a structure of a base station in an embodiment of the present disclosure;

FIG. 23a is a schematic diagram of parameter update mismatch between base station and UE sides in an embodiment of the present disclosure;

FIG. 23b is a schematic diagram of delayed parameter update between base station and UE sides in an embodiment of the present disclosure.

### MODE FOR THE INVENTION

Embodiments of the present disclosure will be described below with reference to the accompanying drawings in the present disclosure. It should be understood that the embodiments to be described below with reference to the accompanying drawings are exemplary descriptions for explaining the technical solutions of the embodiments of the present disclosure, and do not limit the technical solutions of the embodiments of the present disclosure.

It may be understood by a person of ordinary skill in the art that singular forms “a”, “an” and “the” as used here may include plural forms as well, unless otherwise stated. It should be further understood that the terms “comprising” and “including” used in the embodiments of the present disclosure mean that corresponding features may be implemented as presented features, information, data, steps, operations, elements and/or components, but do not exclude implementations as other features, information, data, steps, operations, elements, components, and/or combinations thereof as supported in the prior art. It should be understood that, when an element is referred as being “connected” or “coupled” to another element, this element may be directly connected or coupled to the other element, or this element and the other element may be connected through intervening elements. In addition, “connected to” or “coupled to” as used herein may include wireless connection or coupling. The term “and/or” as used herein indicates at least one of the items defined by the term, e.g., “A and/or B” may be implemented as “A”, or as “B”, or as “both A and B”.

To make the purposes, technical solutions and advantages of the present applicant clearer, the implementations of the present disclosure will be further described below in detail with reference to the accompanying drawings.

In the present application, artificial intelligence (AI) and machine learning (ML) are equivalent concepts, and AI will be used in the following description.

In the existing communication solutions, whenever a UE monitors signals, it needs to process the received signals, and determines whether the base station has scheduled it according to the information obtained after the processing. However, sometimes, the UE fails to detect its scheduling information from the base station after monitoring signals, which makes the UE's monitoring of signals a useless process. That is, the UE's monitoring of signals consumes energy, but does not obtain any useful information for it.

To solve this problem, following solutions have been proposed in the prior art.
Solution 1: Discontinuous reception (DRX), that is, a UE monitors signals only during the active time. The UE obtains the active time according to the configuration of the base station (e.g., DRX cycle length, offset of the DRX starting-up, inactive timer, retransmission timer, etc.).
Solution 2: the time for the UE to monitor signals is configured. That is, the base station transmits configuration information for signal monitoring to the UE. The configuration information indicates the time for the UE to monitor signals (e.g., slot, subframe, etc.).

These solutions have following problems.
Problem 1: Even if the solution 1 and/or solution 2 are used, sometimes signals monitored by the UE do not contain scheduling information, which will still cause un-necessary energy consumption.
Problem 2: the UE is unable to use the above solution 1 and/or solution 2 in case of heavy load, so it is likely to have the situation that signals monitored by the UE do not contain scheduling information.

The reason for these problems is that the UE cannot know the scheduling decision on the base station side in advance, that is, the UE does not know whether the base station has scheduled it.

The communication method, user equipment, network device and storage medium in the present application aim at solving these technical problems in the prior art.

The technical solutions of the embodiments of the present application and the technical effects produced by the technical solutions of the present application will be described below by describing several exemplary implementations. It should be noted that the following implementations may refer to, learn from, or combine with each other, and the same terms, similar features, and similar implementation steps in different implementations will not be described repeatedly.

In the embodiments of the present application, the network entity (e.g., a base station or a distribution unit of the base station) may determine whether to transmit a signal to the UE (or determine whether to schedule the UE) through a model, and the UE may determine whether to monitor the signal through a model to obtain scheduling information from the network entity.

In one embodiment, the above “monitoring the signals” refers to monitoring signals on physical layer downlink control channels (PDCCH), and “scheduling information” refers to downlink control information (DCI) (or DCI for indicating new data transmission). However, it is not limited thereto, and other signals may also be used in other embodiments. It may be understood that, as long as it is a signal that needs to be monitored by the UE, the solutions of the embodiments of the present application may be used, and therefore all should be included within the protection scope of the present application. For ease of understanding, scheduling information may be used as an example for description in some embodiments below.

In one embodiment, the purpose of this solution is to ensure that the UE can receive the scheduling information for it in most or all situations when monitoring signals and there is no transmission of scheduling information to it when the UE does not monitor signals. That is, the purpose of the embodiments of the present application is to design the scheduling on the network entity side and the monitoring on the UE side, so as to reduce the energy consumption of the UE. In one implementation, the problem to be solved may be modeled as a mathematical problem as follows:

In theory, to schedule Nᵣ UEs in a time unit tᵣ, the solution may be modeled as:

$${min}_{\{ {Θ}^{g} ( {t}_{r} ) , {Θ}^{u} ( {t}_{r} ) \}} 𝒢 ( {Θ}^{g} ( {t}_{r} ) , {Θ}^{u} ( {t}_{r} ) , ℚ ( {t}_{r} ) )$$

$$where ,$$

$$ℚ ( t ) = {[ {q}_{{i}_{r} {j}_{r}} ( {t}_{r} ) ]}_{{N}_{r} \times {M}_{r}} , {q}_{{i}_{r} {j}_{r}} ( {t}_{r} ) ∈ {Q}_{{i}_{r} {j}_{r}}$$

$$where , {Θ}^{g} ( {t}_{r} ) = {[ {θ}_{{i}_{r}}^{g} ( {t}_{r} ) ]}_{1 \times {N}_{r}} , {Θ}^{u} ( {t}_{r} ) = {[ {θ}_{{i}_{r}}^{u} ( {t}_{r} ) ]}_{1 \times {N}_{r}}$$

are decision vectors on the network entity side and the UE side, respectively. For

$$U E {i}_{r} , {θ}_{{i}_{r}}^{g} ( {t}_{r} )$$

represents the scheduling decision (“1” for scheduling or selecting the UE for scheduling, otherwise “0”); θᵢ_{ᵣ}^{u}(tᵣ) represents the monitoring decision (“1” for monitoring, otherwise “0”). [symbol] (tᵣ) is a Nᵣ×Mᵣ matrix, and the element qᵢ_{ᵣ}ⱼ_{ᵣ}(tᵣ) in the matrix is the jᵣ-th QoS parameter satisfied by UEiᵣ, that is, [symbol] (tᵣ) is subject to the QoS requirements defined by Qᵢ_{ᵣ}ⱼ_{ᵣ}. Then, the objective function g(Θ^{g}(tᵣ), Θ^{u}(tᵣ), [symbol] (tᵣ)) may be defined as:

$$( {Θ}^{g} ( {t}_{r} ) , {Θ}^{u} ( {t}_{r} ) , ℚ ( {t}_{r} ) ) = \frac{{\sum }_{i = 1}^{{N}_{r}} [ {\sum }_{m = 1}^{{t}_{r}} {θ}_{i}^{g} ( m ) ] * {[ {\sum }_{m = 1}^{{t}_{r}} {θ}_{i}^{u} ( m ) ]}^{- 1}}{{N}_{r} * {\sum }_{i = 1}^{{N}_{r}} {\sum }_{m = 1}^{{t}_{r}} {f}_{i} ( {θ}_{i}^{g} ( m ) , {θ}_{i}^{u} ( m ) , {𝒬}_{i} ( m ) )}$$

where, for UEi in a time unit m(m=1, . . . , tᵣ)

Qᵢ(m)=[qᵢ₁(m), . . . ,q_{iM}_{ᵣ}(m)]

ƒᵢ(*) (i.e., ƒᵢ(θᵢ^{g} (m), θᵢ^{u}(m), Qᵢ(m)) is a function of the QoS achieved by the user (UE). For example, ƒᵢ(*) may be the throughput achieved by UEi.

The energy saving solution obtained on this basis has following characteristics:
1) UE performance is good;
2) The PDCCH monitoring decisions at the network entity and the UE are the same, that is, such as:

$${θ}_{{i}_{r}}^{g} ( m ) = {θ}_{{i}_{r}}^{u} ( m )$$

$$𝒢 \text{(⋆)} = [ {\sum }_{i = 1}^{N} {\sum }_{m = 1}^{r} {f}_{i} \text{(*} {) ]}^{- 1}$$

In another implementation, the scheduling algorithm of scheduling N UEs in a slot t may be modeled as a mathematical problem as follows:

$${max}_{{δ}_{i} ( t ) , {v}_{i} ( r )} {\sum }_{i = 1}^{N} {δ}_{i} ( t ) {v}_{i} ( t )$$

$$subject to : \frac{1}{t} {\sum }_{k = 1}^{t} {δ}_{i} ( k ) {v}_{i} ( k ) \geq {R}_{i} , ∀ i$$

$${Δ}_{i} ( t ) \leq {min}_{j} ( {T}_{i j} + {A}_{i j}^{min} ) - {t}_{l ast} , ∀ i$$

For a user i, δᵢ (t) represents the scheduling decision (“1” for scheduling the user and “0” for not scheduling the user), and vᵢ(t) is the rate that can be achieved by the user in the slot t and is related to the allocated bandwidth. The inequation (2) indicates that the rate requires Rᵢ, and the inequation (2) may be converted into:

$$\frac{1}{t} \frac{{δ}_{i} ( t ) {v}_{i} ( t )}{{R}_{i}} \geq 1 - \frac{{V}_{i} ( t - 1 )}{{R}_{i}} = 1 - \frac{{p}_{i} ( t - 1 ) \overline{{v}_{i} ( t - 1 )}}{{R}_{i}}$$

where, vᵢ(t−1) represents the rate that can be achieved by the user until the slot t−1, pᵢ (t−1) represents the scheduling probability (except for retransmission scheduling) of the user in the slot t−1,

$$\overline{{v}_{i} ( t - 1 )} ( ∈ [ {v}_{i}^{min} , {v}_{i}^{max} ]$$

is the effective rate of the user, and vᵢ^{min} and vᵢ^{max} represent the minimum and maximum rates that can be achieved in the slot where the user is scheduled, respectively. To represent the delay requirement of the user, Δᵢ(t) represents the number of slots where the user i is not scheduled since the last scheduling, and the inequation (3) indicates the limitation of Δᵢ(t). For a service j, Tᵢⱼ represents the delay requirement, Aᵢⱼ^{min} represents the slot when the earliest arriving data packet in the service j in the cache arrives the cache, and tₗₐₛₜ represents the slot where the last scheduling is performed.

Since the information used by the UE and the network entity for decision-making is usually not the same, in order to avoid the resulting difference in decision-making, AI is used to solve this technical problem in an embodiment of the present application.

For the embodiment of the present application, following two models are involved:
the first model: used at the UE side, and used by the UE to determine whether to monitor signals, in an embodiment, the output (inference) of the model indicates the UE whether to monitor the signal (monitoring or not monitoring); and
the second model: used at the network entity side, and used by the network entity to determine whether to transmit signals to one or more UEs, such as scheduling information for the UEs, or used by the network entity to determine whether to select one or more UE for scheduling. In an embodiment, the output (inference) of the model indicates whether to transmit signals to the UE (e.g., transmit, not transmit); in another embodiment, the output (inference) of the model indicates whether to schedule the UE (e.g., schedule or not schedule), or whether to select the UE for scheduling (e.g., select or not select).

In an embodiment of the application, the network entity can be the base station or the distribution unit of the base station, that is, the second model can be used by the base station, or can be used by the distribution unit of the base station.

In the embodiment of the present application, the first model and/or second model may be models generated by artificial intelligence algorithms, or may be other types of models. For any model, when a set of parameters is input into the model, the model will generate one or more output parameters (such as inference).

In the embodiment of the present application, the first model and/or second model may be a model obtained after being trained by an artificial intelligence algorithm, or, the first model and/or second model may be a model obtained by mathematical cal-culation (for example, a model is generated according to the probability that the UE is scheduled, and the probability that the UE is scheduled generated by the model is close to the probability that the UE is actually scheduled).

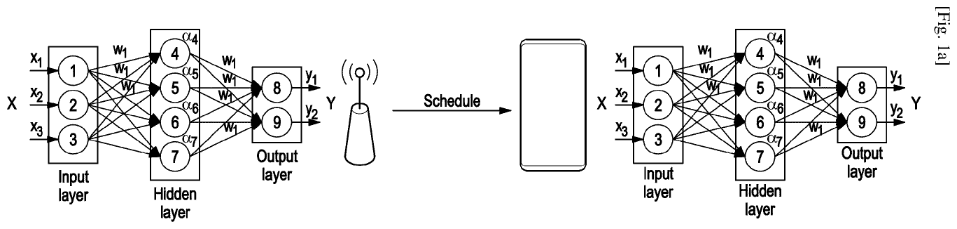

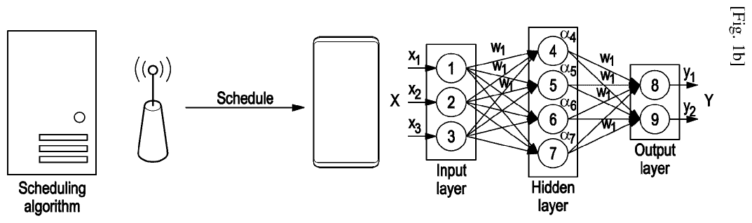

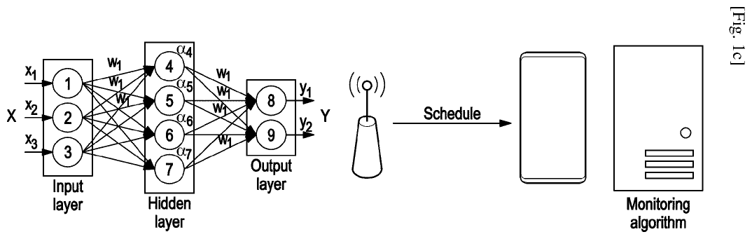

In the embodiment of the present application, the two models may be used in following ways.
Way 1: As shown in FIG. 1a, the first model and the second model are the same model, for example, the base station use the second model to determine whether to transmit signals to the UE (or determine whether to schedule the UE, or determine whether to select the UE for scheduling), the UE uses the first model to determine whether to monitor signals.

As an example, taking two UEs as an example, the same AI model is deployed on both the base station side and the UE side. At the beginning of a time unit, the base station inputs the input parameters of the two UEs into the AI model, respectively, and obtains two inference results. Each inference result indicates whether the corresponding UE is selected for scheduling, and then the base station allocates radio resources to the selected UE (while in the source allocation, the base station can operate by using the traditional scheduling algorithm). Furthermore, both UEs run the same AI model as the base station. By inputting the same input parameters as the base station, each UE can obtain the same inference result, that is, the UE can accurately learn the decision of the base station, thereby skipping unnecessary PDCCH monitoring.
Way 2: As shown in FIG. 1b, the UE uses the first model to determine whether to monitor signals, and the base station determines whether to transmit a signal to the UE according to its own scheduling algorithm.
Way 3: As shown in FIG. 1c, the base station uses the second model to determine whether to transmit a signal to the UE (or determine whether to schedule the UE), and the UE uses its own algorithm (for example, a monitoring algorithm, in one example, the UE performs one signal monitoring every two subframes, but not limited thereto) to determine whether to monitor signals.
4: As shown in FIG. 1d, the first model and the second model are different models, for example, the base station uses the second model to determine whether to transmit signals to the UE (or determine whether to schedule the UE, or determine whether to select the UE for scheduling), the UE uses the first model to determine whether to monitor signals.

Description will be given below by taking the first model and/or second model being a model obtained after being trained by an artificial intelligence algorithm. It may be understood that the present application is applicable to the first model and/or second model obtained by any other methods, which should also be included within the protection scope of the present application.

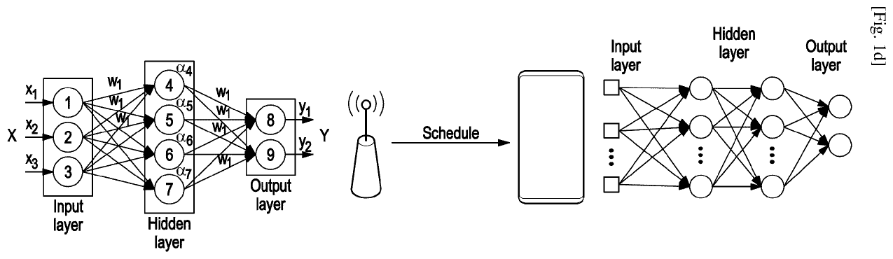

An embodiment of the present application provides a method performed by a UE in a communication system. As shown in FIG. 2, the method includes:

At S201, a first output result is obtained by inputting a first input parameter related to a to-be-monitored time unit into a first model.

In this embodiment of the present application, a time unit refers to a unit of a time period during which the UE may monitor the target signal (for example, scheduling information), and the length of the time period (that is, the time unit) may be a slot, or a subframe, or an OFDM (Orthogonal Frequency Division Multiplexing) symbol, and may also be of other time lengths.

In this embodiment of the present application, the to-be-monitored time unit may include one or more time units. For example, it may be one or more time units that are about to start, but not limited thereto.

Taking the to-be-monitored time unit as a slot as an example, for a slot t_{c}, after inputting the input parameter required by the first model (that is, the first input parameter related to the to-be-monitored time unit) into the first model, the model will generate a first output result (for example, inference, the output result may also be referred to as an inference result, and the same meaning will not be repeated hereafter). The result indicates whether there is a target signal in the slot t_{c} (that is, indicate whether to monitor signals in the slot t_{c}).

At S202, it is determined, based on the first output result, whether to monitor a first signal transmitted by a network entity within the to-be-monitored time unit.

In the embodiment of the present application, the network entity transmitting the first signal can be a base station or a distribution unit of the base station, but not limited thereto.

In this embodiment of the present application, the target signal may refer to a first signal (such as PDCCH), or may refer to a signal carried by the first signal (such as DCI carried by PDCCH).

Optionally, if the first output result indicates that there is a target signal within the to-be-monitored time unit, it may be determined to monitor the first signal transmitted by the network entity within the to-be-monitored time unit, and if the first output result indicates that there is no target signal within the to-be-monitored time unit, it may be determined not to monitor the first signal transmitted by the network entity within the to-be-monitored time unit, but not limited thereto. In other embodiments, the first output result may also be post-processed first, and then determination is made, according to the post-processing result, whether to monitor the first signal transmitted by the network entity within the to-be-monitored time unit.

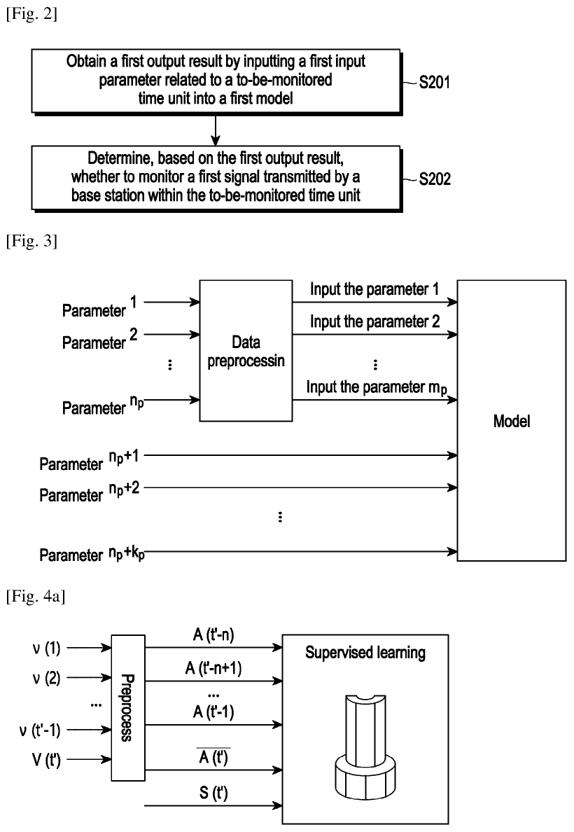

In this embodiment of the present application, the content of the first input parameter may be as shown in FIG. 3, where:
1. Parameters 1˜nₚ+kₚ: represents the original parameters, that is, the first input parameter is obtained based on this parameter or these parameters, which may include at least one of the following parameters:
(1) Channel state information for example, at least one of information such as signal strength, signal-to-noise ratio, and channel state indication information.
(2) QoS information, for example, UE's rate requirements, latency budget re-quirements, packet loss rate requirements, priority, resource type, data type (for example, GBR (guaranteed bit rate) data, non-GBR data, video data, voice data, Internet access data, etc.), QoS flow indication information (for example, 5QI (5G QoS Identifier), QFI (QoS Flow Identifier), etc.) and other information.
(3) Indication information of the actual performance (that is, the indication information of the performance that the UE can achieve), for example, at least one of rate, latency, packet loss rate, jitter, maximum rate, minimum rate, average rate, in-stantaneous rate, accumulation rate and other information that the UE can achieve.
(4) Indication information of the predicted performance, for example, at least one of the predicted rate, the predicted latency, the predicted packet loss rate, the predicted jitter, the predicted maximum rate, the predicted minimum rate, the predicted average rate, the predicted instantaneous rate, the predicted accumulation rate and other information that the UE can achieve.
(5) Indication information of the network state, which is used to indicate the state of the cell served by the base station, for example, resource usage percentage (e.g., PRB (Physical Resource Block) usage percentage), the number of UEs in the cell, etc.

In this embodiment of the present application, in the model training stage, the sample data used for training may also be obtained based on the parameters shown in FIG. 3.

Wherein, the parameters 1˜nₚ+kₚ may further include:
(6) Indication information of the scheduling result of the UE, which is used to indicate, to the UE, whether there is a target signal from the base station in a time unit (for example, a signal indicating whether it is scheduled). If the indication information is 1, it means that the UE is scheduled. If the indication information is 0, it means that the UE is not scheduled.
(7) indication information of the number of the times of the scheduling, for indicating the number of times that the UE has been scheduled by the base station, in one example, the indication information includes the number of time units for which the UE receives the DCI (DCI indicating a new data transmission)
(8) scheduling probability indication information, for indicating the probability of the UE being scheduled by the base station, which in one example comprises a ratio of the number of time units for which the UE receives a DCI (or DCI indicating a new data transmission) to the number of total time units (or total downlink time units). In one example, the “total time units” may be the total number of time units in a time window.
(9) non-scheduling indication information, for indicating the number of time units elapsed since the UE last received DCI (or DCI indicating a new data transmission), which in one example may be the information after processing the number of un-scheduled time units, such as a ratio of “the number of time units elapsed since the UE last received DCI (or DCI indicating a new data transmission)” to a constant (e.g. 1000), for another example, a ratio of “the number of time units elapsed since the UE last received DCI (or DCI indicating a new data transmission)” to the maximum value of the number of time units for which the UE is not scheduled. If the user is scheduled in the slot 5 but has not been scheduled subsequently, in the slot 10, in one embodiment, when the indication information is 4, it indicates that the user has not been scheduled in 4 slots before the slot 10; in another embodiment, when the indication information is 5, it indicates that the user has not been scheduled in 5 slots before the slot 10. If the user is scheduled in the slot 10, the indication information becomes 0.
(10) QoS indication information, for indicating a ratio of the performance that the user can obtain to the performance required by the QoS, which reflects the performance of the QoS that the user can achieve. In one example, the indication information may be a ratio of the value of one of the parameters in the above “indication information of the actual performance” to the value of the same parameter in the above “QoS information”, such as the ratio of the rate to the rate requirement, the ratio of the delay to the delay budget, the ratio of the packet loss rate to the packet loss rate re-quirement, etc.
(11) indication information of predicted QoS, for indicating the predicted user performance, or the ratio of the predicted user performance to the performance required by the QoS, which may reflect the performance of the predicted user in terms of the QoS that can be achieved. In one example, the indication information may be the value of one of the parameters in the above “indication information of predicted performance”, in another example, the indication information may be the value of one of the parameters in the above “indication information of predicted performance” to the value of the parameter in the above “QoS information”, such as the ratio of the predicted rate to the rate requirement, the ratio of the predicted delay to the delay budget, the ratio of the predicted packet loss rate to the packet loss rate requirement, etc.
(12) indication information of the service type, for indicating the type of the service serviced by the user equipment. In one example, the indication information may indicate a service (e.g., video, audio, FTP (File Transfer Protocol), HTTP (Hyper Text Transfer Protocol), XR (Extended Reality), etc.). In another example, the indication information may be used to indicate a combination of a plurality of different services (e.g., video+audio, video+FTP, FTP+HTTP, etc.). One example of the indication information is a piece of index information (e.g., 1, 2, 3, . . . ) indicating different service types or service type combinations.

In the embodiment of the present application, some of the above parameters may need to be preprocessed before being input into the model (for example, parameters
1˜nₚ in FIG. 3), and some may be directly input into the model (for example, parameters nₚ+1˜nₚ+kₚ in FIG. 3).
2. Data preprocessing: this module will process the original parameters 1˜nₚ, for example, calculate one or more of the original parameters 1˜nₚ by mathematical formulas, but not limited thereto.
3. Input parameters 1˜mₚ: which are parameters obtained after data preprocessing of the parameters 1˜nₚ. These parameters will be used as parameters directly input into the model.

In the embodiment of the present application, in the model training stage, a model training module may also be used to train and obtain the required first model and/or second model based on the parameters shown in FIG. 3. Possible training methods include training methods based on supervised learning, training methods based on rein-forcement learning, training methods based on non-reinforcement learning, etc. The specific training methods are not limited in the embodiment of the present application.

In the embodiment of the present application, a feasible implementation manner is provided for the first input parameter related to the to-be-monitored time unit (hereinafter referred to as an input parameter implementation I for ease of description). Specifically, it may include at least one of the following:
1. Accumulation rate related information, in one embodiment, the information may include the actual accumulation rate respectively corresponding to at least one time unit included in a first time window before the to-be-monitored time unit, which may be expressed as A(t_{c}−1), A(t_{c}−2), . . . , A(t_{c}−n) for example.
where, t_{c} represents the to-be-monitored time unit; n represents the number of time units in the first time window. That is, for any time unit t_{c}, the first time window of its related data collection is the n time units before the time unit t_{c}; in the model use stage, A(x) represents the actual accumulation rate of the UE at the end of the time unit x (that is, the accumulation rate that can achieve).

Optionally, the actual accumulation rate in any one time unit is determined based on at least one of the following ways (calculation methods).
(1) An actual average rate within a second time window, that is, the average rate that the UE can achieve in the second time window, is determined, the second time window including a time unit and at least one time unit before the time unit, and the actual average rate is used as the actual accumulation rate in a time unit. Optionally, the actual average rate in the second time window may be calculated by the following formula 1:

$$A ( x ) = \frac{{\sum }_{i = 0}^{m - 1} v ( x - i )}{m * T}$$

where, x represents any time unit; v(x) represents the instantaneous rate actually that the UE can achieve in the time unit x, if the UE is not scheduled in the time unit x, then v(x)=0; m represents the number of time units in the second time window used to calculate the average rate; and T represents the length of one time unit (e.g., 0.001 seconds, but not limited thereto).
(2) Based on an actual instantaneous rate respectively corresponding to at least one time unit included in a first time window, the smoothened actual accumulation rate re-spectively corresponding to at least one time unit included in the first time window is determined, and the smoothened actual accumulation rate corresponding to a time unit is used as the actual accumulation rate of a time unit. Optionally, the smoothed accumulation rate that the UE can actually achieve may be calculated by the following formula 2:

$$A ( x ) = {α}_{1} * v ( x ) + ( 1 - {α}_{1} ) A ( x - 1 )$$

$$A ( 1 ) = v ( 1 )$$

where, x represents any time unit; v(x) represents the instantaneous rate that the UE can actually achieve in the time unit x; α₁ is an average factor (for example, 0.002, but not limited thereto). Further, when A(0)=v(0)=0,

$$A ( x ) = {\sum }_{k = 0}^{x - 1} {{α}_{1} ( 1 - {α}_{1} )}^{k} v ( x - k )$$

2. The predicted accumulation rate within the to-be-monitored time unit which, for example, may be expressed as A̅(̅t̅_̅{̅c̅}̅)̅ or A′(t_{c}). The description will be given below by taking the predicted accumulation rate expressed as Ā as an example.

Wherein, t_{c} represents the to-be-monitored time unit; in the model use stage, A̅(̅x̅)̅ represents the accumulation rate in the time unit x predicted by the base station or the UE at the beginning of the time unit x.

Optionally, the predicted accumulation rate is determined based on the predicted maximum rate in the to-be-monitored time unit and/or the actual accumulation rate in a time unit before the to-be-monitored time unit. Optionally, the predicted accumulation rate may be calculated by the following formula 3:

$$\overline{A ( x )} = {α}_{2} V ( x ) + ( 1 - {α}_{2} ) A ( x - 1 )$$

where, x represents any time unit; V(x) represents the maximum rate that the UE can achieve in the time unit x, which may be prediction of the rate in a future time unit, for example, in the time unit t_{c}−1, the maximum rate that the base station or the UE can predict to achieve in the time unit t_{c}; A(x−1) represents the actual accumulation rate of the UE at the end of the time unit x−1; α₂ is an average factor (which may be the same or different from α₁). In one example, V(x) may be the maximum rate achieved after all or part of the bandwidth in the time unit x is allocated to the UE.

In the embodiment of the present application, the calculation of A(x) and A̅(̅x̅)̅ may be understood as data preprocessing.

In the embodiment of the present application, the parameters A(t_{c}−1), A(t_{c}−2), . . . , A(t_{c}−n) and A̅(̅t̅_̅{̅c̅}̅)̅ are input into the first model to obtain a first output result S(t_{c}). In the model use stage, S(t_{c}) may indicate whether there is a target signal for the UE in the to-be-monitored time unit t_{c}, for example, “1” means there is a target signal, “0” means there is no target signal, or it may indicate whether to select the UE for scheduling within the to-be-monitored time unit t_{c}, for example “1” indicate to select, “0” indicate to not select, but not limited thereto. Other representations may also be used.

The embodiment of the present application provides another feasible implementation for the first input parameter related to the to-be-monitored time unit (hereinafter referred to as an input parameter implementation II for ease of description), specifically, which may include at least one of the following:
1. QoS indication related information, which in one embodiment may comprise in-dication information of the QoS corresponding to at least one time unit included in the first time window before the to-be-monitored time unit, respectively, which may be expressed, for example, as Q(t_{c}−1), Q(t_{c}−2), . . . ,Q(t_{c}−n), and in one example, Q(t_{c}) may be the ratio of the average rate (or rate) T(t_{c}) achieved by the user to the rate requirement T^{tgt}. Other possible indications can be found in “QoS indication information” above.

Where t_{c} denotes the to-be-monitored time unit; n indicates the number of time units in the first time window. That is, for any time unit t_{c}, the first time window for data collection is the n time units before the time unit t_{c}; in the model usage phase, Q(x) indicates the QoS indication information of the UE at the end of time unit x.
2. scheduling probability indication related information, which in one embodiment may include scheduling probability indication information corresponding to at least one time unit included in the first time window before the to-be-monitored time unit (e.g., n time units before the time unit t_{c}) respectively, which may be expressed, for example, as P(t_{c}−1), P(t_{c}−2), . . . , P(t_{c}−n), in one example P(t_{c}) may indicate the probability that the UE is scheduled by the base station at the end of a time unit, e.g. it may be the probability that the UE is scheduled by the base station within a time window, e.g. a ratio of the number of time units for which the UE receives DCI (or DCI indicating a new data transmission) to the total number of time units (or the total number of downlink time units). In one example, the “total time units” may be the total number of time units in a time window.
3. Non-scheduling indication information, which in one embodiment may include non-scheduling indication information corresponding to at least one time unit included in the first time window before the to-be-monitored time unit (n time units before the time unit t_{c}), which may be expressed, for example, as
δ(t_{c}−1), δ(t_{c}−2), . . . , δ(t_{c}−n), in one example, δ(t_{c}) may indicate the number of time units that the UE has experienced at the end of time unit t_{c} since the last time it received the DCI (or DCI for scheduling a new data transmission) message, in another example, δ(t_{c}) may indicates a ratio of the number of time units that the UE has experienced at the end of time unit t_{c} since the last time it received DCI (or DCI for scheduling a new data transmission or receiving the scheduling indication from the base station) message to a constant (which may be, for example, a constant for nor-malization), and in another example, δ(t_{c}) may represent a ratio of the number of time units experienced by the UE at the end of time unit t_{c} since the last time it received the DCI (or DCI for scheduling a new data transmission) message to the maximum value of the number of time units not scheduled by the UE.
4. Indication information of predicted QoS of the to-be-monitored time unit, which may be expressed, for example, as Q̅(t_{c}), which in one embodiment may include the predicted rate (e.g., average rate) T̅(t_{c}) achieved by the user, or include a ratio of the predicted rate (e.g., average rate) T̅(t_{c}) achieved by the user to the rate requirement T^{tgt}, where

$$\overline{T} ( {t}_{c} ) = \frac{( {t}_{c} - 1 ) \cdot T ( {t}_{c} - 1 ) + V ( {t}_{c} )}{{t}_{c}} , V ( {t}_{c} )$$

can be a maximum rate achieved after allocating all or part of the bandwidth in the time unit t_{c} to the UE. Other possible in-dication information can be found in “Indication information of predicted QoS” above.

In the embodiment of the present application, the first output result is obtained by taking multiple parameters (for example, [Q(t_{c}−n), p(t_{c}−n), δ(t_{c}−n)], [Q(t_{c}−n+1), p(t_{c}−n+1), δ(t_{c}−n+1)], . . . , [Q(t_{c}−1), P(t_{c}−1), δ(t_{c}−1)] and Q̅(t_{c})) of one time unit as an input, and inputting it into the first model. Wherein, in the model usage phase, S(t_{c}) may indicate whether the UE has a target signal in the to-be-monitored time unit t_{c}, e.g., “1” means yes and “0” means no, or indicate whether the UE is selected for scheduling within the to-be-monitored time unit t_{c}, e.g., “1” means selecting and “0” means not selecting, but not limited to this, other repre-sentations are also possible. In another example, by inputting multiple parameters of a time unit as an input, such as

$$[ Q ( {t}_{c} - n ) , p ( {t}_{c} - n ) ] , [ Q ( {t}_{c} - n + 1 ) , p ( {t}_{c} - n + 1 ) ] , … , [ Q ( {t}_{c} - 1 ) , p ( {t}_{c} - 1 ) ] ,$$

δ(t_{c}−1) and Q̅(t_{c}) and inputting it to the first model, the first output result (inference result) S(t_{c}) is obtained.

The embodiment of the present application provides another feasible implementation for the first input parameter related to the to-be-monitored time unit (hereinafter referred to as an input parameter implementation V for ease of description), specifically, which may include at least one of the following:
1. QoS indication related information, which in one embodiment may comprise in-dication information of the QoS corresponding to at least one time unit included in the first time window before the to-be-monitored time unit, respectively, which may be expressed, for example, as Q(t_{c}−1), Q(t_{c}−2), . . . ,Q(t_{c}−n), and in one example, Q(t_{c}) may be the ratio of the average rate T(t_{c}) achieved by the user to the rate re-quirement T^{tgt}. Other possible indications can be found in “QoS indication information” above.

Where t_{c} denotes the to-be-monitored time unit; n indicates the number of time units in the first time window. That is, for any time unit t_{c}, the first time window for data collection is the n time units before the time unit t_{c}; in the model usage phase, Q(x) indicates the QoS indication information of the UE at the end of time unit x.
2. scheduling probability indication related information, which in one embodiment may include scheduling probability indication information corresponding to at least one time unit included in the first time window before the to-be-monitored time unit (e.g., n time units before the time unit t_{c}) respectively, which may be expressed, for example, as p(t_{c}−1), p(t_{c}−2), . . . , p(t_{c}−n), in one example p(t_{c}) may indicate the probability that the UE is scheduled by the base station at the end of a time unit, e.g. it may be the probability that the UE is scheduled by the base station within a time window, e.g. a ratio of the number of time units for which the UE receives DCI (or DCI indicating a new data transmission) to the total number of time units (or the total number of downlink time units). In one example, the “total time units” may be the total number of time units in a time window.
3. Non-scheduling indication information, which in one embodiment may include non-scheduling indication information corresponding to at least one time unit included in the first time window before the to-be-monitored time unit (n time units before the time unit t_{c}), which may be expressed, for example, as
δ(t_{c}−1), δ(t_{c}−2), . . . , δ(t_{c}−n), in one example, δ(t_{c}) may indicate the number of time units that the UE has experienced at the end of time unit t_{c} since the last time it received the DCI (or DCI for scheduling a new data transmission) message, in another example, δ(t_{c}) may indicates a ratio of the number of time units that the UE has experienced at the end of time unit t_{c} since the last time it received DCI (or DCI for scheduling a new data transmission) message to a constant, and in another example, δ(t_{c}) may represent a ratio of the number of time units experienced by the UE at the end of time unit t_{c} since the last time it received the DCI (or DCI for scheduling a new data transmission) message to the maximum value of the number of time units not scheduled by the UE.
4. Indication information of predicted QoS of the to-be-monitored time unit, which may be expressed, for example, as Q̅(t_{c}), which in one embodiment may include the predicted average rate T̅(t_{c}) achieved by the user, or include a ratio of the predicted average rate T̅(t_{c}) achieved by the user to the rate requirement T^{tgt}, where

$$\overline{T} ( {T}_{c} ) = \frac{( {t}_{c} - 1 ) * T ( {t}_{c} - 1 ) + V ( {t}_{c} )}{{t}_{c}} , V ( {t}_{c} )$$

can be a maximum rate achieved after allocating all or part of the bandwidth in the time unit t_{c} to the UE. Other possible indication information can be found in “Indication information of predicted QoS” above.
5. Indication information of the service type, which may be expressed, for example, as F(t_{c}), which indicates the type of the service serviced by the user equipment. In one embodiment, the indication information may indicate a service (e.g., video, audio, FTP, HTTP, XR, etc.). In another example, the indication information may indicate a combination of a plurality of different services (e.g., video+audio, video+FTP, FTP+HTTP, etc.). One example of the indication information is a piece of index information (e.g., 1, 2, 3, . . . ) representing different service types or service type com-binations.

In the embodiment of the present application, the first output result S(t_{c}) is obtained by taking multiple parameters (for example, F(t_{c}), [Q(t_{c}−n), p(t_{c}−n), δ(t_{c}−n)], [Q(t_{c}−n+1), p(t_{c}−n+1), δ(t_{c}−n+1)], . . . , [Q(t_{c}−1), p(t_{c}−1), δ(t_{c}−1)] and Q̅(t_{c})) of one time unit as an input, and inputting it into the first model. Wherein, in the model usage phase, S(t_{c}) may indicate whether the UE has a target signal in the to-be-monitored time unit t_{c}, e.g., “1” means yes and “0” means no, or indicate whether the UE is selected for scheduling within the to-be-monitored time unit t_{c}, e.g., “1” means selecting and “0” means not selecting, but not limited to this, other repre-sentations are also possible. In another example, by inputting multiple parameters of a time unit as an input, such as F(t_{c}),

$$[ Q ( {t}_{c} - n ) , p ( {t}_{c} - n ) ] , [ Q ( {t}_{c} - n + 1 ) , p ( {t}_{c} - n + 1 ) ] , \text{} … , [ Q ( {t}_{c} - 1 ) , p ( {t}_{c} - 1 ) ] ,$$

δ(t_{c}−1) (or δ(t_{c})) and Q̅(t_{c}) and inputting it to the first model, the first output result S(t_{c}) is obtained.

In this embodiment of the present application, the first model may be not distinguishing to services, or may be distinguishing to services. The possible services include, but are not limited to, video service, voice service, Internet access service, etc. Different services can be represented by different identification information, such as application ID, service ID, PDU (Protocol Data Unit) session (session) ID, QoS flow ID, DRB (Data Radio Bearer) ID, SRB (Signaling Radio Bearer) ID, etc.

Specifically, if the first model is not distinguishing to services, before the start of the time unit t, the UE runs a first model M(t), inputs the first input parameter into the first model, and determines whether to monitor the first signal in the time unit t according to the first output result of the first model.

If the first model is distinguishing to services, there will be multiple first models Mⱼ(t), j=1, . . . , J, respectively corresponding to different J services. Then, step S201 may specifically include: obtaining a first output result respectively corresponding to at least one service, by respectively inputting the first input parameter related to the at least one service into the first model respectively corresponding to the at least one service; and step S202 may specifically include: determining, based on the first output result respectively corresponding to the at least one service, whether to monitor the first signal within the to-be-monitored time unit.

Taking the UE having two services as an example, before the start of the time unit t, the UE runs a first model for each service, i.e., M₁(t) and M₂(t), respectively inputs the first input parameter of the service 1 and the first input parameter of the service 2 into M₁(t) and M₂(t) to obtain the first output result of M₁(t) and the first output result of M₂ (t), and determines whether to monitor the first signal at the time unit t based on the two first output results.

Further, determining, based on the first output result respectively corresponding to the at least one service, whether to monitor a first signal transmitted by a network entity within the to-be-monitored time unit may specifically include: not monitoring the first signal within the to-be-monitored time unit, if the first output result re-spectively corresponding to the at least one service indicates not to monitor the first signal within the to-be-monitored time unit; otherwise, monitoring the first signal within the to-be-monitored time unit.

Continuing from the above example, the first output results of the two first models M₁(t) and M₂(t) are processed by a post-processing module. The post-processing module works in the following way: if one of the first output results of all models run on the UE side indicates that the UE needs to monitor the first signal (for example, indicates that the UE needs to receive scheduling information), the output result from the post-processing module is to monitor signals; and if the output results of all models run on the UE side indicate that the UE does not need to monitor signals, the output result from the post-processing module is not to monitor signals.

In the embodiment of the present application, the method performed by the UE further includes the step of obtaining the first model by at least one of the following methods:
1. training, based on collected first data set, to generate the first model; and
2. receiving the first model from a network entity.

That is, the first model may be generated by training by the UE, or may be generated by training by the network entity.

Wherein, the network entities transmitting the first model can be a base station, a centralized unit of the base station, a control plane portion of the centralized unit of the base station, a distribution unit of the base station, a radio access network intelligent controller near real-time layer (Near-RT RIC, Near-Real Time-RAN (Radio Access Network) Intelligent Controller), NWDAF (NetWork Data Analytics Function) entity, OAM (Operation Administration and Maintenance) entity, artificial intelligence entity, etc.

Optionally, the network entity transmitting the first signal and the network entity transmitting the first model may be the same network entity or different network entities, e.g., the UE determines whether to monitor the first signal transmitted by the first network entity based on the first model, and the UE receives the first model from the second network entity, but not limited thereto.

In addition, the training of the model may be performed offline. For example, it may be trained in specified entities (e.g., network entities and UEs, etc.) and then dis-tributed. In another embodiment, the training of the model is performed online. Even if the model is transmitted to other entities, or the model is already in use, the training of the model is still in progress. That is, the model is trained by using the newly generated training data. Specifically, no matter which side the model is generated by, for the above “input parameter implementation I” the model training (which may also be un-derstood as the generation of the model) method includes the following steps:

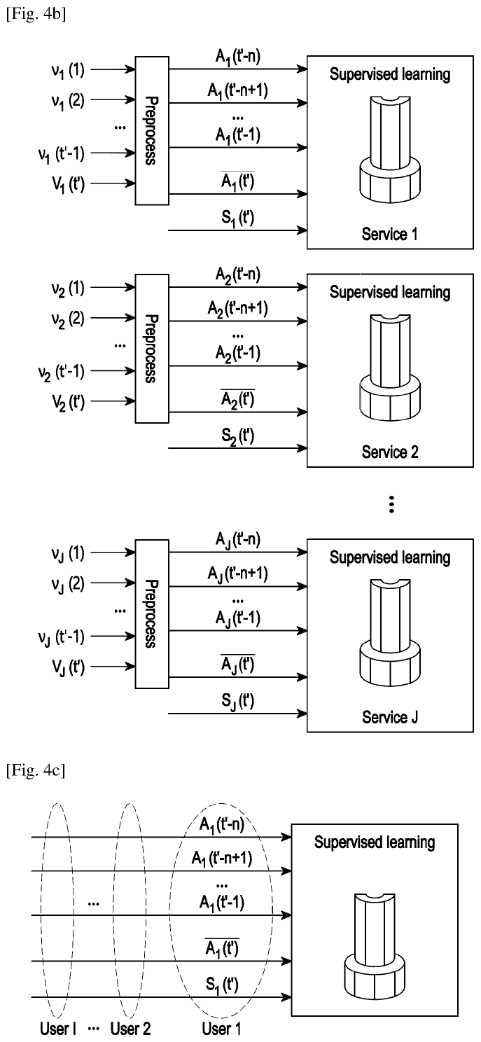

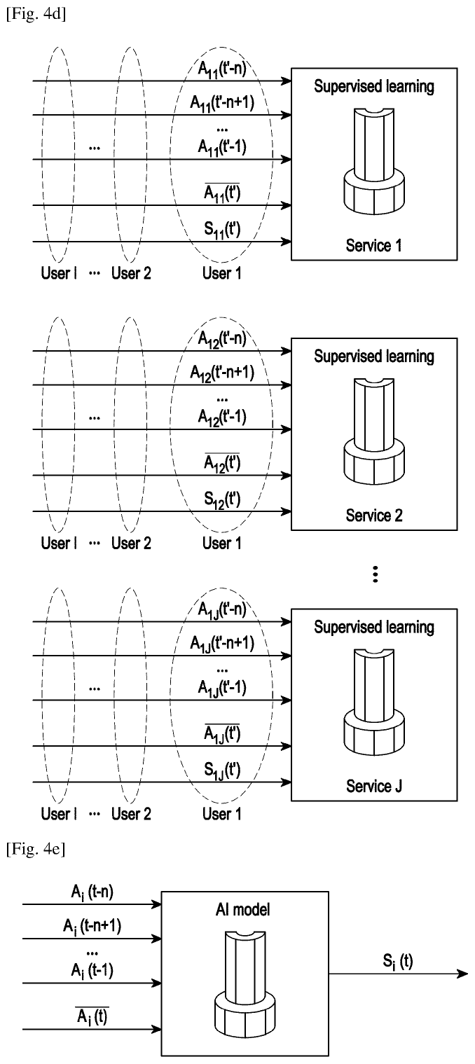

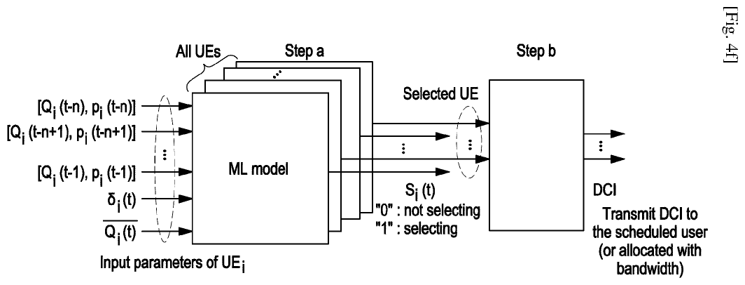

At step 4-1, a data set (training data set) for model training is collected. These data may be preprocessed data, for example, input parameters 1˜mₚ in FIG. 3, or data without preprocessing, for example, parameters nₚ+1˜nₚ+kₚ in FIG. 3. Based on the example in FIG. 4a, the data collected in each time unit is given in Table 1 below:

TABLE 1

| t′ − n | t′ − n + 1 | t′ − 1 | t′ | t′ + 1 |
|---|---|---|---|---|
| A(t′ − n) | A(t′ − n + 1) | A(t′ − 1) | A(t′) | A(t′ + 1) |
| V(t′ − n) | V(t′ − n + 1) | V(t′ − 1) | V(t′) | V(t′ + 1) |
| S(t′ − n) | S(t′ − n + 1) | S(t′ − 1) | S(t′) | S(t′ + 1) |
| ν(t′ − n) | ν(t′ − n + 1) | ν(t′ − 1) | ν(t′) | ν(t′ + 1) |

In the embodiment o the present application, the collected data set may be distinguishing to services. Specifically, each service will have a data set. Based on the example in FIG. 4b, the data collected for service j in each time unit is given in Table 2 below:

TABLE 2

| t′ − n | t′ − n + 1 | t′ − 1 | t′ | t′ + 1 |
|---|---|---|---|---|
| Aⱼ(t′ − n) | Aⱼ(t′ − n + 1) | Aⱼ(t′ − 1) | Aⱼ(t′) | Aⱼ(t′ + 1) |
| Vⱼ(t′ − n) | Vⱼ(t′ − n + 1) | Vⱼ(t′ − 1) | Vⱼ(t′) | Vⱼ(t′ + 1) |
| Sⱼ(t′ − n) | Sⱼ(t′ − n + 1) | Sⱼ(t′ − 1) | Sⱼ(t′) | Sⱼ(t′ + 1) |
| νⱼ(t′ − n) | νⱼ(t′ − n + 1) | νⱼ(t′ − 1) | νⱼ(t′) | νⱼ(t′ + 1) |

At the end of each time unit t′, if the UE has multiple services, the collected data set includes multiple sets of data for different services, and each set of data is (Aⱼ(t′), Vⱼ (t′), Sⱼ(t′), vⱼ(t′)), where j=1, . . . , J, J is the total number of services in the network.

In the embodiment of the present application, for the solution in which a model is generated by training on the network entity side, the collected data set may also be dis-tinguishing to UEs, or may also be distinguishing to both services and UEs.

Specifically, if the data set is distinguishing to UEs, each UE will have a data set which may be given by considering all services of the UE. For example, A(t′), V(t′), v(t′), etc., are obtained after considering all the services of the UE. Based on the example in FIG. 4c, the data collected for UEi in each time unit are given in Table 3 below:

TABLE 3

| t′ − n | t′ − n + 1 | t′ − 1 | t′ | t′ + 1 |
|---|---|---|---|---|
| Aᵢ(t′ − n) | Aᵢ(t′ − n + 1) | Aᵢ(t′ − 1) | Aᵢ(t′) | Aᵢ(t′ + 1) |
| Vᵢ(t′ − n) | Vᵢ(t′ − n + 1) | Vᵢ(t′ − 1) | Vᵢ(t′) | Vᵢ(t′ + 1) |
| Sᵢ(t′ − n) | Sᵢ(t′ − n + 1) | Sᵢ(t′ − 1) | Sᵢ(t′) | Sᵢ(t′ + 1) |
| νᵢ(t′ − n) | νᵢ(t′ − n + 1) | νᵢ(t′ − 1) | νᵢ(t′) | νᵢ(t′ + 1) |

At the end of each time unit t′, if there are multiple UEs in the network, the collected data set includes multiple sets of data for different UEs, and each set of data is (Aᵢ (t′), Vᵢ(t′), Sᵢ(t′), vᵢ(t′))′, where i=1, . . . , I, I is the total number of UEs in the network.

If it is distinguishing to both services and UEs, a data set only contains the data of a specific service of one UE. For example, A(t′), v(t′), v(t′), etc., are given by con-sidering a certain service of one UE. Based on the example in FIG. 4d, the data collected for the j-th service of UEi in each time unit are given in Table 4 below:

TABLE 4

| t′ − n | t′ − n + 1 | t′ − 1 | t′ | t′ + 1 |
|---|---|---|---|---|
| Aᵢⱼ(t′ − n) | Aᵢⱼ(t′ − n + 1) | Aᵢⱼ(t′ − 1) | Aᵢⱼ(t′) | Aᵢⱼ(t′ + 1) |
| Vᵢⱼ(t′ − n) | Vᵢⱼ(t′ − n + 1) | Vᵢⱼ(t′ − 1) | Vᵢⱼ(t′) | Vᵢⱼ(t′ + 1) |
| Sᵢⱼ(t′ − n) | Sᵢⱼ(t′ − n + 1) | Sᵢⱼ(t′ − 1) | Sᵢⱼ(t′) | Sᵢⱼ(t′ + 1) |
| νᵢⱼ(t′ − n) | νᵢⱼ(t′ − n + 1) | νᵢⱼ(t′ − 1) | νᵢⱼ(t′) | νᵢⱼ(t′ + 1) |

At the end of each time unit t′, if there are multiple UEs in the network and each UE has multiple services, the collected data set includes multiple sets of data Aᵢⱼ (t′), Vᵢⱼ(t′), Sᵢⱼ(t′), vᵢ (t′), where i=1, . . . , I, j=1, . . . , j, I is the total number of UEs in the network, and J is the total number of services in the network.

Wherein, for the meanings of the parameters in Tables 1 to 4, reference may be made to the introduction to the first input parameter, which will not be repeated here.

For the “input parameter implementation II” described above, the method of training (also understood as model generation) of the model comprises the following steps:

Step 4-1: Collecting a data set for model training (training data set), which may be pre-processed data, such as input parameters 1˜mₚ in FIG. 3, or data without preprocessing, such as parameters nₚ+1˜nₚ+kₚ in FIG. 3. The data collected at each time unit is given in Table 5.

TABLE 5

| t′ − n | t′ − n + 1 | t′ − 1 | t′ | t′ + 1 |
|---|---|---|---|---|
| Q(t′ − n) | Q(t′ − n + 1) | Q(t′ − 1) | Q(t′) | Q(t′ + 1) |
| p(t′ − n) | p(t′ − n + 1) | p(t′ − 1) | p(t′) | p(t′ + 1) |
| δ(t′ − n) | δ(t′ − n + 1) | δ(t′ − 1) | δ(t′) | δ(t′ + 1) |
| Q̅(t′ − n) | Q̅(t′ − n + 1) | Q̅(t′ − 1) | Q̅(t′) | Q̅(t′ + 1) |

In one example, for the “input parameter implementation V” described above, the data collected in the above step 4-1 may also include the indication information F(t′) of the service type.

In the embodiment of the present application, the collected data sets may be distinguishing to services. Specifically, there will be one data set for each service, and the data collected at each time unit for service j is given through Table 6:

TABLE 6

| t′ − n | t′ − n + 1 | t′ − 1 | t′ | t′ + 1 |
|---|---|---|---|---|
| Qⱼ(t′ − n) | Qⱼ(t′ − n + 1) | Qⱼ(t′ − 1) | Qⱼ(t′) | Qⱼ(t′ + 1) |
| pⱼ(t′ − n) | pⱼ(t′ − n + 1) | pⱼ(t′ − 1) | pⱼ(t′) | pⱼ(t′ + 1) |
| δⱼ(t − n) | δⱼ(t′ − n + 1) | δⱼ(t′ − 1) | δⱼ(t′) | δⱼ(t′ + 1) |
| Q̅ⱼ̅(t′ − n) | Q̅ⱼ̅(t′ − n + 1) | Q̅ⱼ̅(t′ − 1) | Q̅ⱼ̅(t′) | Q̅ⱼ̅(t′ + 1) |

At the end of each time unit t′, if the UE has multiple services, the collected dataset includes multiple sets of data for different services, each set being Qⱼ(t′), pⱼ(t′), δⱼ(t′), Q̅ⱼ̅(t′), where j=1, . . . , J and J is the total number of services in the network.

In the embodiment of the present application, for the scheme of training and generating the model on the network entity side, the collected data set may also be dis-tinguishing to UEs, or may also be distinguishing to both services and UEs.

Specifically, if it is distinguishing to UEs there is a dataset for each UE, which may be given considering all the services of the UE, and the data collected at each time unit for UEi are given through Table 7 as follows.

TABLE 7

| t′ − n | t′ − n + 1 | t′ − 1 | t′ | t′ + 1 |
|---|---|---|---|---|
| Qᵢ(t′ − n) | Qᵢ(t′ − n + 1) | Qᵢ(t′ − 1) | Qᵢ(t′) | Qᵢ(t′ + 1) |
| pᵢ(t′ − n) | pᵢ(t′ − n + 1) | pᵢ(t′ − 1) | pᵢ(t′) | pᵢ(t′ + 1) |
| δᵢ(t′ − n) | δᵢ(t′ − n + 1) | δᵢ(t′ − 1) | δᵢ(t′) | δᵢ(t′ + 1) |
| Q̅ᵢ(t′ − n) | Q̅ᵢ(t′ − n + 1) | Q̅ᵢ(t′ − 1) | Q̅ᵢ(t′) | Q̅ᵢ(t′ + 1) |

At the end of each time unit t′, if there are multiple UEs in the network, the collected data set includes data from multiple sets of different UEs, each set being Qᵢ(t′), pᵢ(t′), δᵢ(t′), Q̅ᵢ̅(t′), where i=1, . . . , I and I is the total number of UEs in the network. Further, each set of data may also include the indication information Fᵢ(t′) of the service type.

If it is distinguishing to both services and UEs, a dataset contains data for a particular service of a UE only, and the data collected at each time unit for the jth service of UEi are given through Table 8 as follows.

TABLE 8

| t′ − n | t′ − n + 1 | t′ − 1 | t′ | t′ + 1 |
|---|---|---|---|---|
| Qᵢⱼ(t′ − n) | Qᵢⱼ(t′ − n + 1) | Qᵢⱼ(t′ − 1) | Qᵢⱼ(t′) | Qᵢⱼ(t′ + 1) |
| pᵢⱼ (t′ − n) | pᵢⱼ (t′ − n + 1) | pᵢⱼ (t′ − 1) | pᵢⱼ (t′) | pᵢⱼ (t′ + 1) |
| δᵢⱼ(t′ − n) | δᵢⱼ(t′ − n + 1) | δᵢⱼ(t′ − 1) | δᵢⱼ(t′) | δᵢⱼ(t′ + 1) |
| Q̅ᵢ̅ⱼ̅(t′ − n) | Q̅ᵢ̅ⱼ̅(t′ − n + 1) | Q̅ᵢ̅ⱼ̅(t′ − 1) | Q̅ᵢ̅ⱼ̅(t′) | Q̅ᵢ̅ⱼ̅(t′ + 1) |

At the end of each time unit t′, if there are multiple UEs in the network and each UE has multiple services, the collected data set includes multiple sets of data, Qᵢⱼ(t′), pᵢⱼ(t′), δᵢⱼ(t′), Q̅ᵢ̅ⱼ̅(t′), where i=1, . . . , I, j=1, . . . , J, I is the total number of UEs in the network, and J is the total number of services in the network

Wherein, the meanings of the parameters in Tables 5 to 8 can be found in the introduction to the first input parameters, which will not be repeated here.

Further, the data set collected in this step may be generated according to one or more of the following methods:
1. It is generated by scheduling UEs corresponding to the base station by a scheduling algorithm, and the data in the data set may be obtained by scheduling UEs by the base station within a period of time.
2. It is generated by scheduling UEs corresponding to the base station by a model, and the model may be the first model and/or second model. Further, the scheduling may be performed according to the methods in FIGS. 1a to 1d. The data in the data set may be obtained by scheduling UEs by the base station within a period of time.

Additionally, this training data set is continuously updated as the schedule progresses.

At step 4-2, sample data for model training is selected from the collected data set.

As shown in FIG. 3, a set of sample data includes input parameters 1˜mₚ and parameters nₚ+1˜nₚ+kₚ.

Optional, for the above “input parameter implementation I”, taking FIG. 4a as an example, for the time unit t′, a set of input data samples includes A(t′−1), A(t′−2), . . . , A(t′−n), A̅(̅t̅′̅)̅, S(t′), where A̅(̅t̅′̅)̅ is obtained according to Formula 3 above. Referring to FIG. 4b to FIG. 4d, if the sample data is distinguishing to services, a set of sample data is for service j, i.e., Aⱼ(t′−1), Aⱼ(t′−2), . . . , Aⱼ(t′−n), A̅ⱼ̅(̅t̅′̅)̅, S̅ⱼ̅(̅t̅′̅)̅; if the sample data is distinguishing to UEs, a set of sample data is for UEi, i.e., Aᵢ (t′−1), A (t′−2), . . . , Aᵢ (t′−n), A̅ᵢ̅(̅t̅′̅)̅, Sᵢ(t′); and if the sample data is distinguishing to both UEs and services, a set of sample data is for service j of UEi i.e., Aᵢⱼ(t′−1), Aᵢⱼ(t′−2), . . . , Aᵢⱼ(t′−n), A̅ᵢ̅ⱼ̅(̅t̅′̅)̅, Sᵢⱼ(t′).

Optionally, for the above “input parameter implementation II”, in one implementation, for time unit t′, a set of input data samples includes [Q(t′−1), p(t′−1), δ(t′−1)], [Q(t′−2), p(t′−2), S(t′−2)] . . . [Q(t′−n), p(t′−n), δ(t′−n)], Q̅(̅t̅′̅)̅, S(t′). A set of sample data is specific to service j if the sample data is distinguishing to services, i.e., [Qⱼ (t′−1), pⱼ (t′−1), [δⱼ(t′−1)], [Qⱼ (t′−2), pⱼ (t′−2), δⱼ (t′−2)], . . . , [Qⱼ(t′−n), pⱼ (t′−n), δⱼ(t′−n)], Q̅ⱼ̅(̅t̅′̅)̅, Sⱼ(t′); a set of sample data is for UEi if the sample data is distinguishing UEs, i.e., [Qᵢ(t′−1), pᵢ(t′−1), δᵢ(t′−1)], [Qᵢ(t′−2), pᵢ(t′−2), δᵢ(t′−2)], . . . , [Qᵢ(t′−n), pᵢ(t′−n), δᵢ(t′−n)], Q̅ᵢ̅(̅t̅′̅)̅, Sⱼ(t′); if the sample data is distinguishing both UEs and services, then a set of sample data is for service j of UE i, i.e., [Qᵢⱼ(t′−1), pᵢⱼ(t′−1), δᵢⱼ(t′−1)], [Qᵢⱼ(t′−2), pᵢⱼ(t′−2), δᵢⱼ(t′−2)], . . . , [Qᵢⱼ(t′−n), pᵢⱼ(t′−n), δᵢⱼ(t′−n)], Q̅ᵢ̅ⱼ̅(̅t̅′̅)̅, Sᵢⱼ(t′). In another implementation, for the time unit t′, a set of input data samples includes [Q(t′−1), p(t′−1)], [Q(t′−2), p(t′−2)], . . . , [Q(t′−n), p(t′−n)], Q̅(̅t̅′̅)̅, δ(t′−1) (or δ(t′), S(t′). A set of sample data is specific to service j if the sample data is distinguishing to services, i.e., [Qᵢ(t′−1), pᵢ(t′−1)], [Qᵢ(t′−2), pᵢ(t′−2)], . . . , [Qᵢ(t′−n), pᵢ(t′−n)], Q̅ᵢ̅ (̅t̅′̅)̅, δᵢ(t′−1) (or δ̅ⱼ̅ (̅t̅′̅)̅), Sᵢ(t′); a set of sample data is for UEi if the sample data is distinguishing to UE, i.e., [Qᵢ(t′−1), pᵢ(t′−1)], [Qᵢ(t′−2), pᵢ(t′−2)], . . . , [Qᵢ(t′−n), pᵢ(t′−n)], Q̅ᵢ̅(̅t̅′̅)̅, δᵢ(t′−1) (or δᵢ(t′)), Sᵢ(t′); if the sample data is distinguishing to both UEs and services, a set of sample data is for service j of UEi, i.e., [Qᵢⱼ(t′−1), pᵢⱼ (t′−1)], [Qᵢⱼ(t′−2), pᵢⱼ(t′−2)], . . . , [Qᵢⱼ(t′−n), pᵢⱼ (t′−n)], Q̅ᵢ̅ⱼ̅ (̅t̅′̅)̅, δᵢⱼ(t′−1) (or δᵢⱼ (t′)), Sᵢⱼ(t′).

Optionally, for the above “input parameter implementation V”, in one implementation, for time unit t′, a set of input data samples includes [Q(t′−1), p(t′−1), δ(t′−1)], [Q(t′−2), p(t′−2), δ(t′−2)], . . . , [Q(t′−n), p(t′−n), δ(t′−n)], Q̅(̅t̅′̅)̅, F(t′), S(t′). A set of sample data is for UEi if the sample data is distinguishing UEs, i.e. [Qᵢ(t′−1), pᵢ (t′−1), δᵢ (t′−1)], [Qᵢ(t′−2), pᵢ(t′−2), δᵢ(t′−2)], . . . , [Qᵢ(t′−n), pᵢ(t′−n), δᵢ(t′−n)], Q̅ᵢ̅(̅t̅′̅)̅, Fᵢ (t′), Sᵢ(t′). In another implementation, for the time unit t′, a set of input data samples includes [Q(t′−1), p(t′−1)], [Q(t′−2), p(t′−2)], . . . , [Q(t′−n), p(t′−n)], Q̅(̅t̅′̅)̅, F(t′), δ(t′−1) (or δ(t′)), S(t′). A set of sample data is for UEi if the sample data is distinguishing to UEs, i.e., [Qᵢ(t′−1), pᵢ(t′−1)], [Qᵢ(t′−2), pᵢ(t′−2)] . . . , [Qᵢ(t′−n), pᵢ(t′−n)], Q̅ᵢ̅ (̅t̅′̅)̅, Fᵢ (t′), δᵢ (t′−1) (or δᵢ(t′)), Sᵢ(t′).

At step 4-3, the selected sample data is input into the program for training the model, and then the model is trained by the program. The model is trained according to whether the sample data is distinguishing to services. The embodiment of the present invention has two different ways of model training.
training method 1: model training in the case that the sample data is not distinguishing to services. In this training method, the model obtained by training is not dis-tinguishing to services. That is, when the model is used subsequently, it is unnecessary to take the services of the UE into consideration.
for the above “input parameter implementation I”, taking FIG. 4a as an example, the sample data A(t′−1), A(t′−2), . . . , A(t′−n), A̅(̅t̅′̅)̅, S(t′) in the time unit t′ is input into the program for model training. Or, taking FIG. 4c as an example, multiple sets of sample data will be generated in the time unit t′, and each set of sample data includes Aᵢ(t′−1), Aᵢ(t′−2), . . . , Aᵢ(t′−n), A̅ᵢ̅(̅t̅′̅)̅, Sᵢ(t′). The multiple sets of data may be sequentially input into the program for model training.

For the above “input parameter implementation II”, in one implementation, sample data of time unit t′ [Q(t′−1), p(t′−1), δ(t′−1)], [Q(t′−2), p(t′−2), δ(t′−2)], . . . , [Q(t′−n), p(t′−n), S(t′−n)], Q̅(̅t̅′̅)̅, S(t′) is input to the program for model training. Or, multiple set of sample data will be generated in the time unit t′, each set comprising [Qᵢ (t′−1), pᵢ(t′−1), δᵢ(t′−1)], [Qᵢ(t′−2), pᵢ(t′−2), δᵢ(t′−2)], . . . , [Qᵢ(t′-n), pᵢ (t′−n), δᵢ(t′−n)], Q̅ᵢ̅(̅t̅′̅)̅, Sᵢ (t′), the multiple set of data may be sequentially input into the program for model training. In another implementation, sample data of the time unit t′[Q(t′−1), p(t−1], [Q(t′−2), p(t′-2)], . . . , [Q(t′−n), p(t′-n)], Q̅(̅t̅′̅)̅, δ(t′−1) (or δ(t′)), S(t′) is input to the program for model training. Or, multiple set of sample data will be generated in the time unit t′, each set comprising [Qᵢ(t′−1), pᵢ(t′−1)], [Qᵢ(t′−2), pᵢ (t′−2)], . . . , [Qᵢ(t′−n), pᵢ (t′−n)], Q̅ᵢ̅ (̅t̅′̅)̅, δᵢ(t′−1) (or δᵢ(t′)), Sᵢ (t′), the multiple set of data may be sequentially input into the program for model training. The model trained in this way may be expressed as M(t′).

For the above “input parameter implementation V”, in one implementation, sample data of time unit t′ [Q(t′−1), p(t′−1), S(t′−1)], [Q(t′−2), p(t′−2), S(t′−2)], . . . , [Q(t′−n), p(t′−n), δ(t′−n)], Q̅(̅t̅′̅)̅, F(t′), S(t′) is input to the program for model training. Or, multiple set of sample data will be generated in the time unit t′, each set comprising [Q(t′−1, pᵢ (t′−1), δᵢ (t′−1)], [Qᵢ (t′−2), pᵢ(t′−2), δᵢ(t′−2)], . . . , [Qᵢ (t′−n, pᵢ(t′−n), δᵢ (t′−n)], Qᵢ(t′), Fᵢ(t′), Sᵢ (t′), the multiple set of data may be sequentially input into the program for model training. In another implementation, sample data of the time unit t′ [Q(t′−1), p (t′−1)], [Q(t′−2), p(t′−2)], . . . , [Q(t′−n), p(t′−n)], Q(t′), F(t′), δ(t′−1) (or δ(t′)), S(t′) is input to the program for model training. Or, a multiple set of sample data will be generated in the time unit t′, each set comprising [Qᵢ(t′−1), pᵢ (t′−1)], [Qᵢ(t′−2), pᵢ (t′−2)], . . . , [Qᵢ(t′−n), pᵢ(t′−n)], Q̅ᵢ̅(̅t̅′̅)̅, Fᵢ (t′), δᵢ(t′−1) (or δᵢ (t′)), Sᵢ(t′), the multiple set of data may be sequentially input into the program for model training. The model trained in this way may be expressed as M(t′).
training method 2: model training in the case that the sample data is distinguishing to services. In this training method, the model obtained by training is distinguishing to services. That is, for a different service, a model corresponding to the service will be trained.

Optionally, for the above “input parameter implementation I”, taking FIG. 4b as an example, multiple sets of sample data will be generated in the time unit t′, and each set of sample data includes Aᵢ(t′−1), Aᵢ(t′−2), . . . , Aᵢ(t′−n), A̅ᵢ̅ (̅t̅′̅)̅, Sᵢ(t′). If the trained model is for service b, the data A_{b}(t′−1), A_{b} (t′−2), . . . , A_{b} (t′−n), A̅_̅{̅b̅}̅ (̅t̅′̅)̅, S_{b}(t′) corresponding to the model is input into the program for model training. Or, taking FIG. 4b as an example, multiple sets of sample data will be generated in the time unit t′, and each set of sample data includes Aᵢⱼ(t′−1), Aᵢⱼ(t′−2), . . . , Aᵢⱼ (t′−n), A̅ᵢ̅ⱼ̅ (̅t̅′̅)̅, Sᵢⱼ (t′). If the trained model is for service b, the data input to the model for training includes multiple sets of data, and each set of data is A_{ib}(t′−1), A_{ib}(t′−2), . . . , A_{ib}(t′−n), A̅_̅{̅i̅b̅}̅(̅t̅′̅)̅, S_{ib}(t′). The multiple sets of data may be sequentially input into the program for model training.

Optionally, for the above “input parameter implementation II”, in one implementation, for time unit t′, multiple sets of sample data will be generated in the time unit t′, each set of sample data includes [Qⱼ(t′−1), pⱼ(t′−1), δⱼ(t′−1)], [Qⱼ(t′−2), pⱼ (t′−2), δⱼ(t′−2)], . . . , [Qⱼ (t′−n), pⱼ (t′−n), δⱼ(t′−n)], Q̅ⱼ̅(̅t̅′̅)̅, Sⱼ (t′). If the trained model is for service b, the data [Q_{b}(t′−1), p_{b}(t′−1), δ_{b}(t′−1)], [Q_{b}(t′−2), p_{b} (t′−2)], δ_{b}(t′−2)], . . . , [Q_{b}(t′−n), p_{b}(t′−n), δ_{b}(t′−n)], Q̅_̅{̅b̅}̅(̅t̅′̅)̅, S_{b}(t′) corresponding to this model for training is input to the program for model training. Or, multiple sets of sample data will be generated in the time slot t′, each set of sample data comprising [Qᵢⱼ(t′−1), pᵢⱼ(t′−1), δᵢⱼ(t′−1)], [Qᵢⱼ (t′−2), pᵢⱼ(t′−2), δᵢⱼ (t′−2)], . . . , [Qᵢⱼ(t′−n), pᵢ(t′−n), Sᵢⱼ(t′−n)], Q̅ᵢ̅ⱼ̅(̅t̅′̅)̅, Sᵢⱼ (t′). If the trained model is for the service b, the data input to this model for training includes multiple sets of sample data, each set of data comprising [Q_{ib}(t′−1), p_{ib}(t′−1), δ_{ib} (t′−1)], [Q_{ib}(t′−2), p_{ib}(t′−2), δ_{ib}(t′−2)], . . . , [Q_{ib}(t′−n), p_{ib}(t′−n), δ_{ib}(t′−n)], Q̅_̅{̅i̅b̅}̅(̅t̅′̅)̅, S_{ib}(t′), the multiple set of data may be sequentially input into the program for model training. In one implementation, multiple sets of sample data will be generated in the time slot t′, each set of sample data comprising [Qⱼ(t′−1), pⱼ(t′−1)], [Qⱼ(t′−2), pⱼ (t′−2)], . . . , [Qⱼ(t′−n), pⱼ (t′−n)], Q̅ⱼ̅(̅t̅′̅)̅, δⱼ(t′−1) (or δⱼ)), Sⱼ(t). If the trained model is for the service b, the data corresponding to this model for training [Q_{b} (t′−1), p_{b} (t′−1)], [Q_{b} (t′−2), p_{b} (t′−2)], . . . , [Q_{b}(t′−n), p_{b}(t′−n)], Q̅_̅{̅b̅}̅ (̅t̅′̅)̅, δ_{b} (t′−1) (or δ_{b} (t′), S_{b}(t′) is input the program for model training. Or, multiple set of sample data will be generated in the time slot t′, each set of sample data comprising [Qᵢⱼ(t′−1), pᵢⱼ(t′−1)], [Qᵢⱼ(t′−2), pᵢⱼ(t′−2)], . . . , [Qᵢⱼ(t′−n), pᵢⱼ(t′−n)], Q̅ᵢ̅ⱼ̅(̅t̅′̅)̅, δᵢⱼ(t′−1) (or δᵢⱼ(t′)), Sᵢⱼ(t′). If the trained model is for service b, the data input to the model for training includes multiple sets of data, each set of date comprising [Q_{ib}(t′−1), p_{ib}(t′−1)], [Q_{ib}(t′−2), p_{ib}(t′−2)], . . . , [Q_{ib}(t′−n), p_{ib}(t′−n)], Q̅_̅{̅i̅b̅}̅(̅t̅′̅)̅, δ_{ib} (t′−1) (or δ_{ib}(t′)), S_{ib}(t′), the multiple set of data may be sequentially input into the program for model training. There are multiple models trained in this way, each model is for a certain service j, and the multiple models may be expressed as Mⱼ(t′), j=1, . . . , J.

For each model obtained by performing steps 4-1 to 4-3 at the network entity, re-gardless of whether it is distinguishing to services, each model is applicable to each UE. If the model is for a certain service, the model is applicable to all UEs using the service.

By the AI model trained in the training way, the network entity or UEi can input parameters Aᵢ(t−1), . . . , Aᵢ(t−2), Aᵢ(t−n) and A̅ᵢ̅(̅t̅)̅ related to the time unit t of user i into the model, and the model outputs an inference result Sᵢ(t) for UEi, as shown in FIG. 4e. Or, the network entity or the UEi may input the parameters related to the time unit t of UEi [Qᵢ(t−1), pᵢ(t−1), δᵢ(t−1)], [Qᵢ(t−2), pᵢ(t−2), δᵢ(t−2)], . . . , [Qᵢ(t−n), pᵢ(t−n), δᵢ(t−n)] and Q̅ᵢ̅(̅t̅)̅ into the model, and the model outputs the inference result Sᵢ(t) of the UEi; or, the network entity or the UEi inputs the parameters related to the time unit t of UE i [Qᵢ (t−1), pᵢ(t−1), δᵢ(t−1)], [Qᵢ(t−2), pᵢ(t−2), δᵢ(t−2)], . . . , [Qᵢ(t−n), pᵢ(t−n), δᵢ(t−n)], Fᵢ(t), and Q̅ᵢ̅(̅t̅)̅ into the model, and the model outputs the inference result Sᵢ(t) of the UEi. Or, as shown in FIG. 4f, the network entity or the UEi may input the parameters related to the time unit t of UEi [Qᵢ(t−1), pᵢ(t−1)], [Qᵢ(t−2), pᵢ(t−2)], . . . , [Qᵢ(t−n), pᵢ(t−n)], δᵢ(t−1) (or δᵢ(t)) and Q̅ᵢ̅(̅t̅)̅ into the model, and the model outputs the inference result Sᵢ(t) of the UEi; or, the network entity or the UEi inputs the parameters related to the time unit t of UE i [Qᵢ(t−1), pᵢ(t−1)], [Qᵢ(t−2), pᵢ(t−2)], . . . , [Qᵢ(t−n), pᵢ(t−n)], Fᵢ(t), δᵢ(t−1) (or δᵢ(t)) and Q̅ᵢ̅(̅t̅)̅ into the model, and the model outputs the inference result Sᵢ(t) of the UEi.

In one example, as shown in FIG. 4f, the scheduling of the user on the base station side will include two steps:
step a: the base station uses the input parameter of each user as the input of the same model, and the inference result of the model indicates whether the user is selected, for example, “0” means not selecting and “1” means selecting;
step b: for the selected users indicated by the inference result of the model, the base station allocates bandwidth for these selected users through a scheduler, and finally transmits the DCI to the users allocated with bandwidth.

According to the steps 4-1 to 4-3, the first model up to the time unit t′ may be obtained. That is, if the first model is not distinguishing to services, the model is M(t′); and if the model is distinguishing to services, there will be multiple latest models, i.e., Mⱼ(t′), j=1, . . . , J.

In the embodiment of the present application, as time progresses, the steps 4-1 to 4-3 may be continued in subsequent time units (e.g., t′+1, t′+2, . . . ), so that the model is continuously updated.

Specifically, in each time unit t′, the newly obtained data set may be input into the model training program, and the model may be updated in real time. It is not difficult to understand that data for model training may be generated in each time unit, and the data may be used to update the model.

In the embodiment of the present application, the updating of the model may be performed periodically. Specifically, in each cycle, the data generated in the cycle may be input into the model training program to train the model, and at the end of each cycle, a new model may be obtained. The model update cycle may be one or more time units. For example, the model may be updated once every slot, or updated once every hundreds of milliseconds, or several seconds, or other possible cycle lengths. The model update cycle may be set by a person of ordinary skill in the art according to the actual situation. It will not be defined in the embodiment of the present application. In other embodiments, the model may also be updated based on other timings, for example, when the network state and/or the UE state change to a certain extent, but not limited thereto.

According to the above model training method, the UE may generate and/or update the first model, or the network entity may generate and/or update the first model and/or second model.

In the embodiment of the present application, if the first model is generated by training at the base station (or obtained from other entity, and the first model is generated by other entity through training), after obtaining the first model, the base station side needs to deploy the first model to the UE side (i.e., transmits it to the UE). Similarly, if the base station side updates the first model in real time (or the updated model is obtained from other entity), it also needs to deploy the updated model to the UE side. That is, when the base station wants to transmit the first model to the UE, the base station needs to transmit the current latest model to the UE.

An embodiment of the present application provides a model deployment method, which implements the deployment of the first model generated on the network entity side to the UE side. Taking the scheduling of the UE by the base station as an example, on one hand, the base station and the UE will determine whether the scheduling information of the UE needs to be available within the to-be-monitored time unit according to the model. If the UE can obtain the latest first model, the performance of the UE may be guaranteed. Therefore, timely transmitting the latest first model to the UE is beneficial to the data transmission of the UE. On the other hand, when the first model is transmitted to the UE, radio resources of the air interface need to be occupied. In order to ensure the performance of the UE and save air interface resources, an embodiment of the present application proposes a deployment mechanism for the first model, which can avoid excessive air interface resource occupation caused by transmitting the first model to the UE too frequently, thereby guaranteeing the performance of the UE on the basis of saving air interface resources.

For the embodiment of the present application, it can be that the base station transmits the generated first model to the UE, or it can be that the base station transmits the first model generated by this other entity obtained from the other entity to the UE, or it can be that any network entity transmits its generated first model to the UE, and for the sake of description, the following is introduced as an example of the base station transmitting the first model to the UE (i.e., the base station in the embodiment of the present application can be replaced by other network entities).

In the embodiment of the present application, the deployment of the model mainly includes the following stages:
Stage 1: Initial deployment of the UE-side model

At this stage, the base station needs to transmit the first model to some UEs that have not obtained the model, so that the UE or these UEs can determine whether there is a target signal within the to-be-monitored time unit according to the first model. Op-tionally, before transmitting the first model, the base station may detect the performance of the model, and if it is determined that the new first model is a model with good performance, the base station may transmit the first model to the UE. And/or, the base station will determine whether the current QoS requirements of the UE are satisfied before transmitting the first model, and if so, it can transmit the latest first model to the UE. The specific model performance detection method will be introduced below.
Stage 2: Update of the UE-side model

After the base station transmits the first model to the UE, because the state of the network (for example, the number of UEs, cell load, etc.) may change, and/or the state of the UE (for example, channel state, service, etc.) may change, and/or the QoS state of the UE may change (e.g., whether the QoS requirements are satisfied, whether there is a degradation in the achieved QoS performance, etc.), the first model of the serving UE can be updated in time in order to maintain the performance of the first model.

At this stage, the base station needs to determine the way to update the model of the UE. Optionally, the base station may use at least one of the following two ways to update the model of the UE:
1. Synchronous update. That is, the base station may transmit the latest first model to multiple UEs (or may be all the UEs) at the same time. Optionally, the base station may transmit the first model to multiple UEs in a broadcast or unicast manner.
2. Asynchronous update. That is, the base station may transmit the latest first model to the selected UE, so that the updating of the first model of different UEs may occur at different times, and the models used by different UEs may also be different. Op-tionally, the base station may transmit the first model to the selected UE in a broadcast or unicast manner.

Then, for the UE, receiving the first model from the network entity includes at least one of the following situations:
1. Receiving the first model updated in a synchronous manner from the network entity; and
2. Receiving the first model updated in an asynchronous manner from the network entity;
3. Receiving the directly updated first model from the network entity.

It may be understood that, for synchronous update and asynchronous update, the network needs to determine when to update the model of the UE, and for asynchronous update, the network also needs to determine which UE models to update.

In the embodiment of the present application, the timing of synchronous update may be when the cycle of synchronous update is reached, and/or when it is determined that the number of UEs for which the first model needs to be updated is greater than the first threshold value.

That is, for the UE, receiving the first model updated in a synchronous manner from the network entity includes at least one of the following situations:
1. periodically receiving, from the network entity, the first model updated in a synchronous manner;
2. receiving, from the network entity, the first model updated in a synchronous manner, if the number of UEs for which the first model needs to be updated is greater than a first threshold value.

In the embodiment of the present application, the timing of asynchronous update may be when it is determined in real time that there are UEs for which the first model needs to be updated and/or the number of UEs for which the first model needs to be updated is not greater than the first threshold value.

That is, for the UE, receiving the first model updated in an asynchronous manner from the network entity includes: receiving, from the network entity, the first model updated in an asynchronous manner, if the number of UEs for which the first model needs to be updated is not greater than a first threshold value when it is needed to update the first model.

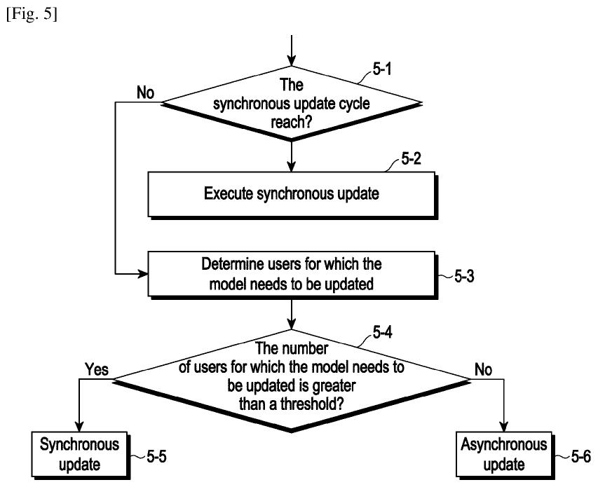

In the embodiment of the present application, FIG. 5 shows an example of a flow for the base station to update the UE-side model so that the base station can dynamically update the model of the UE. Specifically, the flow may include following steps:

Step 5-1: The cycle of synchronous update is determined. If the cycle of synchronous update is reached, step 5-2 is performed; otherwise, step 5-3 is performed.

Step 5-2: The base station performs synchronous update. The base station transmits the latest first model to all UEs for which the first model is deployed, in a broadcast (transmits to multiple UEs simultaneously) or unicast (e.g., transmits to each UE indi-vidually) manner.

Step 5-3: The UE that needs to update the model is determined. The specific deter-mination method will be introduced below.

Step 5-4: The number of UEs that need to update the model is determined. If the number of UEs exceeds a threshold value (for example, the first threshold value), step 5-5 is performed; otherwise, step 5-6 is performed.

Step 5-5: The base station performs synchronous update. The base station transmits the latest first model to the UEs in a broadcast (transmits to multiple UEs simul-taneously) or unicast (e.g., transmits to each UE individually) manner.

Step 5-6: The base station performs asynchronous update. The base station transmits the latest first model to the UEs that need to update the model determined in the step 5-3, in a broadcast (transmits to multiple users simultaneously) or unicast (e.g., transmits to each user individually) manner.

The above synchronous and asynchronous updates are determined by the network entity, while the UE only receives the updated model. It should be noted that the network entity can also perform a model update without the above distinction between synchronous and asynchronous updates, and directly select the UE that needs to update the model (e.g., “directly update the first model” above).

In the embodiment of the present application, the network entity can determine the UE for which the first model needs to be updated by at least one of the following information:
1. a detection result of the network performance in using the first model and a second threshold value;
2. a detection result of the UE performance in using the first model and a third threshold value;
3. the number of update times of the first model and a fourth threshold value.

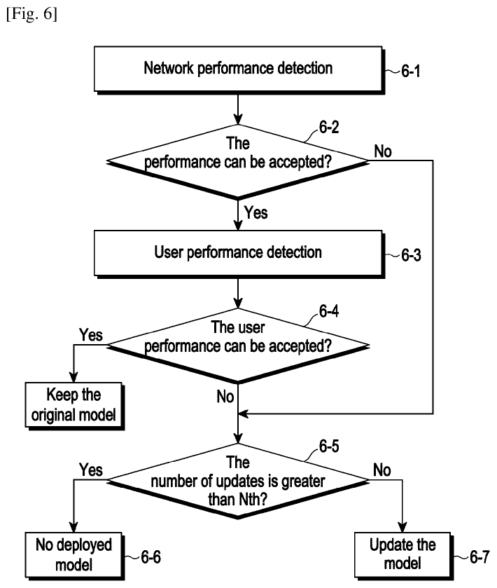

In the embodiment of the present application, FIG. 6 shows an example of a flow of determining the UE for which the first model needs to be updated. The base station can determine which UE-side first model needs to be updated by monitoring network performance and UE performance. Specifically, the flow may include following steps.

Step 6-1: Detection of network performance. The base station obtains the network performance obtained after transmitting the first model to the UE (that is, the UE uses the first model). In an optional implementation, the network performance may be the spectral efficiency achieved by the network:

S_{eff}=Σᵢ₌₁^{M}Tᵢ/BW
where, M represents the number of UEs in the cell; Tᵢ represents the throughput achieved by UEi; BW represents the system bandwidth of the cell.

In another optional implementation, the network performance may be network load, for example, the number or percentage of used resources, the number of users, etc.

The examples of measuring network performance may also have other types of parameters, for example, latency, throughput, interference, packet loss rate, energy efficiency, etc., which are not limited here.

Step 6-2: Determination of network performance. Taking the network performance being S_eff as an example, if S_{eff}>Sₜₕ where S_{eff} is obtained in the step 6-1, the flow goes to step 6-3 or directly goes to step 6-7 (as shown by the dotted line in FIG. 6), otherwise goes to step 6-5 or directly goes to step 6-6 (as shown by the dotted line in FIG. 6). Sₜₕ is a threshold value for determining the network performance (for example, the second threshold value). The threshold value is determined according to the network performance that may be achieved when the first model is not used, for example, but not limited thereto, 90% of the network spectral efficiency that can be achieved when the UE does not use the first model. Taking the network load as an example, if the network load obtained in step 6-1 above is greater than a threshold value, then it goes to step 6-3 or step 6-7, otherwise go to step 6-5 or step 6-6. When the parameters for measuring the network performance are other parameters, the threshold value of this step is for the other parameters (For different types of parameters, the network performance can be determined based on the parameters that measures the network performance is greater than the threshold value or less than the threshold value). Or, the network performance can also be determined based on a change in network performance, such as the change above exceeding a certain threshold value, a change in network load above exceeding a certain threshold value, etc.

Step 6-3: Detection of UE performance. The base station obtains the performance that the UE can achieve after transmitting the first model to the UE (that is, the UE uses the first model), for example, throughput (T_{eff}ⁱ), or the base station obtains the current performance that the UE can achieve. The examples of measuring UE performance may also have other types of parameters, for example, latency, packet loss rate, energy efficiency, etc., which are not limited here.

Step 6-4: Determination of UE performance. Taking the throughput as an example, the base station compares whether the UE performance exceeds a threshold value (for example, the third threshold value above), that is, whether T_{eff}ⁱ>Tₜₕⁱ is satisfied. Tₜₕⁱ is a threshold value related to UEi performance. In an optional implementation, the threshold value is related to the UE performance that can be achieved when the UE does not use the first model, for example, 90% of the throughput that the UE can achieve when the UE does not use the first model. If T_{eff}ⁱ>Tₜₕⁱ, there is no need to update the model of the UE, otherwise, step 6-5 is performed or the step 6-7 is directly performed (as shown by the dotted-line of FIG. 6). When the parameters for measuring UE performance are other parameters, the threshold value in this step is for the other parameters (For different types of parameters, the UE performance can be determined based on the parameters that measures the network performance is greater than the threshold value or less than the threshold value).

Optionally, the UE performance is determined on the premise that the QoS re-quirements of the UE are satisfied, and conversely, if the QoS requirements of the UE are not satisfied, the UE does not use the first model (i.e., the UE receives and monitors for signals in a traditional way). Further, when the QoS performance of the UE is satisfied, the base station determines whether there is a decreasing trend in the performance of the UE or whether the decrease in the performance of the UE exceeds a certain threshold, and if there is a decreasing trend or the decrease exceeds a certain threshold, it indicates that the performance of the user is not acceptable, and thus the base station proceeds to step 6-5 or step 6-7, otherwise the model is not updated.

Step 6-5: Determination of the update times of the first model of the UE. For example, if the number of updates performed for the UE exceeds the threshold value N tₕ (for example, the fourth threshold value), step 6-6 is performed; otherwise, step 6-7 is performed.

Step 6-6: If the number of updates of the first model exceeds the threshold value Nth and the performance is still poor, the base station notifies the UE to monitor signals in a traditional manner, that is, the UE determines whether to monitor signals without using the first model.

Step 6-7: The base station updates the first model of the UE (for example, the methods in the steps 5-4 to 5-6 are used).

It should be noted that the step No. in the steps 6-1 to 6-4 does not constitute any limitation to the sequence of the steps. In practical applications, steps 6-1 and 6-2 can be performed first, and then steps 6-3 and 6-4 are performed; or steps 6-3 and 6-4 can be performed first, and then steps 6-1 and 6-2 are performed; or the steps are performed in no particular order, etc., wherein each step is optional, that is, each step is not required to be performed, for example, after step 6-4, if the user performance cannot be accepted, the model is updated.

In the embodiment of the present application, after generating or receiving the first model, the UE needs to trigger the first model to perform prediction. The following provides possible implementations for model triggering.

As a possible implementation, once the UE generates or receives the first model, it starts to use the first model for prediction.

As another possible implementation, the UE uses the first model for prediction after a specified time (which may be configured by the base station, or determined by the UE itself, or a default or fixed time length) upon receiving the first model, or uses the first model for prediction within a specified time (which may be configured by the base station, or determined by the UE itself, or a default or fixed time length) upon receiving the first model.

As another possible implementation, in order to achieve obvious energy saving effect, after obtaining the new first model (or no first model is obtained), the UE side evaluates the energy saving effect that can be achieved by the UE, and activates the first model for prediction or request the first model from the network entity when determining that obvious energy saving effect can be achieved by the first model. Specifically, step S201 may specifically include: in at least one of the following situations, determining to activate the first model or request the first model from the network entity:
1. the occurrence ratio of a related signal is less than a fifth threshold value; wherein, the related signal may refer to the first signal, or may refer to the signal carried by the first signal, for example scheduling information;
2. the potential energy saving by using the first model is greater than a sixth threshold value; and
3. the accuracy of the first model is greater than a seventh threshold value.

The above fifth threshold value, sixth threshold value and seventh threshold value may be configured by the base station, may be pre-configured or may be decided by the UE.

Determining not to initiate or suspend the first model or not to request the first model from the network entity, in at least one of the following cases:
1. an occurrence ratio of a related signal is greater than a seventeenth threshold value wherein the related signal may refer to the first signal or to a signal carried by the first signal, such as scheduling information.
2. the potential energy savings using the first model is less than an eighteenth threshold value.
3. the accuracy of the first model is less than a nineteenth threshold value.

The above seventeenth threshold value, eighteenth threshold value and nineteenth threshold value can be configured by the base station, or pre-configured, or decided by the UE.

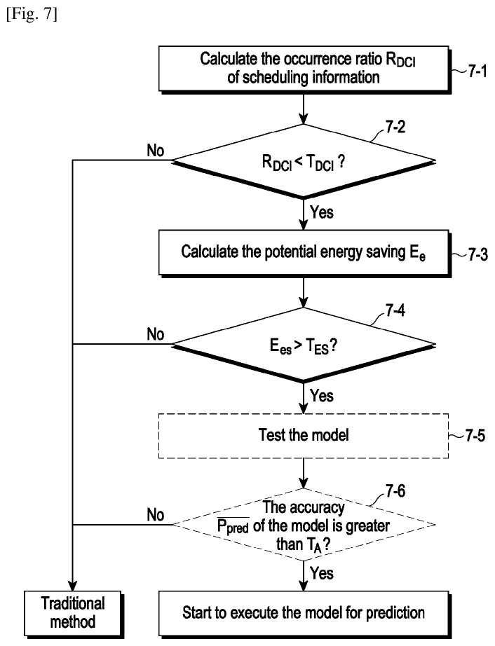

As an example, taking the scheduling of the UE by the base station as an example, the UE may perform evaluation according to the steps shown in FIG. 7.

At step 7-1, the occurrence ratio R_DCI of the scheduling information (for example DCI) for the UE is calculated:

$${R}_{DCI} = \frac{{N}_{DCI}}{{N}_{PDCCH}}$$

where, N_{DCI} represents the number of time units (for example slots) in which scheduling information (for example, scheduling information of new data transmission, such as DCI) occurs in a time window, and N_{PDCCH} is the number of time units in which the UE monitors signals (for example PDCCHs) in a time window. The time window may be a fixed value, for example 100 milliseconds, or a preconfigured value.

At step 7-2, R_{DCI} and T_{DCI} are compared. T_{DCI} indicates a threshold value of the oc-currence ratio of scheduling information (for example, the fifth threshold value). If R_{DCI}>T_{DCI}, it means that, even if the model can completely accurately predict the time unit in which scheduling information may be received, the monitoring of scheduling information cannot be greatly reduced, that is, obvious energy saving effect cannot be achieved. Therefore, there is no need to use the model for prediction or there is no need to request the first model from the base station. Conversely, if R_{DCI}<T_{DCI}, the model may be activated or requested. It should be noted that the above threshold value T_{DCI} comparing with R_{DCI} can be different values, such as R_{DCI}>T_{DCI1}, R_{DCI}<T_{DCI2}, or can be the same values. Optionally, one calculation of the above T_{DCI} is as follows:

$${T}_{DCI} = 0.9 - \frac{{P}_{model}}{{P}_{DCI}}$$

where, P_{model} represents the energy consumed by the UE to perform one prediction by using the model, and P_{DCI} represents the energy consumed by the UE to perform one detection of scheduling information. These two parameters may be fixed values, may be transmitted by the UE to the base station, or may be transmitted by the base station to the UE.

At step 7-3, the potential energy saving Eₑₛ that can be achieved by using the model (for the prediction of scheduling information) is calculated. Optionally, the potential energy saving may be calculated by the following formula:

$${E}_{es} = 1 - \frac{{P}_{model}}{{P}_{DCI}} - {R}_{DCI} * ( 1 + δ )$$

where, δ is the assumed ratio of the average over-detected scheduling information, for example δ=10%. When calculating the potential energy saving, it is assumed that the ratio of the difference between the number of times the model which is used to monitor the scheduling information and the number of times the scheduling information is actually found exceeds δ. The parameter may be a fixed value or a value configured by the base station.

At step 7-4, Eₑₛ and T_{ES} are compared. T_{ES} indicates a threshold value of energy saving (for example, the sixth threshold value). If Eₑₛ<T_{ES}, it means that the first model cannot achieve sufficient energy saving gain, so it is unnecessary to use the first model for prediction or unnecessary to request the first model from the base station; conversely, if Eₑₛ>T_{ES}, then the UE may use the first model for prediction or to request the first model from the base station. T_{ES} may be a fixed value or a value configured by the base station. It should be noted that the threshold value T_{ES} Comparing with the Eₑₛ may be different values, such as Eₑₛ<T_{ES1}, Eₑₛ>T_{ES2}, or may be the same values.

Step 7-5: Model testing. This step is optional. The UE may test the first model for a period of time. During this period, the UE monitors the scheduling information in a conventional manner, and at the same time, the UE uses the first model for prediction, and records the number of time units in which the occurrence of the scheduling information is accurately predicted. In this step, the data set used for testing (testing data set) may be a training data set, or a new data set different from the training data set, for example data collected in the past scheduling process.

At step 7-6, if the step 7-5 is performed, the accuracy P̅_̅{̅p̅r̅e̅d̅}̅ of the first model may be calculated:

$$\overline{{P}_{pred}} = \frac{{N}_{pred}}{{N}_{real}}$$

where, N_{pred} represents the number of times the occurrence of the scheduling information is correctly predicted by the first model obtained in the step 7-5, and Nᵣₑₐₗ represents the number of times the scheduling information actually occurs in the step 7-5.

If P̅_̅{̅v̅r̅e̅d̅}̅>T_{A}, it means that the model is accurate enough to be used for prediction or requesting the first model from the base station; conversely, if P̅_̅{̅p̅r̅e̅d̅}̅<T_{A}, then the UE does not use the first model for prediction or does not request the first model from the base station. T_{A} is a threshold value of accuracy required for model testing (for example, the seventh threshold value). T_{A} may be a fixed value or a value configured by the base station. The above threshold value T_{A} comparing with P̅_̅{̅p̅r̅e̅d̅}̅ may be different values, such as P̅_̅{̅p̅r̅e̅d̅}̅<T_{A1}, P̅_̅{̅p̅r̅e̅d̅}̅>T_{A2}, or may be same values.

If the UE is configured with multiple first models corresponding to different services, for each first model, whether to activate the first model may be determined according to the steps 7-1 to 7-6.

It should be noted that the step No. in the steps 7-1 to 7-6 does not constitute any limitation to the sequence of the steps. In practical applications, steps 7-3 and 7-4 can be performed first, or steps 7-5 and 7-6 can be performed first, or the steps can be performed in no particular order, etc., wherein each step is optional, that is, each step is not required to be performed, for example, after performing step 7-2, it is determined whether to perform the “traditional method” or “start executing the model for prediction or requesting the model from the base station” based on the result, and after performing step 7-4, it is determined whether to perform the “traditional method” or “start executing the model for prediction or requesting the model from the base station” based on the result. After performing step 7-4, based on the results, it is determined whether to perform the “traditional method” or to perform “start executing the model for prediction or requesting the model from the base station”, optionally, only step 7-3 needs to be performed before step 7-4 (steps 7-1 and 7-2 need not be performed); step 7-5 needs not be performed before 7-1 and/or 7-2 and/or 7-3 and/or 7-4.

For the embodiment of the present application, before using the first model for prediction, the UE evaluates the performance of the first model. This can determine whether the first model may be used to start receive scheduling information, so as to ensure that sufficient energy saving can be achieved by the use of the first model.

In the embodiment of the present application, a viable implementation for the execution aspect of the model is provided, for example, after the UE determines that the first model may be used to start prediction, the flow can go to the execution of the model. Specifically, step S201 may specifically include: obtaining a first output result by inputting a first input parameter related to a to-be-monitored time unit into a first model, if it is determined that there is no related signal that must be received; in other words, monitoring the first signal within the to-be-monitored time unit, if it is de-termined that there are related signals that must be received.

Wherein, the related signal may refer to the first signal, or may refer to a signal carried by the first signal, for example scheduling information. As an example, the scheduling information required to schedule the reselected data may be, but not limited to, the scheduling information that must be received.

Further, if it is determined, based on the first output result, not to monitor the first signal transmitted by the network entity within the to-be-monitored time unit, it may further include following steps: in at least one of the following situations, also monitoring the first signal within the to-be-monitored time unit:
1. the predetermined QoS is not satisfied; and
2. the number of times that the related signal is not received continuously is greater than an eighth threshold value.

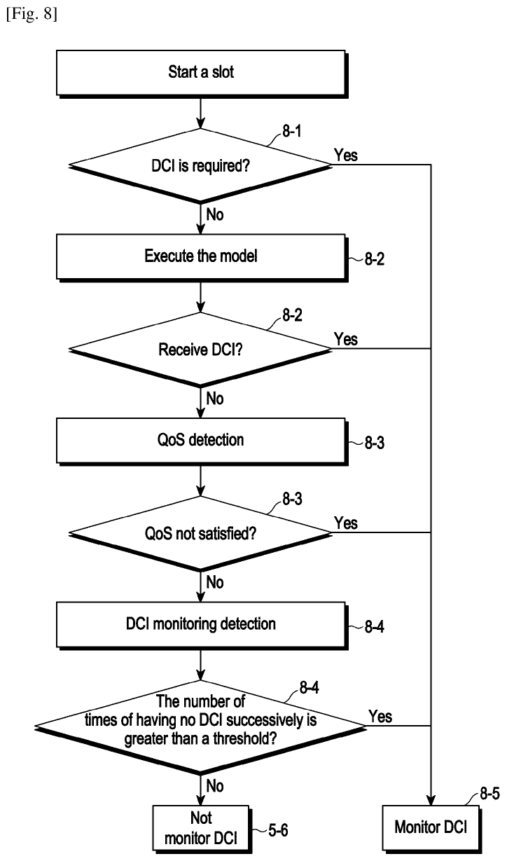

Exemplarily, taking the scheduling of the UE by the base station as an example, the UE can perform the prediction of the model according to the steps shown in FIG. 8.

At step 8-1, it is determined whether there is scheduling information that must be received. If not, step 8-2 is performed, otherwise, step 8-5 is performed.

At step 8-2, the UE executes the first model and obtains the first output result. If the first output result indicates that scheduling information needs to be received, step 8-5 is performed, otherwise, step 8-3 is performed.

At step 8-3, the UE detects whether its QoS requirements are not satisfied. The QoS requirements may be throughput, rate, packet delay, packet loss rate, jitter of packet arrival, and the like. If the QoS requirements cannot be satisfied, step 8-5 is performed, otherwise, step 8-4 is performed.

At step 8-4, the reception of scheduling information for the UE is detected. If the number of times that the scheduling information is not received continuously by the UE exceeds a threshold value (for example, the eighth threshold value), step 8-5 is performed; otherwise, the UE does not monitor the scheduling information. The threshold value is a threshold value of the number of times that the UE does not receive scheduling information continuously. If the UE fails to obtain the scheduling information for the consecutive times exceeding the threshold value, the UE needs to monitor the scheduling information. The threshold value may be a fixed value or a value configured by the base station.

At step 8-5, the UE monitors the scheduling information.

In the embodiment of the present application, when the UE is configured with multiple first models corresponding to different services, for each first model, the UE may execute the first model according to the steps 8-1 to 8-5. If the result of executing, by the UE, one of first models according to the steps 8-1 to 8-5 indicates to monitor the scheduling information, the UE monitors the scheduling information. If the result of executing, by the UE, all first models according to the steps 8-1 to 8-5 indicates not to monitor the scheduling information, the UE needs not to monitor the scheduling information.

It should be noted that the step No. in the steps 8-3 to 8-4 does not constitute any limitation to the sequence of the steps. In practical applications, step 8-4 can be performed first and then step 8-3 can be performed, or the steps can be performed in no particular order, etc., wherein each step is optional, that is, each step is not required to be performed, for example, the UE directly executes step 8-2 and monitors the scheduling information if the output result of the first model is that the scheduling information needs to be monitored, or does no monitor the scheduling information if it is not needed. If the indication result of step 8-1 or 8-2 or 8-3 or 8-4 above is “No”, the UE does not monitor the scheduling information, and vice versa (if the indication result is “Yes”), the UE monitors the scheduling information.

The method performed by the UE in the embodiments of the present application can enable the UE to effectively determine whether to monitor signals. This avoids the situation that a UE needs to monitor signals within all configured time units in the tra-ditional technologies, and thus saves energy consumed by the UE to receive signals.

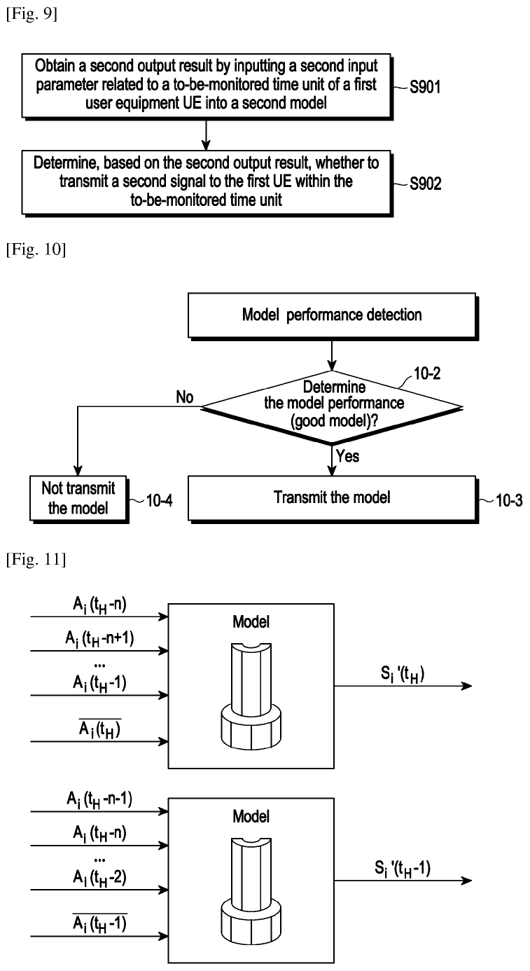

An embodiment of the present application provides a method performed by a network entity in a communication system, as shown in FIG. 9, including following steps.

At step S901, a second output result is obtained by inputting a second input parameter related to a to-be-monitored time unit of a first UE into a second model.

In the embodiment of the present application, the network entity performing the second model may be a base station or a distribution unit of a base station, but is not limited thereto.

For the introduction of the time unit and the to-be-monitored time unit, reference may be made to the above description, and details will not be repeated here.

In the embodiment of the present application, there may be one or more first UEs. If there are multiple first UEs, the second input parameters related to the to-be-monitored time units of the multiple first UEs are respectively input into the second model to obtain second output results respectively corresponding to the multiple first UEs.

In the embodiment of the present application, of the second output result can be used to indicate whether to transmit a second signal to the UE or to indicate whether to select the UE for scheduling.

In the embodiment of the present application, the second input parameter related to the to-be-monitored time unit of the first UE may be the same as or different from the first input parameter when the first UE runs the first model.

Specifically, the second input parameter may also be obtained based on at least one of the following parameters: channel state information; QoS information; indication information of actual performance; indication information of predicted performance; in-dication information of network state; indication information of the scheduling result; indication information of number of times of scheduling, scheduling probability in-dication information, non-scheduling indication information, QoS indication information, indication information of predicted QoS.

In the embodiment of the present application, a feasible implementation for the second input parameter related to the first UE of the to-be-monitored time unit is provided (hereinafter referred to as an input parameter implementation III for ease of description) and may include at least one of the following:
1. Accumulation rate related information, in an embodiment, the information may include an actual accumulation rate respectively corresponding to at least one time unit included in the first time window before the to-be-monitored time unit;
wherein, the actual accumulation rate in one time unit is determined in at least one of the following ways:
(1) An actual average rate within a second time window is determined, the second time window including a time unit and at least one time unit before the time unit, and the actual average rate is used as the actual accumulation rate in a time unit; and
(2) Based on an actual instantaneous rate respectively corresponding to at least one time unit included in a first time window, the smoothened actual accumulation rate re-spectively corresponding to at least one time unit included in the first time window is determined, and the smoothened actual accumulation rate corresponding to a time unit is used as the actual accumulation rate of a time unit.
2. The predicted accumulation rate within the to-be-monitored time unit.

Wherein, the predicted accumulation rate is determined based on the predicted maximum rate in the to-be-monitored time unit and/or the actual accumulation rate in the time unit before the to-be-monitored time unit.

For the embodiment of the present application, for other non-detailed content of the second input parameter, reference may be made to the introduction to “input parameter implementation I” in the first input parameter, and details will not be repeated here.

The embodiment of the present application provides another feasible implementation for the second input parameter related to the first UE of the to-be-monitored time unit (hereinafter referred to as an input parameter implementation IV for ease of de-scription), specifically, which may include at least one of the following:
1. QoS indication related information, which in one implementation, the information may comprise indication information of the QoS corresponding to at least one time unit included in the first time window before the to-be-monitored time unit, re-spectively.
2. Scheduling probability indication related information, which in one implementation the information may comprise scheduling probability indication information corresponding to at least one time unit included in the first time window before the to-be-monitored time unit, respectively.
3. Non-scheduling indication related information, which in one embodiment the information may include non-scheduling indication information corresponding to the at least one time unit included within the first time window before the to-be-monitored time unit, respectively.
4. Indication information of predicted QoS of the to-be-monitored time unit.
5. Indication information of the service type

For the embodiment of the present application, other non-exhaustive contents of the second input parameter can be found in the description of the “Input parameter implementation II” or “Input parameter implementation V” in the first input parameter above, and will not be repeated here.

At step S902, it is determined, based on the second output result, whether to transmit a second signal to the first UE within the to-be-monitored time unit or select the first UE for scheduling, so as to further decide whether to transmit the second signal to the first UE (if the first UE is scheduled, then the second signal is transmitted).

In the embodiment of the present application, the second signal may be the same signal as the first signal, or the second signal may be a signal that is different from the first signal but related, for example, the second signal may refer to a signal carried by the first signal (i.e., the target signal), but not limited thereto.

In the embodiment of the present application, whether to transmit the second signal to the first UE within the to-be-monitored time unit may be determined directly according to the indication of the second output result. In other embodiments, the second output result may be post-processed (for example, the scheduling) first, and then whether to transmit the second signal to the first UE within the to-be-monitored time unit is determined according to the post-processing result.

In the embodiment of the present application, the second model may be not distinguishing to services, or may be distinguishing to services.

Specifically, if the second model is not distinguishing to services, before the start of the time unit t, the network entity runs a second model, inputs the second input parameter into the second model, and determines whether to transmit a second signal to the first UE in the time unit t according to the second output result of the second model (or whether to select the first UE for scheduling, so as to further decide to whether to transmit the second signal to the first UE (if the first UE is scheduled, then the second signal is transmitted)).

If the second model is distinguishing to services, the network entity will have multiple second models respectively corresponding to different services. Then, step S901 may specifically include: obtaining a second output result respectively corresponding to at least one service, by respectively inputting the second input parameter related to the at least one service into the second model respectively corresponding to the at least one service; and step S902 may specifically include: determining, based on the second output result respectively corresponding to the at least one service, whether to transmit a second signal to the first UE within the to-be-monitored time unit (or whether to select the first UE for scheduling, so as to further decide to whether to transmit the second signal to the first UE (if the first UE is scheduled, then the second signal is transmitted)).

Taking the first UE having two services as an example, before the start of the time unit t, the network entity runs corresponding second models for the two services of the first UE, respectively. The network entity inputs the first input parameter of the service 1 and the first input parameter of the service 2 into corresponding second models, re-spectively, to obtain second output results corresponding to the two services. Based on the two second output results, the network entity determines whether to transmit a second signal to the first UE in the time unit t (or whether to select the first UE for scheduling, so as to further decide to whether to transmit the second signal to the first UE (if the first UE is scheduled, then the second signal is transmitted)).

Further, the step of determining whether to transmit a second signal to the first UE or whether to select the first UE for scheduling within the to-be-monitored time unit based on the second output results corresponding to the at least one service may specifically include:
if the second output results respectively corresponding to the at least one service all indicate not to transmit a second signal to the first UE within the to-be-monitored time unit, then not transmit a second signal to the first UE within the to-be-monitored time unit; otherwise, transmits a second signal to the first UE within the to-be-monitored time unit;

Or, if the second output results respectively corresponding to the at least one service all indicate not to select the first UE for scheduling within the to-be-monitored time unit, then not select the first UE for scheduling within the to-be-monitored time unit; otherwise, select the first UE for scheduling within the to-be-monitored time unit, so as to further decide whether to transmit the second signal to the first UE (if the first UE is scheduled, then the second signal is transmitted)).

Continuing from the above example, the second output results respectively corresponding to the two second models are processed by a post-processing module. The post-processing module works in the following way: if one of all second output results indicates that the network entity needs to transmit a second signal to the first UE, the output result from the post-processing module is to transmit a second signal to the first UE; and if all second output results indicate that the network entity does not need to transmit a second signal to the first UE, the output result from the post-processing module is not to transmit a second signal to the first UE (or whether to select the first UE for scheduling, so as to further decide to whether to transmit the second signal to the first UE (if the first UE is scheduled, then the second signal is transmitted)).

Further, in order to generate the second model, the data set (training data set) used for training the second model may be not distinguishing to services, may be distinguishing to services, may be distinguishing to UEs, or may be distinguishing to both services and UEs. For the specific training method of the second model, reference may be made to the above description to the training of the first model by the network entity, and details will not be repeated here.

Optionally, the second model may be distinguishing to UEs, and the network entity will have multiple second models respectively corresponding to different UEs. Then, the step S901 may specifically include: obtaining a second output result respectively corresponding to the at least one first UE, by respectively inputting the second input parameter related to the at least one first UE into the second model respectively corresponding to the at least one first UE; and determining, based on the second output result respectively corresponding to the at least one first UE, whether to transmit a signal to the at least one first UE within the current time unit (or whether to select the at least one first UE for scheduling, so as to further decide to whether to transmit the second signal to the at least one first UE (if the at least one first UE is scheduled, then the second signal is transmitted)).

Similarly, data for model training may be generated in each time unit, which may also be used to update the second model. For the method of model updating, reference may be made to the introduction to the first model, and details will not be repeated here.

It may be known from the above introduction that the UE may generate and/or update the first model, or the network entity may generate and/or update the first model and/or second model. Specifically, the network entity may generate the second model by training based on the collected second data set; and/or, generate the first model by training based on the collected third data set, and transmit the first model to the second UE.

Wherein, the second UE and the first UE may be the same UE, may be partially the same UEs, or may be completely different UEs.

Wherein, if the first model is trained by a UE, the first model and the second model may be the same, for example, both are obtained by training based on the data of the UE, that is, the third data set may be the same as the first data set; or, the first model and the second model may be different, for example, the data sets collected by the first UE and the network entity for training are different, that is, the third data set may be different from the first data set, or different initial models are used, etc., but not limited thereto.

If both the first model and the second model are trained by the network entity, the first model and the second model may be different, and the data sets used for training may be different, that is, the second data set and the third data set may be different, or different initial models are used, etc., but not limited thereto; or, the first model and the second model may be the same, for example, the same data set is used to train the first model and the second model, that is, the second data set and the third data set may be the same, or after the base station trains a model, the network entity transmits the model to the UE as the first model and uses it as the second model, but not limited thereto.

Wherein the network entity for training the first model, the network entity for training the second model, and the network entity for transmitting the first model may all be a base station, a centralized unit of the base station, a control plane portion of the centralized unit of the base station, a distribution unit of the base station, a wireless access network intelligent controller near real-time layer, an NWDAF entity, an OAM entity, an artificial intelligence entity, etc.

Optionally, the network entity for training the first model, the network entity for training the second model, the network entity for transmitting the first signal, and the network entity for transmitting the first model may be the same network entity or different network entities, for example, the third network entity trains the first model and the second model, and transmits them to the fourth network entity and the fifth network entity, and the fourth network entity transmits the first model to the UE. The fifth network entity determines whether to transmit a second signal to the UE or whether to select the UE for scheduling based on the second model, but is not limited to this.

In the embodiment of the present application, if the first model is generated by training by the base station or obtained from other entity by the base station, after obtaining the first model, the base station side needs to deploy the first model to the UE side (i.e., transmits to the second UE). Similarly, if the base station side updates the first model in real time, the base station needs to deploy the updated model to the UE side. That is, when the base station wants to transmit the first model to the UE, the base station needs to transmit the current latest model to the UE.

For the embodiment of the present application, it may be that the base station transmits the generated first model to the UE, or it may be that the base station transmits the first model generated by that other entity obtained from that other entity to the UE, or it may be that any network entity transmits its generated first model to the UE, and for ease of description, the following is described as an example of the base station transmitting the first model to the UE (i.e., the base station in the embodiment of the present application may be replaced with another network entity).

In the embodiment of the present application, the deployment of the model mainly includes the following stages:
Stage 1: Initial deployment of the UE-side model

At this stage, the base station needs to transmit the first model to some UEs that have not obtained the model, so that the UE or these UEs can determine whether there is a target signal within the to-be-monitored time unit according to the first model. Op-tionally, before transmitting the first model, the base station may detect the performance of the model and/or determine the current QoS of the UE, and if it is de-termined that the model performance of the first model is better than the preset performance standard and/or the current QoS of the UE is satisfied, the base station can transmits the latest first model to the second UE.

In the embodiment of the present application, FIG. 10 shows an example of a flow of performance detection of the first model for a UE by the base station. Specifically, the flow may include following steps.

Step 10-1: Detection of model performance. The following is an example of detecting whether the model can correctly predict the scheduling information for the UE. Specifically, it may include steps:

The performance of the model in predicting the scheduling information is obtained according to the historical data of a UE. For example, as shown in FIG. 11, it is assumed that the current latest first model is M(t) (or Mⱼ(t), j=1, . . . , J), the base station will sequentially input data in the historical time unit t_H and before the time unit into the first model to obtain the prediction results of the model, for example, input Aᵢ (t_{H}−1), Aᵢ(t_{H}−2), . . . , Aᵢ(t_{H}−n), A̅ᵢ̅(̅t̅_̅{̅H̅}̅)̅ into the model to obtain the result Sᵢ′(t_{H}−1) of the model Sᵢ′. For another example, [Qᵢ(t_{H}−1), pᵢ(t_{H}−1), δᵢ(t_{H}−1)], [Qᵢ(t_{H}−2), pᵢ(t_{H}−2), δᵢ(t_{H}−2)], . . . , [Qᵢ(t_{H}−n), pᵢ(t_{H}−n), δᵢ(t_{H}−n)] and Q̅ᵢ̅(̅t̅_̅{̅H̅}̅)̅ are input to the model to obtain the result of the model Sᵢ′(t_{H}), and [Qᵢ(t_{H}−2), pᵢ(t_{H}−2), δᵢ(t_{H}−2)], [Qᵢ(t_{H}−3), pᵢ(t_{H}−3), δᵢ(t_{H}−3)], . . . , [Qᵢ(t_{H}−n−1), pᵢ(t_{H}−n−1), δᵢ(t_{H}−n−1)] and Q̅ᵢ̅(̅t̅_̅{̅H̅}̅−̅1̅)̅ are input to the model to obtain the result of the model Sᵢ′(t_{H}−1). For another example, [Qᵢ(t_{H}−1), pᵢ(t_{H}−1)], [Qᵢ (t_{H}−2), pᵢ (t_{H}−2)], . . . , [Qᵢ(t_{H}−n), pᵢ(t_{H}−n)], δᵢ(t_{H}−1) (or δᵢ(t_{H})) and Q̅ᵢ̅(̅t̅_̅{̅H̅}̅)̅ are input to the model to obtain the result of the model Sᵢ′(t_{H}), and [Qᵢ(t_{H}−2), pᵢ(t_{H}−2)], [Qᵢ(t_{H}−3), pᵢ (t_{H}−3)], . . . , [Qᵢ(t_{H}−n−1), pᵢ(t_{H}−n−1)], δᵢ(t_{H}−2) (or δᵢ(t_{H}−1)) and Q̅ᵢ̅(̅t̅_̅{̅H̅}̅−̅1̅)̅ are input to the model to obtain the result of the model Sᵢ′(t_{H}−1). The data input to the model may further include the indication information of the service type.
(2) The accuracy (P_{pred}) of the model in predicting the occurrence of scheduling information and the performance (for example, rate T_{pred}) that the model can achieve are calculated according to the following formulas:

$${P}_{pred} = \frac{{\sum }_{m = 0}^{TW} S ( t - m ) * {s}^{′} ( t - m )}{{\sum }_{m = 0}^{TW} S ( t - m )} \\ {T}_{pred} = {\sum }_{m = 0}^{TW} S ( t - m ) * {S}^{′} ( t - m ) * v ( t - m )$$

where, TW represents the size of the time window to which the data used for performance confirmation belongs, for example 1000 time units, that is, data in 1000 time units before time unit t will be used to confirm the performance of the model; it is assumed that the output result of the model is represented by “1” or “0”, then S(t−m)*S′(t−m)=1 represents a correct prediction; Σₘ₌₀^{TW} S(t−m)*S′(t−m) represents the total number of times that the occurrence of scheduling information is correctly predicted in the TW time units; Σₘ₌₀^{TW} S(t−m) represents the number of times that the scheduling information actually occurs in the TW time units; and v(t-m) represents the rate actually obtained by the UE in the time unit t−m.

Step 10-2: Determination of model performance. For example, if P_{pred}>Pₜₕ and T_{pred}>T tₕ Obtained in step 10-1, the model is a model with good performance that may be delivered to the UE; otherwise, the model is not delivered to the UE.

Step 10-3: The transmission of the model. If the step 10-2 determines that the new model is a model with good performance, the base station may transmit the model to the UE; otherwise, it will not transmit.

When the model obtained by training is distinguishing to services, the steps 10-1 to 10-3 may be used to detect the performance of each first model. That is, for each first model, all the steps 10-1 to 10-3 need to be executed, wherein the parameters input into the first model in the step 10-1 are parameters related to service j of UEi.

In one embodiment, the data set (testing data set) used for testing the model at this stage may be a training data set, or may be a new data set different from the training data set, for example data collected in the past scheduling process.
Stage 2: Update of the UE-side model

At this stage, the network entity needs to determine the way to update the model of the UE. Optionally, the network entity may use at least one of the following two ways to update the model of the UE:
1. Synchronous update. That is, the network entity transmits the updated first model to the second UE in a synchronous manner.
2. Asynchronous update. That is, the network entity transmits the updated first model to the second UE in an asynchronous manner.
3. Direct update. That is, the network entity transmits the updated first model to the second UE according to its own decision.

In the embodiment of the present application, the network entity transmits the first model to the second UE in a synchronous manner, including at least one of the following situations:
1. periodically transmitting the updated first model to the second UE in a synchronous manner; and
2. If the number of second UEs for which the first model needs to be updated is greater than the ninth threshold value, transmitting the updated first model to the second UE in a synchronous manner.

In the embodiment of the present application, transmitting the first model to the second UE in an asynchronous manner includes:

If the number of second UEs for which the first model needs to be updated is not greater than the ninth threshold value, transmitting the updated first model to the second UEs for which the first model needs to be updated in an asynchronous manner.

In the embodiment of the present application, the second UE for which the first model needs to be updated may be determined by at least one of the following information:
1. a detection result of the network performance of the second UE in using the first model and a tenth threshold value;
2. a detection result of the UE performance of the second UE in using the first model and an eleventh threshold value; and
3. the number of update times of the first model of the second UE and a twelfth threshold value.

The methods of the embodiment of the present application correspond to the methods of the embodiment of the UE side. For other non-detailed content, reference may be made to the description of the model deployment methods in the embodiments of the UE side, and details will not be repeated here.

It should be noted that the first threshold value and the ninth threshold value may be the same or different; the second threshold value and the tenth threshold value may be the same or different; the third threshold value and the eleventh threshold value may be the same or different; and the fourth threshold value and the twelfth threshold value may be the same or different.

In the embodiment of the present application, after obtaining the second model, the network entity needs to trigger the second model to perform prediction.

As a possible implementation, once the network entity obtains the second model, it starts to use the second model for prediction.

As another possible implementation, in order to achieve obvious energy saving effect, after obtaining the new second model, the network entity evaluates the energy saving effect that can be achieved by the second model, and activates the second model for prediction when determining that obvious energy saving effect can be achieved by the second model. Specifically, step S901 may specifically include: in at least one of the following situations, determining to activate the second model:
1. the occurrence ratio of the second signal is less than the thirteenth threshold value;
2. the potential energy saving by using the second model is greater than a fourteenth threshold value; and
3. the accuracy of the second model is greater than a fifteenth threshold value.

The network entity determines not to activate or hang up the second model in at least one of the following cases:
an occurrence ratio of a second signal is less than a twentieth threshold value;
a potential energy saving by using the second model is greater than a twenty-first threshold value;
an accuracy of the second model is greater than a twenty-second threshold value.

Exemplarily, taking the scheduling of the UE by the base station as an example, the base station may perform the evaluation of the second model according to the steps shown in FIG. 7, wherein the introduction of FIG. 7 has been given and will not be repeated here. For the model testing process in step 7-5, the base station may determine whether to transmit scheduling information to the UE in a conventional manner, and meanwhile, the base station uses the second model to perform prediction, so as to determine the number of time units in which the occurrence of scheduling information is accurately predicted by the second model.

It should be noted that the fifth threshold value and the thirteenth threshold value may be the same or different; the sixth threshold value and the fourteenth threshold value may be the same or different; and the seventh threshold value and the fifteenth threshold value may be the same or different.

In the embodiment of the present application, after the network entity determines that the second model may be used to start prediction, step S901 may specifically include: obtaining a second output result by inputting a second input parameter related to the first UE within a to-be-monitored time unit into a second model, if it is determined that there is no second signal that must be transmitted to the first UE; in other words, if it is determined that there is a second signal that must be transmitted to the first UE, transmitting the second signal to the first UE within the to-be-monitored time unit.

Further, if it is determined, based on the second output result, not to transmit a second signal to the first UE within the to-be-monitored time unit, it may further include: in at least one of the following situations, also transmitting a second signal to the first UE within the to-be-monitored time unit.
1. the predetermined QoS of the first UE is not satisfied; and
2. the number of times that the related signal is not received continuously by the first UE is greater than a sixteenth threshold value.

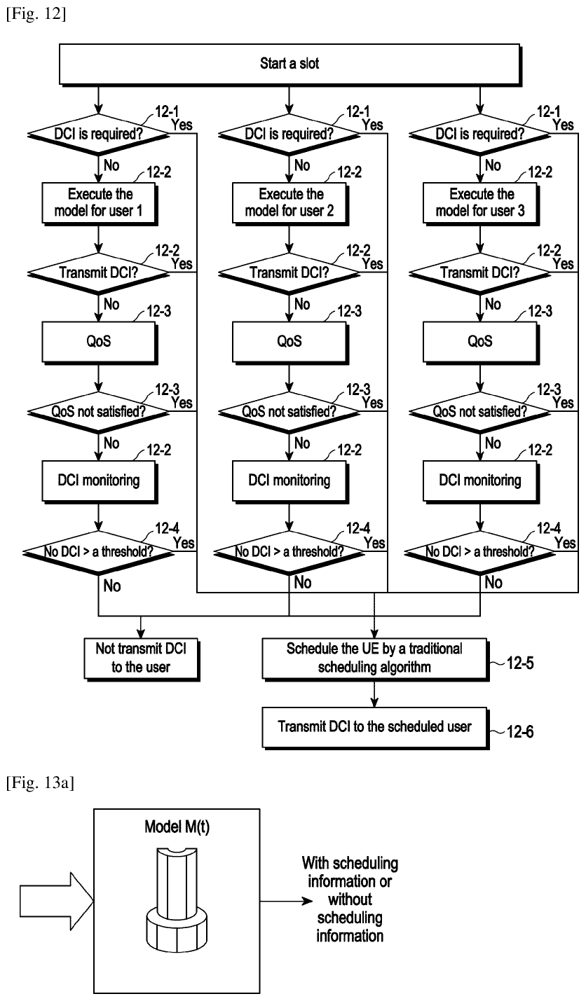

Exemplarily, taking the scheduling of UEs by the base station as an example, the base station may perform model prediction according to the steps shown in FIG. 12 (since the base station may need to simultaneously perform the transmission of scheduling information based on the model for multiple UEs during the execution of the model and the UE side only needs to perform the prediction and reception of its own scheduling information based on the model, the methods for the base station side and the UE side to execute the model may be different, that is, FIG. 12 and FIG. 8 have the identical parts and different parts). In FIG. 12, description will be given by taking, as an example, the case in which the base station executes the model for three UEs to determine whether to transmit scheduling information, wherein, for each UE, the base station side needs to perform the following steps.

At step 12-1, it is determined whether there is scheduling information that must be transmitted. In one example, the scheduling information that must be transmitted may be scheduling information required to schedule reselected data. If not, step 12-2 is performed; otherwise, step 12-5 is performed.

At step 12-2, the base station executes the second model for a UE to obtain a second output result of the model. If the second output result indicates that scheduling information needs to be transmitted to the UE, step 12-5 is performed; otherwise, step 12-3 is performed.

At step 12-3, the base station detects whether the QoS requirements of the UE are satisfied. The QoS requirements may be throughput, rate, packet delay, packet loss rate, jitter of packet arrival, etc. If the QoS can be met, step 12-5 is performed; otherwise, step 12-4 is performed.

At step 12-4, the reception of scheduling information by the UE is detected. If the number of times that the scheduling information is not received continuously by the UE exceeds a threshold value (e.g., the sixteenth threshold value), step 12-5 is performed; otherwise, the base station will not transmit scheduling information (e.g., DCI) to the UE. The threshold value is a threshold value of the number of times that the UE does not receive scheduling information continuously. If the UE fails to obtain the scheduling information for the consecutive times exceeding the threshold value, the base station needs to transmit the scheduling information to the UE. The threshold value may be a fixed value or a value configured by the base station.

At step 12-5, the base station schedules multiple UEs, and the multiple UEs are UEs that need to monitor scheduling information determined by one or more of the steps 12-1 to 12-4.

Further, the multiple UEs may also include UEs for which no model is deployed. Since the resources of the base station are limited and it may be determined by the steps 12-1 to 12-4 that there are too many UEs that need to monitor the scheduling information, the base station needs to determine UEs, from these UEs, to which the scheduling information is to be transmitted. To determine the UEs, the base station may run a traditional scheduling algorithm for these UEs to cause the scheduling algorithm to determine the scheduled UEs, and finally the base station transmits scheduling information to these scheduled UEs. In this example, only some UEs may be scheduled eventually. Wherein this processing may also be understood as a post-processing process for the second output results corresponding to the multiple UEs. In another example, the multiple UEs may include UEs that are determined by the steps 12-1 to 12-4 to need to monitor scheduling information and/or UEs for which no model is deployed. Then, in this example, the base station may allocate resources to each of the “multiple UEs”. That is, if it is determined, based on the second output result, to transmit a second signal to multiple UEs or to select multiple UEs for scheduling within the to-be-monitored time unit, the embodiment of the present application also includes at least one of the following situations: scheduling, by a scheduling algorithm, the multiple UEs and/or UEs for which a first model is not deployed; and allocating, by a scheduling algorithm, resources (e.g., bandwidth) to the multiple UEs and/or UEs for which a first model is not deployed.

At step 12-6, the base station transmits scheduling information (e.g., DCI) to the UEs scheduled in the step 12-5.

In the embodiment of the present application, when the base station configures multiple second models corresponding to different services, for each second model, the base station may execute for all UEs applicable to the model in sequence according to the steps 12-1 to 12-6. For a UE, as long as there is a second model corresponding to a service indicates, after the steps 12-1 to 12-6, that the base station needs to transmit scheduling information to the UE, the base station will transmit scheduling information to the UE. On the contrary, if each model corresponding to different services indicates, after the steps 12-1 to 12-6, that the base station does not need to transmit scheduling information to the UE, the base station will not transmit scheduling information to the UE.

It should be noted that the step No. in the steps 12-3 and 12-4 does not constitute any limitation to the sequence of the steps. In practical applications, step 12-4 can be performed first and then step 12-3 is performed, or the steps can be performed in no particular order, etc. In addition, the eighth threshold value and sixteenth threshold value may be the same or different. Wherein, each step is optional, that is, each step is not required to be performed, for example, if the output of step 12-1 or 12-2 or 12-3 or 12-4 is “No”, then “not transmit DCI to the user” is directly executed, and if the output is “Yes”, then step 12-5 is directly executed.

The embodiment of the present application provides an example, and the output of the model may indicate whether the UE is selected to be scheduled. On the UE side, if the output of the model indicates that the UE is selected to be scheduled, the UE monitors the PDCCHs; otherwise, the UE does not need to monitor the PDCCHs. On the base station side, if the output of the model indicates that the UE is not selected to be scheduled, the base station will not transmit DCI to the UE. On the contrary, that is, the output of the model indicates that the UE will be selected to be scheduled, if there are many UEs selected to be scheduled (for example, the base station does not have enough resources to allocate to these UEs), the base station will reschedule these UEs (this processing may be understood as post-processing). The scheduling algorithm may be an existing scheduling algorithm, or a simple scheduling algorithm (for example, selecting the UEs by priority, until the resources are allocated). If the base station has enough resources to allocate to the each UE, the base station will schedule each UE. In another embodiment, the base station may allocate resources to all UEs selected to be scheduled.

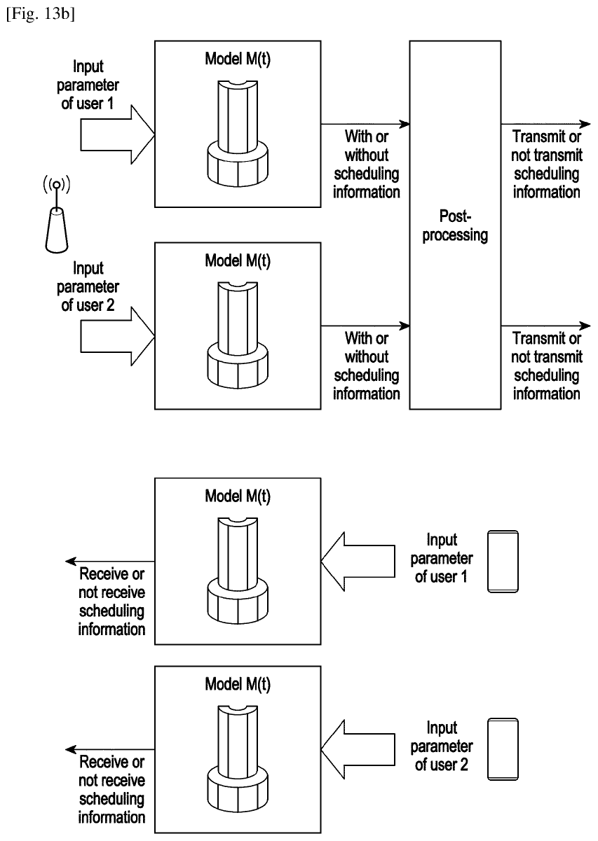

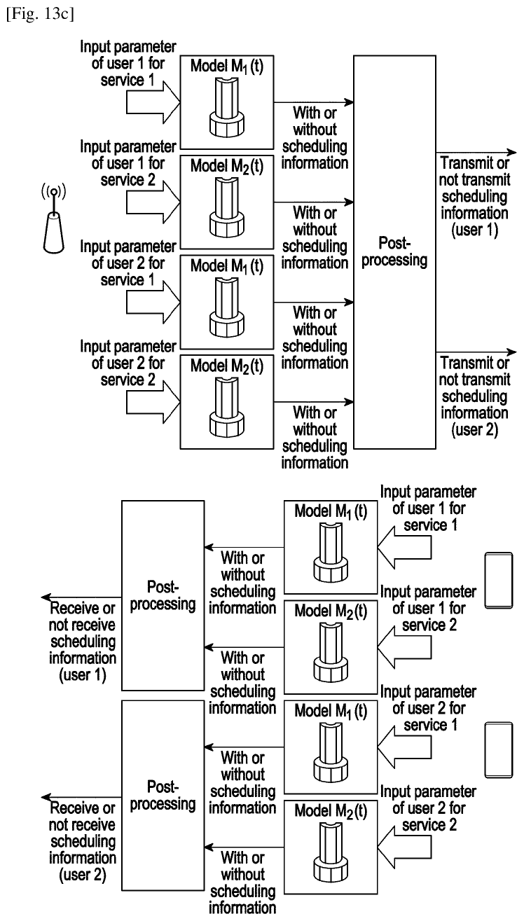

In combination with at least one of the above embodiments, taking the scheduling of the UE by the base station as an example, an embodiment of the present application shows a method for using the model in FIG. 13a. Specifically, for a time unit t, after inputting the input parameters required by the model (which may be the first model or the second model) into the model, the model will generate an output result (model inference) which indicates whether there is scheduling information for the UE at the time unit t (with or without scheduling information) or whether to select the UE for scheduling. Wherein, for the UE, it may be determined that the UE needs to monitor signals if there is scheduling information, and that the UE does not need to monitor signals if there is no scheduling information. For the base station, it may be determined that the base station needs to transmit a signal if there is scheduling information, and it may be determined that the base station does not need to transmit a signal if there is no scheduling information, or it may be determined that the base station schedules the UE if indicating to select the UE for scheduling, or, indicating not to select the UE for scheduling, then the base station may determine that it is not necessary to transmit the signal.

Further, taking the scheduling of two UEs by the base station as an example, FIG. 13b shows a method for using the model in the way 1 shown in FIG. 1a in an embodiment of the present application. In this example, the model is a model that is not distinguishing to services, and the base station and the two UEs use the same model. Specifically, before the start of a time unit t, the base station respectively inputs the input parameters of UEl and UE2 into the model M(t) to obtain two output results (that is, with or without scheduling information). The two output results will be processed by a post-processing module to generate a final result that indicates whether the base station needs to transmit scheduling information to the two UEs. The op-erations performed by this post-processing module may refer to the above introduction (e.g., step 12-5), which will not be repeated here. On the UE side, each UE will run the same model M(t). Each UE inputs its own data into the model, and the UE determines whether to receive scheduling information according to the output result of the model.

Further, continuing to take the scheduling of two UEs by the base station as an example, FIG. 13c shows a method for using the model in the way 1 shown in FIG. 1a in an embodiment of the present application. In this example, the model is a model that is distinguishing to services, and the base station and the two UEs use the same model. For the convenience of description, it is assumed that each UE has two services. Specifically, before the start of a time unit t, the base station respectively inputs the input parameters of UE1 and UE2 about service 1 into the model M(t) related to service 1, to obtain two output results (that is, with or without scheduling information). Similarly, the base station respectively inputs the input parameters of UE1 and UE2 about service 2 into the model M₂(t) related to service 2, to generate two output results. The four output results will be processed by a post-processing module to generate a final result that indicates whether the base station needs to transmit scheduling information to the two UEs (there is a final result for each UE). The operations performed by this post-processing module may refer to the above introduction (e.g., the post-processing in the step 12-5 and/or step S902), which will not be repeated here. On the UE side, each UE will run a model for each service, i.e., M₁(t) and M₂(t). The two models are the same as the models on the base station side. Each UE respectively inputs the input parameters of service 1 and service 2 into the models M₁(t) and M₂(t), to obtain output results of the models. Further, the output results of the two models will be processed by a post-processing module. The post-processing module works in the following way: if one of the output results of all models run on the UE side indicates that the UE needs to receive scheduling information, the output result from the post-processing module is to receive scheduling information; and if the output results of all models run on the UE side indicate that the UE does not need to receive scheduling information, the output result from the post-processing module is not to receive scheduling information.

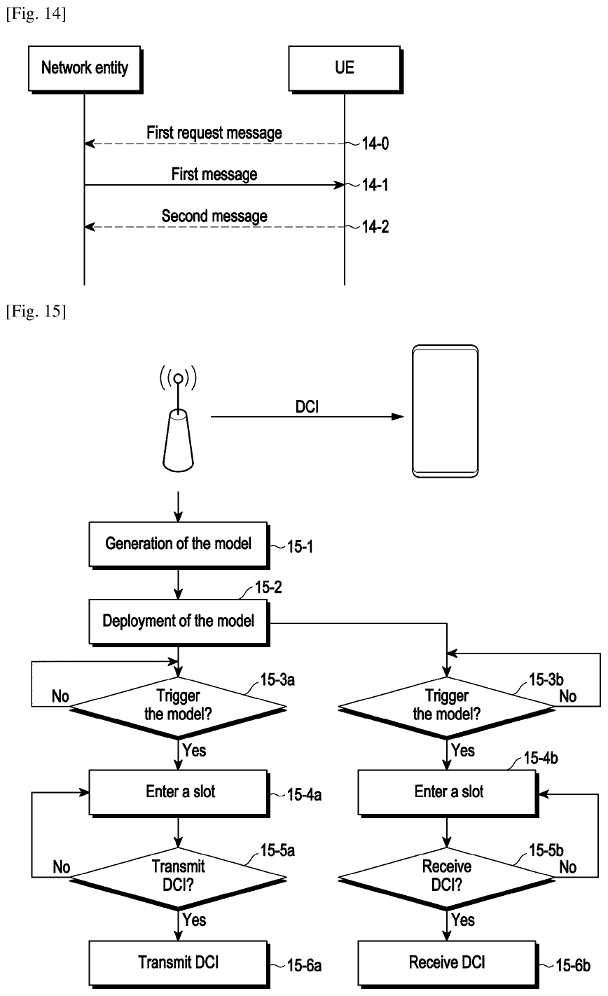

In the embodiment of the present application, for the case where the network entity transmits the generated first model to the UE and for the processes of triggering the execution of the first model and executing the first model, some parameters may need to be exchanged between the network entity and the UE. As an example, FIG. 14 shows an interaction flow between the network entity and the UE.

At step 14-1, the network entity transmits a first message to the UE, where the first message contains information required by the UE to perform prediction by using the model, and the first message may further contain assistant information required by the UE when executing the model. The network entity may include, but are not limited to, a base station, a centralized unit of the base station, a control plane portion of the cen-tralized unit of the base station, a distribution unit of the base station, a wireless access network intelligent controller near real-time layer, an NWDAF entity, an OAM entity, an artificial intelligence entity, etc. The first message may contain one or more models, and for a model, the message may include, but not limited to, at least one of the following information:
1. Information related to the model. The information helps the UE to execute the model. The information may include, but not limited to, at least one of the following information:
(1) The number of the model.
(2) The name of the model.
(3) The container that carries the model. This file contains the parameters of the model, such as the number of layers of the model and the configuration of each neuron in the model. After the UE receives the file, it can construct a model and use the model to perform prediction. Further, the model may also contain the preprocessing module mentioned above.
(4) Model transfer serial number, used to identify this model transfer.
(5) Model type, used to represent the type of the model, including but not limited to perceptrons, feedforward neural networks, radial basis function networks, deep feedforward networks, recurrent neural networks, long/short-term memory networks, gated recurrent units, autoencoders, variational autoencoders, denoising autoencoders, sparse autoencoders, Markov chains, Hoffett networks, Boltzmann machines, restricted Boltzmann machines, deep belief networks, deep convolutional networks, deconvo-lutional neural networks, deep convolutional inverse graph networks, generative ad-versarial networks, liquid machines, extreme learning machines, echo state networks, deep residual networks, Kohonen networks, support vector machines, neural turing machines, convolutional neural networks, artificial neural networks, recurrent neural networks, deep neural networks, etc.
(6) The characteristic parameters of the model, including but not limited to at least one of the following information:
1) the number of layers, used to represent the number of layers of the neural network;
2) the number of neurons in each layer, used to represent the number of neurons in each layer of the neural network; and
3) weights, used to represent the weights of neurons in the neural network.
(7) Model download address, used to represent the model download address, including but not limited to at least one of the following information: address, port, protocol, and URL address of the download server.
(8) Input parameter information of the model, used to represent the input parameters of the model and the order thereof. For example, it is represented by nₑ*mₑ bits, each nₑ bits represent a parameter, there are total me parameters, and the input order is the same as the bit representation order. Based on the mapping relationship between the nₑ bits and the parameters, the input order of parameters may be inferred. When the input parameters are presented as a matrix, the position of each parameter in the matrix may be indicated. The specific input parameters of the model may refer to the parameters 1˜nₚ+kₚ mentioned above; or the parameters 1˜mₚ mentioned above. That is, the input parameters may be directly input into the model, for example, the accumulation rate of the UE (e.g., A(t), t=1,2, . . . ), predicted accumulation rate (e.g., A̅(̅t̅)̅, t=1,2, . . . ), etc.
(9) Original parameter information, used to generate the information about the input parameters of the model, and used to represent the input parameters used for training and the order thereof. For example, it is represented by ng*mg bits, each ng bits represent a parameter, there are total mg parameters, and the input order is the same as the bit representation order. Based on the mapping relationship between the ng bits and the parameters, the input order of parameters may be inferred. When the input parameters are presented as a matrix, the position of each parameter in the matrix may be indicated. The specific input parameters of the model may refer to the parameters 1˜nₚ+kₚ mentioned above; or the parameters 1˜nₚ mentioned above. That is, the original parameter information may be preprocessed (for example, by a preprocessing matrix to be described below) before being input into the model, for example, the instantaneous rate of the UE (e.g., v(t), t=1,2, . . . ), the maximum instantaneous rate that the UE can achieve (e.g., V(t), t=1,2, . . . ).
(10) Preprocessing matrix information, used to preprocess the collected data for inputting the data into the model. In one example, this information may indicate the structure of the matrix and the value of each element in the matrix.
(11) Output parameter information of the model, used to indicate the type and order of the output parameters of the network. For example, it is represented by nu*mu bits, each nu bits represent a parameter, there are total mu parameters, and the output order is the same as the bit representation order. Based on the mapping relationship between the nu bits and the parameters, the output order of the parameters may be inferred. In one example, the output parameters may be 0 and 1, “0” indicates not to monitor scheduling information (the UE is not selected for scheduling), “1” indicates to monitor scheduling information (the UE is selected for scheduling).
(12) Feedback type, used to indicate the type of subsequent feedback received from the network, for example feedback weight, feedback data, and feedback of updated model.

In the embodiment of the present application, two possible implementation examples are provided for the UE to obtain the input parameters of the model according to the “input parameter information of the model” and the possible “original parameter information” and “preprocessing matrix information”.

### Example 1: The Base Station Directly Informs the UE of the Input Parameters of the Model

At the beginning of a time unit t_{c}, the input parameters are A(t_{c}−1), A(t_{c}−n2), . . . , A(t_{c}−n), A(t_{c}). If the model is for different services, these input parameters are for one service. Then, the input parameter information will indicate that: at the beginning of the to-be-monitored time unit t_{c}, the first input parameter is the accumulation rate that the UE can achieve in the time unit t_{c}−n, the second input parameter is the accumulation rate that the UE can achieve in the time unit t_{c}−n+1, . . . , the n-th input parameter is the accumulation rate that the UE can achieve in the time unit t_{c}−1, and the (n+1)-th input parameter is the accumulation rate of the UE predicted at the beginning of the time unit t_{c}.

For another example, at the beginning of the time unit te, the input parameter is [Q(t_{c}−n), p(t_{c}−n), δ(t_{c}−n)], [Q(t_{c}−n+1), p(t_{c}−n+1), δ(t_{c}−n+1)], . . . , [Q(t_{c}−1), p(t_{c}−1), δ(t_{c}−1)] and Q̅(t_{c}); for another example, at the beginning of the time unit t_{c}, the input parameter is [Q(t_{c}−n), p(t_{c}−n)], [Q(t_{c}−n+1), p(t_{c}−n+1)], . . . , [Q(t_{c}−1), p(t_{c}−1)], δ(t_{c}−1) (or δ(t_{c})) and Q̅(t_{c}). Additionally, the input parameter information also indicates the size of n (that is, the time window of the input parameter). Further, the input parameters may also include the indication information of the service type.

### Example 2: The Base Station Informs the UE of the “Input Parameter Information of the Model”, “Original Parameter Information” and “Preprocessing Matrix Information”

For the description of the “input parameter information of the model”, reference may be made to the “Example 1”. As an implementation of the “original parameter information” and “preprocessing matrix information”, the base station informs the UE that the input parameters to generate A(t) are v(t) and A(t−1) and the preprocessing matrix is

$$[ \begin{matrix}α \\ 1 - α\end{matrix} ] ,$$

so A(t) is calculated according to

$$A ( t ) = [ v ( t ) A ( t - 1 ) ] * [ \begin{matrix}α \\ 1 - α\end{matrix} ] ;$$

the base station informs the UE that the input parameters to generate A̅(̅t̅)̅ are V(t) and A(t−1) and the preprocessing matrix is

$$[ \begin{matrix}α \\ 1 - α\end{matrix} ] ,$$

so A̅(̅t̅)̅ calculated according to

$$\overline{A ( t )} = [ V ( t ) A ( t - 1 ) ] * [ \begin{matrix}α \\ 1 - α\end{matrix} ] ;$$

and the base station informs the UE of A(1)=v(1). In this way, the UE may generate the input parameters of the model in sequence. As another implementation of the “original parameter information” and “preprocessing matrix information”, the base station informs the UE that the input parameter matrix is

$$[ \begin{matrix}v ( t ) & A ( t - 1 ) \\ V ( t ) & A ( t - 1 )\end{matrix} ]$$

and the preprocessing matrix is

$$[ \begin{matrix}α \\ 1 - α\end{matrix} ] ,$$

so A(t) and A̅(̅t̅)̅ are calculated according to [A(t)

$$\overline{A ( t )} ] = [ \begin{matrix}v ( t ) & A ( t - 1 ) \\ V ( t ) & A ( t - 1 )\end{matrix} ] * [ \begin{matrix}α \\ 1 - α\end{matrix} ] ;$$

and the base station informs the UE of A(1)=v(1).
2. Indication information of applicable services, used to indicate the services for which the model contained in the “model file” is provided, including but not limited to at least one of the following information:
(1) Indication information of the service type, used to indicate the service type corresponding to the model, for example, but not limited to, video, audio, FTP, URLLC (Ultra-Reliable & Low-Latency Communication) services, etc.
(2) Identifier information of the bearer, used to indicate the bearer corresponding to the model, such as DRB ID, SRB ID, etc.
(3) Identifier information of the QoS flow, used to indicate the QoS flow corresponding to the model.
(4) Identifier information of a PDU session, used to indicate a PDU session corresponding to the model.
(5) Identifier information of the logical channel, used to indicate the logical channel used by the service corresponding to the model.
3. First assistant information, used to help the UE to generate the input parameters of the model, and/or help the UE to execute the model, including but not limited to at least one of the following information:
(1) average factor for calculating the accumulation rate, for example, α, α₁, α₂ mentioned above.
(2) The size of the time window used to calculate the average rate, for example, the second time window m.
(3) The size of the time window for data collection, for example, the first time window n.
(4) The size of the time window used to calculate the occurrence ratio of the scheduling information of the UE, for example, used in the step 7-1.
(5) The energy consumed by the UE to perform a prediction once by using the model, for example, used in the step 7-2.
(6) The energy consumed by the UE to perform one calculation in the model, for example, used when calculating the P_{model} in the above step 7-2.
(7) The energy consumed by the UE to detect the scheduling information once, for example, used in the step 7-2.
(8) The assumed ratio of the average over-detected scheduling information, for example, used in the step 7-3.
(9) The threshold value of energy saving, for example, the sixth threshold value, the eighteenth threshold value, the fourteenth threshold value, etc., which may be used in the step 7-4.
(10) The threshold value of the accuracy required by the model test, for example, the seventh threshold value, the fifteenth threshold value, the nineteenth threshold value, etc., which may be used in the step 7-6.
(11) The threshold value for the successive number of times that the UE has no scheduling information, for example, the eighth threshold value, the sixteenth threshold value, etc., which may be used in the steps 8-4, 12-4, and the like.
(12) A threshold value for the proportion of related signals occurring, for example, the fifth threshold, the seventeenth threshold, as described above, may be used in step 7-2 above.
(13) Input data update time window, which indicates the time window to be waited when updating the input data and will be specifically described in the following de-scription.
4. Indication information of applicable UEs, used to indicate the UEs that can use the model information contained in the first message, for example, used to indicate the identifier information of the corresponding UE.
5. Fallback indication information, used to notify the UE to obtain the scheduling information in a conventional way.
6. indication information of applicable areas, for indicating an area capable of using the model information included in the first message, the indication information comprising at least one of the following information:
(1) area identification information that indicates an area, such as a Tracking Area (TA), a RAN notification area (RNA), etc.
(2) Cell identification information, which may include the identification of one or more cells.
7. Indication information of applicable rates, for indicating the rate of a user capable of using the model included in the first message, such as level of rates (low mobility, medium mobility, high mobility), specific values of rates, ranges of rates, etc.
8. Activation indication information, for indicating whether to activate the model, the model may be the model included in the first message, or the model transmitted to the UE before step 14-1, or the model generated by the UE itself.

In one implementation, when the model is not distinguishing to services, the first message contains information about only one model; and in another implementation, when the model is distinguishing to services, the first message may contain information about one or more models.

In one implementation, when the base station updates the model in a synchronous manner, the base station may transmit the first message to the UEs in a broadcast or unicast manner; and in another implementation, when the base station updates the model in an asynchronous manner, the base station may transmit the first message to the UEs in a broadcast or unicast manner. In yet another implementation, the base station may transmit the first message to the UEs by means of software downloading or pushing, for example, transmit the first message to the UEs by upper-layer application software. In yet another implementation, the base station may transmit the first message to the UEs through signaling of the air interface (i.e., the interface between the base station and the UEs). In this way, the air interface signaling needs to be defined to transmit the model.

In other embodiments, one or more of the parameters or information may also be predefined.

Optionally, step 14-2 is also included: the UE transmits a second message to the network entity, where the second message may be used to confirm the correct reception of the first message, and the second message may include, but not limited to, at least one of the following information:
1. Information indicative of the use of the model. The information is used to indicate the model that the UE will use, or the model that the UE will not use. The information may include, but not limited to, at least one of the following information:
(1) Indication information of the model, used to indicate a model.
(2) Indication information for the use of the model, used to indicate whether the UE uses the model indicated by the “indication information of the model”.
(3) Indication information of the received model, used to indicate the model that the UE will use, for example, the first model triggered by steps 7-1 to 7-6.
(4) Indication information of the rejected model, used to indicate the model that the UE will not use, for example, the first model that is not activated determined in steps 7-1 to 7-6.

That is, in the embodiment of the present application, if the UE receives the first model from the base station, the following step may be included: transmitting, to the base station, information indicative of used first models and/or unused first models.

In other words, the base station may receive, from the third UE, information indicative of the first models used by the third UE and/or the first models not used by the third UE. The third UE may refer to some or all of the second UEs.
2. The second assistant information, including but not limited to at least one of the following information:
(1) average factor for calculating the accumulation rate, for example, α, α₁, α₂ mentioned above.
(2) The size of the time window used to calculate the average rate, for example, the second time window m.
(3) The size of the time window for data collection, for example, the first time window n.
(4) The size of the time window used to calculate the occurrence ratio of the scheduling information of the UE, for example, used in the step 7-1.
(5) The energy consumed by the UE to perform a prediction once by using the model, for example, used in the step 7-2.
(6) The energy consumed by the UE to perform one calculation in the model, for example, used when calculating the P_model in the above step 7-2.
(7) The energy consumed by the UE to detect the scheduling information once, for example, used in the step 7-2.
(8) The assumed ratio of the average over-detected scheduling information, for example, used in the step 7-3.
(9) The threshold value of energy saving, for example, the sixth threshold value, the eighteenth threshold value, the fourteenth threshold value, etc., which may be used in the step 7-4.
(10) The threshold value of the accuracy required by the model test, for example, the seventh threshold value, the fifteenth threshold value, the nineteenth threshold value, etc., which may be used in the step 7-6.
(11) The threshold value for the successive number of times that the UE has no scheduling information, for example, the eighth threshold value, the sixteenth threshold value, etc., which may be used in the steps 8-4, 12-4, and the like.
(12) A threshold value for the proportion of related signals occurring, for example, the fifth threshold, the seventeenth threshold, as described above, may be used in step 7-2 above.

Further optionally, before step 14-1, it may also include:

Step 14-0: the UE transmits a first request message to the network entity (e.g. base station) for indicating the UE's request for model usage and/or providing assistant information to the network entity, the message comprising at least one of the following information:
(1) a first request message, which is used to indicate a request by the UE, the message comprising at least one of:
(1) indication information of the requesting model, for indicating the UE to request the base station to transmit the model, further, the indication information may further indicate at least one of the following: the service corresponding to the requested model (e.g., PDU session identification information, QoS flow identification information, bearer identification information, logical channel identification information, indication information of the service type), user (e.g., UE identification information), area (e.g., area identification information, cell (e.g., UE identification information), area (e.g., area identification information, cell identification information), user rate (e.g., levels of rates, specific values of the rate, ranges of the rates, etc.).
(2) Indication information requesting to activate the model.
(3) Indication information requesting to deactivate the model.
(4) Indication information requesting to update the model.
2. Third assistant information that may include, but is not limited to, at least one of the following information:
(1) An averaging factor for calculating the accumulation rate, such as α, α₁, α₂, etc., above.
(2) A size of the time window used to calculate the average rate, such as the second time window m above.
(3) A size of the time window for data collection, e.g., the first time window n above.
(4) A size of the time window used to calculate the rate at which the scheduling information of the UE occurs, e.g. used in step 7-1 above.
(5) An energy consumed by the UE to perform one prediction by using the model, e.g. used in step 7-2 above.
(6) The energy consumed by the UE to perform one calculation by using the model, e.g. used in step 7-2 above for calculating P_model.
(7) The energy consumed by the UE to detect the scheduling information once, for example, used in the step 7-2 above.
(8) The assumed ratio of the average over-detected scheduling information, for example, used in the step 7-3 above.
(9) The threshold value of energy saving, for example, the sixth threshold value, the eighteenth threshold value, the fourteenth threshold value, etc., which may be used in the step 7-4 above.
(10) The threshold value of the accuracy required by the model test, for example, the seventh threshold value, the fifteenth threshold value, the nineteenth threshold value, etc., which may be used in the step 7-6 above.
(11) The threshold value for the successive number of times that the UE has no scheduling information, for example, the eighth threshold value, the sixteenth threshold value, etc., which may be used in the steps 8-4, 12-4, etc., above.
(12) A threshold value for the proportion of related signals occurring, for example, the fifth threshold, the seventeenth threshold, as described above, may be used in step 7-2 above.
(13) First indication information of QoS performance, for indicating the QoS performance that can be achieved by the user, such as rate, delay, packet loss rate, etc.
(14) Over-detection indication information, for indicating the number of times of PDCCH detections actually performed by the user and/or the number of times of detected DCIs and/or a ratio of the number of DCIs is detected (or DCIs for new data transmission) to the number of times of PDCCH detections.
(15) Energy saving indication information, for indicating the percentage of energy savings that can be achieved by the UE.

Optionally, steps 14-1 and 14-2 may be performed after the network entity determines that the first model needs to be transmitted to the UE.

In combination with at least one of the above embodiments, the embodiment of the present application can implement the monitoring of scheduling information by the UE according to the model. As an example, FIG. 15 shows a complete flow on the network entity side (The following description is illustrated using a base station as an example; in practice, the base station in the following description may be replaced with other network entities and the implementation described below will also be applicable) and the UE side to implement the monitoring of scheduling information.

Step 15-1: Generation of the model. For specific implementation, reference may be made to the description of the generation of the model.

Step 15-2: Deployment of the model. For specific implementation, reference may be made to the description of the deployment of the model. Optionally, after the base station determines that the model needs to be transmitted to the UE, the base station and the UE will interact according to the description of the steps 14-1 and 14-2.

Step 15-3a/3b: Triggering of the model. This is an optional step. For example, after the UE receives the model in step 15-2, the base station and the UE start to use the model for prediction without performing this step. If this step is performed, both the base station and the UE will determine whether to trigger the model. For the specific implementation, reference may be made to the description of the triggering of the model.

Step 15-4a/4b: Entering a slot.

Step 15-5a/5b: The base station uses the model to determine whether to transmit scheduling information (for example, DCI in FIG. 15) to the UE in this slot, and the UE uses the model to determine whether to monitor the scheduling information transmitted by the base station in this slot. For specific implementation, reference may be made to the description of the execution of the model.

Step 15-6a/6b: The base station transmits scheduling information to the UE, and the UE monitors the scheduling information.

For the embodiment of the present application, the steps 15-1, 15-2, 15-3a, 15-4a, 15-5a, and 15-6a are performed on the base station side, and the steps 15-3b, 15-4b, 15-5b, 15-6b are performed on the UE side.

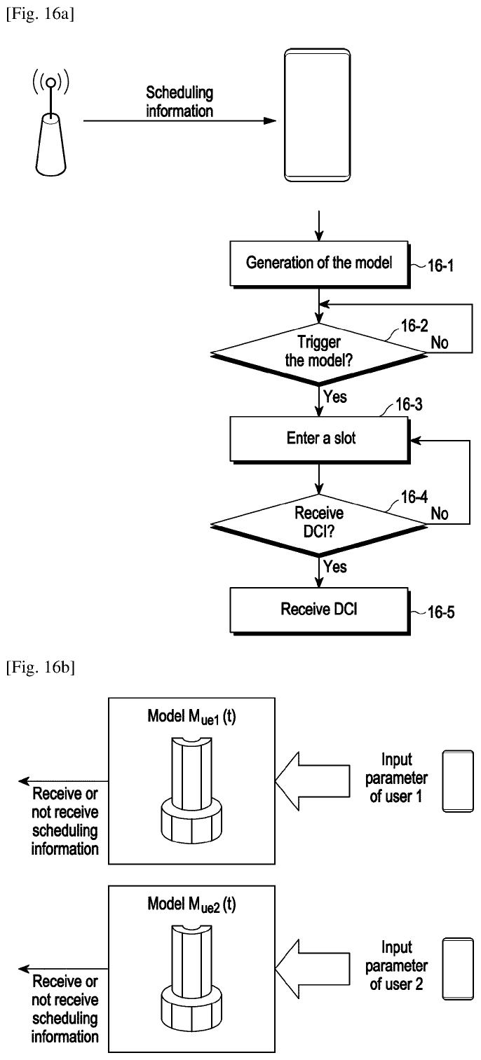

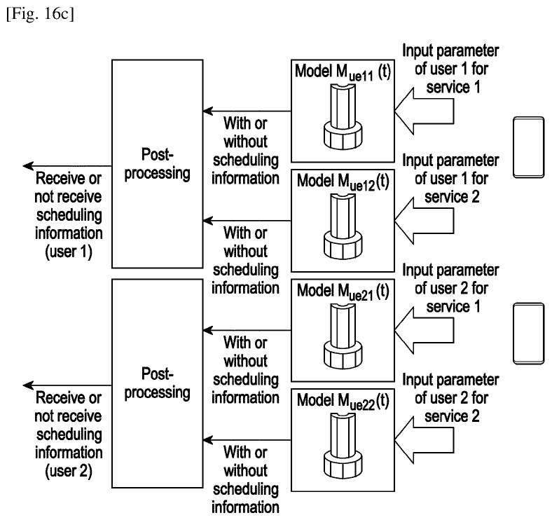

In the embodiment of the present application, a possible implementation is provided for the way 2 for using the model in FIG. 1b. In this way, only the UE side will use the model, while the base station side uses a traditional scheduling algorithm to decide whether to transmit scheduling information to the UE. Therefore, the model on the UE side needs to predict the behavior of the scheduling algorithm on the base station side to determine whether the UE monitors scheduling information. Specifically, the flow on the UE side will be shown in FIG. 16a.

Step 16-1: Generation of the model. For specific implementation, reference may be made to the description of the generation of the model. In the embodiment of the present application, this step is performed on the UE side. In other embodiments, the model may be generated by the base station and transmitted to the UE.

Step 16-2: Triggering of the model. This is an optional step. For example, after the UE generates a model, it can directly use the model without performing this step. If the UE performs this step, the UE will determine whether to trigger the model. For the specific implementation, reference may be made to the description of the triggering of the model.

Step 16-3: Entering a slot.

Step 16-4: The model is used to determine whether to monitor the scheduling information (for example, DCI in FIG. 16a) transmitted by the base station in this slot. For specific implementation, reference may be made to the description of the execution of the model.

Step 16-5: If so, the UE monitors the scheduling information.
or the embodiment of the present application, for the method for using the model on the UE side, reference may be made to FIG. 16b and FIG. 16c. Because the model for each UE is generated separately, the model on each UE side is different. In FIG. 16b, the model on the UE1 side is Mᵤₑ₁(t), and the model on the UE2 side is Mᵤₑ₂(t). In FIG. 16c, taking UE1 as an example, the models on the UE1 side are Mᵤₑ₁₁(t) and Mᵤₑ₁₂(t). The post-processing module on the UE1 side will output a result that indicates not to receive scheduling information, only when both the output results of the two models indicate that there is no scheduling information. Otherwise, a result that indicates to receive scheduling information will be output. The processing of UE2 is similar to that of UE1, and will not be repeated here.

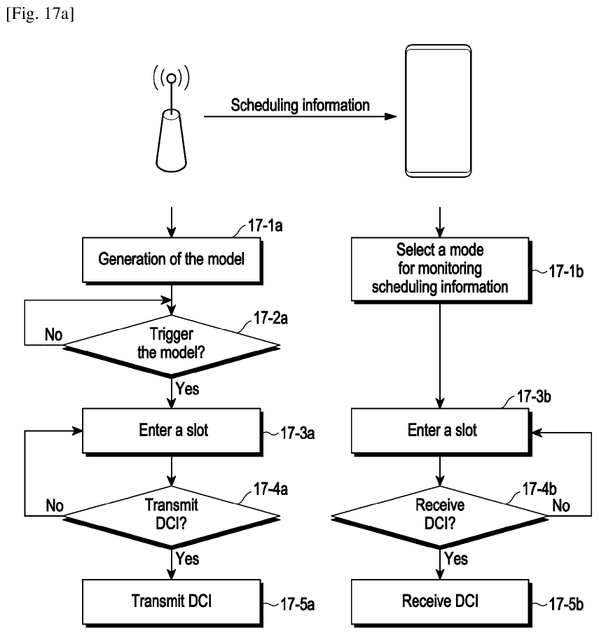

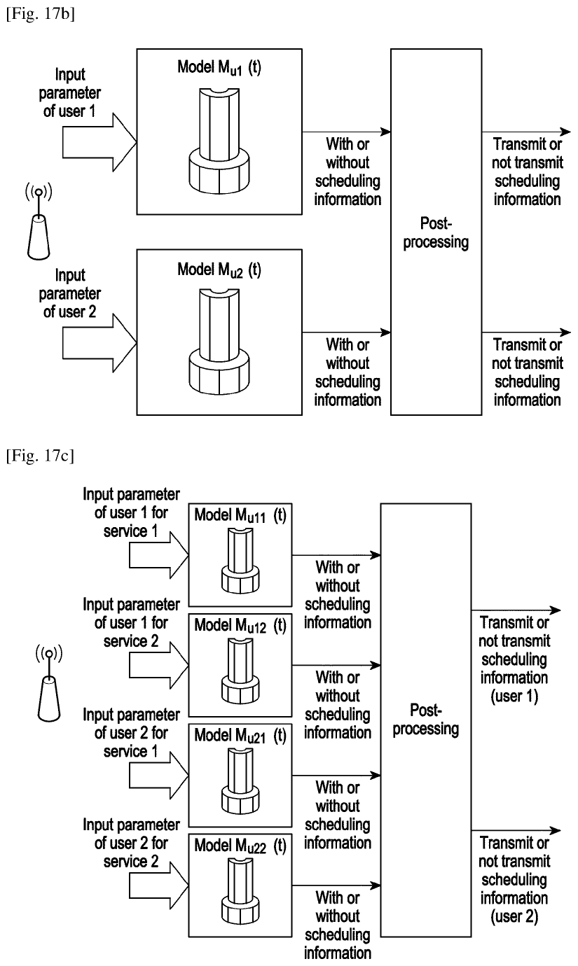

In the embodiment of the present application, a possible implementation is provided for the way 3 for using the model in FIG. 1c. In this way, only the base station side will generate a model, and the UE side will select an appropriate mode for monitoring scheduling information according to the characteristics of its own services. Therefore, the model on the base station side needs to predict the mode in which the UE side monitors the scheduling information to determine whether to transmit the scheduling information to the UE. Specifically, as shown in FIG. 17a, the flow on the base station side includes:

Step 17-1a: Generation of the model. For specific implementation, reference may be made to the description of the generation of the model. This step is performed at the base station side.

Step 17-2a: Triggering of the model. This is an optional step. For example, after the base station generates a model, it can directly use the model without performing this step. If this step is performed, the base station will determine whether to trigger the model. For the specific implementation, reference may be made to the description of the triggering of the model.

Step 17-3a: Entering a slot.

Step 17-4a: The model is used to determine whether to transmit scheduling information (for example, DCI in FIG. 17a) to the UE in this slot. For specific implementation, reference may be made to the description of the execution of the model.

Step 17-5a: If so, the base station transmits scheduling information to the UE.

The flow on the UE side includes:

Step 17-1b: The UE selects a mode for monitoring scheduling information. This mode indicates in which time units the UE will monitor scheduling information. In an embodiment, an optional mode may instruct the UE to monitor the scheduling information periodically, and then the mode may indicate the periodic information that the UE monitors the scheduling information, for example, the cycle length (e.g., the number of slots), the location information of time units in which the UE monitors the scheduling information in a cycle (for example, indicate slots in which the UE needs to monitor the scheduling information in the form of bitmap), etc. In another embodiment, another optional mode may instruct the UE to monitor the scheduling information in an aperiodic manner. Then, the mode will randomly indicate whether the UE needs to monitor the scheduling information within a time unit, or indicate whether the UE needs to monitor the scheduling information in each time unit. The UE will determine this mode according to the historical scheduling information. For example, the UE will determine the mode according to the ratio of the number of slots in which the UE receives scheduling information to the number of all slots in which the UE monitors scheduling information, and parameters required by the model (for example, cycle, the location of time units in which the UE needs to monitor scheduling information in a cycle, etc.). Further, the selection of this mode may be for different services, that is, different services may correspond to the same or different modes.

Based on this, an embodiment of the present application provides a method performed by a user equipment UE in a communication system, including:
Step SA: determining a mode for monitoring a first signal transmitted by a network entity;
Step SB: determining, based on the determined mode, a time unit for monitoring the first signal; and
Step SC: monitoring the first signal in the time unit;
wherein the mode for monitoring the first signal transmitted by the network entity includes at least one of the following:
a mode indicating a time unit for monitoring the first signal; and
a mode indicating whether to monitor the first signal at any time unit.

Optionally, the step SA specifically includes: determining a mode for monitoring a first signal transmitted by a network entity, according to the ratio of the number of time units in which the related signals are found to the number of time units in which the related signals are monitored.

Optionally, the step SA specifically includes: for at least one service, respectively determining a mode for monitoring a first signal transmitted by a network entity corresponding to the at least one service.

Step 17-3b: Entering a slot.

Step 17-4b: The UE determines whether to monitor the scheduling information in the slot according to the mode selected in step 17-1b. If the UE determines different modes based on different services, the UE does not monitor the scheduling information only when all modes indicate that the UE does not need to monitor the scheduling information.

Step 17-5b: If so, the UE receives the scheduling information.

For the embodiment of the present application, for the method for using the model on the base station side, reference may be made to FIG. 17b and FIG. 17c. Because the mode for monitoring the scheduling information selected by each UE may be different, the base station side generates models separately for different UEs when generating the models, thus the models for the UEs are different. In FIG. 17b, the model for UE1 is Mᵤ₁(t), and the model for UE2 is Mᵤ₂(t). The base station will post-process the output results of the two models. For this post-processing operation, reference may be made to the above introduction (for example, step 12-5), which will not be repeated here. Then, the base station finally decides whether to transmit scheduling information to the two UEs. In FIG. 17c, the models for service 1 and service 2 of UE1 are Mᵤ₁₁(t) and Mᵤ₁₂(t), respectively, and the models for service 1 and service 2 of UE2 are Mu₂₁(t) and Mᵤ₂₂(t), respectively. The base station will be post-process the output results of these models. For this post-processing operation, reference may be made to the above introduction (for example, the post-processing of step 12-5 and/or S902), which will not be repeated here. Then, the base station finally decides whether to transmit scheduling information to the two UEs.

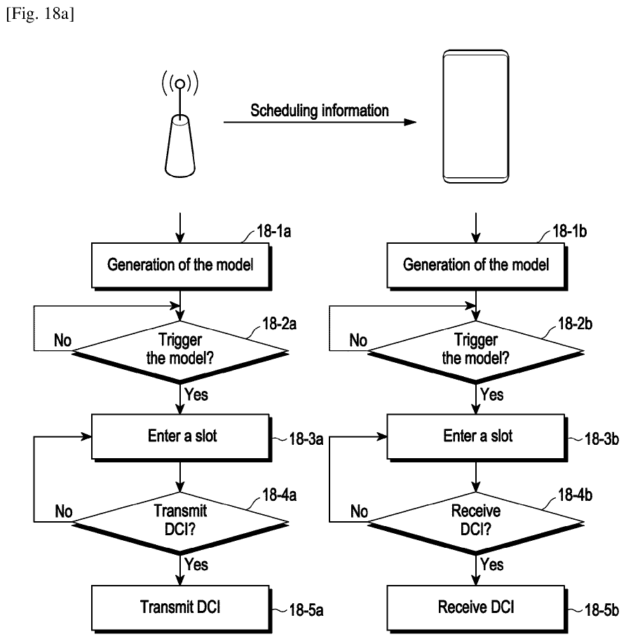

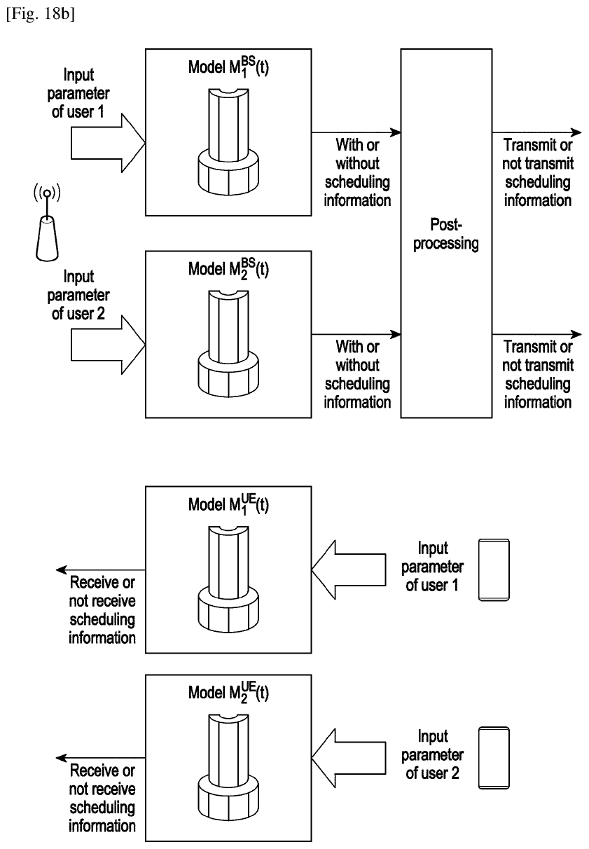

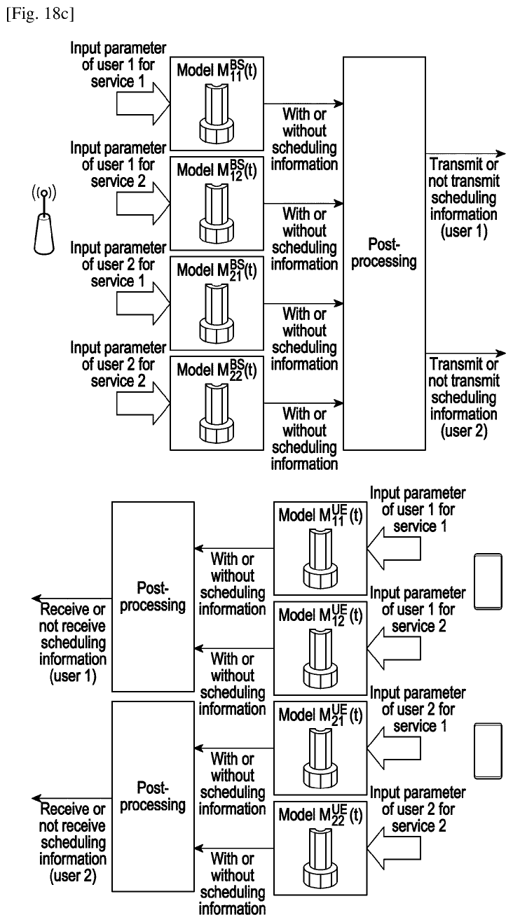

In the embodiment of the present application, a possible implementation is provided for the way 4 for using the model in FIG. 1d. In this way, both the base station side and the UE side generate models, but the two sides generate models independently, so the models used by the base station side and the UE side are different. Specifically, as shown in FIG. 18a, the flow on the base station side includes:

Step 18-1a: Generation of the model. For specific implementation, reference may be made to the description of the generation of the model. This step is performed at the base station side.

Step 18-2a: Triggering of the model. This is an optional step. For example, after the base station generates a model, it can directly use the model without performing this step. If this step is performed, the base station will determine whether to trigger the model. For the specific implementation, reference may be made to the description of the triggering of the model.

Step 18-3a: Entering a slot.

Step 18-4a: The model is used to determine whether to transmit scheduling information (for example, DCI in FIG. 18a) to the UE in this slot. For specific implementation, reference may be made to the description of the execution of the model.

Step 18-5a: If so, the base station transmits scheduling information to the UE.

The flow on the UE side includes:

Step 18-1b: Generation of the model. For specific implementation, reference may be made to the description of the generation of the model. This step is performed on the UE side.

Step 18-2b: Triggering of the model. This is an optional step. For example, after the UE generates a model, it can directly use the model without performing this step. If the UE performs this step, the UE will determine whether to trigger the model. For the specific implementation, reference may be made to the description of the triggering of the model.

Step 18-3b: Entering a slot.

Step 18-4b: The UE uses the model to determine whether to monitor the scheduling information transmitted by the base station in this slot. For specific implementation, reference may be made to the description of the execution of the model.

Step 18-5b: If so, the UE monitors the scheduling information.

For the embodiment of the present application, for the method for using the model on the base station side and UE side, reference may be made to FIG. 18b and FIG. 18c. FIG. 18b shows a method for using the model by the base station and two UEs when the model is not distinguishing to services. Specifically, before the start of a slot, the base station will run two different models M₁^{BS}(t) and M₂^{BS}(t). The two models correspond to UE1 and UE2, respectively. The input parameters of UE1 and UE2 are respectively input to the two models. The output results of the two models (that is, whether or not there is scheduling information) will be processed by a post-processing module to generate a final result that indicates whether the base station needs to transmit scheduling information to the two UEs. For the operations of the post-processing module, reference may be made to the above introduction (for example, step 12-5), which will not be repeated here. On the UE side, UE1 and UE2 will run two different models M₁^{UE} (t) and M₂^{UE} (t), respectively. Each UE will input its own data into the model. The UE will determine whether to receive scheduling information according to the output result of the model. FIG. 18c shows a method for using the model by the base station and two UEs when the model is distinguishing to services. For the convenience of description, it is assumed that each UE has two services. Specifically, before the start of a time unit, for UE1, the base station runs the models M₁₁^{BS}(t) and M₁₂^{BS}(t) corresponding to service 1 and service 2 of UE1, respectively. The parameters of UE1 related to service 1 and service 2 are input to the two models. The two models generate output results (that is, whether or not there is scheduling information). Similarly, for UE2, the base station runs the models M₂₁^{BS} (t) and M₂₂^{BS}(t) corresponding to service 1 and service 2 of UE2, respectively. The parameters of UE2 related to service 1 and service 2 are input to the two models. The two models generate output results (that is, whether or not there is scheduling information). The output results of the four models will be processed by a post-processing module to generate a final result that indicates whether the base station needs to transmit scheduling information to the two UEs (there is a final result for each UE). For the operations of the post-processing module, reference may be made to the above introduction (for example, the post-processing of step 12-5 and/or S902), which will not be repeated here. On the UE side, UE1 will run two models M₁₁^{UE} (t) and M₁₂^{UE}(t) for service 1 and service 2, respectively. The two models are different from those on the base station side. The UE1 inputs the input parameters related to service 1 and service 2 into the models M₁₁^{UE} (t) and M₁₂^{UE} (t), respectively, to obtain output results of the models. Further, the output results of the two models will be processed by a post-processing module. The post-processing module works in the following way: if one of the output results of all models run on the UE side indicates that the UE needs to receive scheduling information, the output result from the post-processing module is to receive scheduling information; and if the output results of all models run on the UE side indicate that the UE does not need to receive scheduling information, the output result from the post-processing module is not to receive scheduling information. In the same way, UE2 will determine whether to receive scheduling information, according to the two models (M₂₁^{UE}(t) and M₂₂^{UE}(t)) generated by it, which are different from the models on the base station side. This process will not be repeated here.

It should be understood by a person of ordinary skill in the art that the above usage scenarios of the models are merely exemplary, and appropriate changes based on these examples may also be applied to the present application, so they should also be included in the protection scope of the present application.

In the embodiment of the present application, implementations of mobility support are provided for how to implement UEs in a mobile state to monitor the scheduling information based on a model, specifically, but not limited to, the following two methods of model deployment.
Method 1: the models are deployed at cell level, i.e., different models can be deployed for different cells.
Method 2: The models are deployed at area level, i.e., different models may be deployed in different areas, which may contain one or more cells within an area. Further, the division of the area may also be related to the rate of the user, e.g., the area for high speed users is different from the area for low speed users.

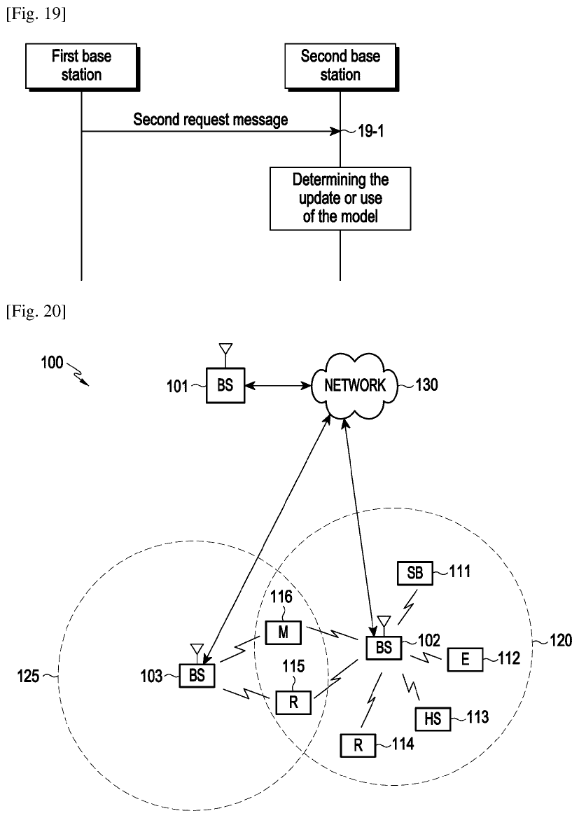

When the UE moves from one cell to another, the source base station and the target base station need to interact in signaling in order to complete the coordination of the models used in the different cells, specifically, the following process may also be included, as shown in FIG. 19.

Step 19-1: The first base station (or the centralized unit of the base station, or the control plane portion of the centralized unit of the base station, the base station may be the source base station or the target base station) transmits a second request message to the second base station (or the distribution unit of the base station, the base station may be the source base station or the target base station) for requesting a UE handover, such as a handover request message, a user context establishment request message, etc., the request message may contain at least one of the following information:
1. Model related information, the description of which can be found in step 14-1 above, in one embodiment, the model indicated by the information is the model being used by the UE. In one embodiment, the information may contain the model corresponding to the cell/area in which the UE is located, in another embodiment, the information may contain the model corresponding to the neighbor cell/area of the cell/area where the UE is located, and in another embodiment, the information may contain both the model corresponding to the cell/area in which the user is located and the model corresponding to the neighbor cell/area of the cell/area where the UE is located.
2. indication information of the network performance, for indicating the performance status of the network (e.g. cell) where the UE is located before handover, such as load (e.g. resource occupancy rate, resource occupancy rate of a particular service), spectrum efficiency (or spectrum efficiency of a particular service), delay (or delay of a particular service), packet loss rate (or packet loss rate of a particular service), etc.
3. indication information of user performance, for indicating the performance, such as throughput, delay, packet loss rate, etc., that can be achieved by the network (e.g., cell) where the UE is located before handover, and further, the indication information can be further used to indicate whether the user performance has a decreasing trend.
4. the number of times of the update of the model.

Step 19-2: The second base station (or the distribution unit of the target base station) determines the update or use of the model based on the information received in step 19-1.
1. The second base station (or the distribution unit of the target base station) determines to follow the model used by the user before handover based on at least one of the following cases:
(1) the first base station (or the distribution unit of the source base station) and the second base station (or the distribution unit of the target base station) have similar performance, e.g., little change in load.
(2) The first base station does not indicate a degradation of user performance.
2. The second base station (or the distribution unit of the target base station) determines to update the model based on at least one of the following:
(1) The information contained in the “second request message” above is not received.
(2) The performance difference between the first base station (or the distribution unit of the source base station) and the second base station (or the distribution unit of the target base station), such as a significant change in load.
(3) The base station indicates the degradation of the UE performance.
(4) The area where the second base station is located is different from the area where the first base station is located, the area means the area where the same model is used.

By the method provided in the embodiments of the present application, the UE is enabled to determine whether to monitor the scheduling information according to the output of the model. This avoids the situation that a UE needs to monitor the scheduling information within all configured time units in the traditional technologies, and thus saves energy consumed by the UE to receive the scheduling information.

In addition, in case of heavy load, the UE still does not need to monitor the scheduling information in each time unit, which reduces the energy consumption of the UE and prolongs the service life of the UE terminal.

By the method in the embodiment of the present application, the base station side can determine whether to transmit scheduling information to the UE according to the output of the model, and avoid using a complex scheduling algorithm to determine the scheduled UE, which reduces the complexity of the base station side.

In addition, the network served by the base station can satisfy the QoS requirements of different UEs, and can also implement different QoS satisfaction mechanisms for different services.

The method in the embodiment of the present application enables the exchange of model information between the base station and the UE, which reduces unnecessary transmission of air interface information and saves air interface resources.

It has been proven by the inventor(s) of the present application through a large number of experiments that the solutions provided in the embodiments of the present application can reduce PDCCH monitoring by 56% and save power by 53% while ensuring the throughput of the UE.

An embodiment of the present application provides a UE. The UE may include a first execution module and a first determination module, wherein:
the first execution module is configured to obtain a first output result by inputting a first input parameter related to a to-be-monitored time unit into a first model; and
the first determination module is configured to determine, based on the first output result, whether to monitor a first signal transmitted by a network entity within the to-be-monitored time unit.

Optionally, the first execution module is specifically configured to obtain a first output result respectively corresponding to at least one service, by respectively inputting the first input parameter related to the at least one service into the first model respectively corresponding to the at least one service; and
the first determination module is specifically configured to determine, based on the first output result respectively corresponding to the at least one service, whether to monitor the first signal within the to-be-monitored time unit.

Optionally, the UE further includes a monitoring module configured to: not monitor the first signal within the to-be-monitored time unit if the first output result re-spectively corresponding to the at least one service indicates not to monitor the first signal within the to-be-monitored time unit; otherwise, monitor the first signal within the to-be-monitored time unit.

Optionally, the UE further includes a model obtaining module configured to obtain the first model in at least one of the following ways:
training, based on collected first data set, to generate the first model; and
receiving the first model from a network entity.

Optionally, the model obtaining module is further used for receiving the first message transmitted by the network entity.

Optionally, the model obtaining module is specifically used in at least one of the following situations:
to receive, from a network entity, the first model updated in a synchronous manner; and
to receive, from a network entity, the first model updated in an asynchronous manner;
to receive, from a network entity, the directly updated first model.

Optionally, the model obtaining module is specifically used in at least one of the following situations:
to periodically receive, from a network entity, the first model updated in a synchronous manner; and
to receive, from a network entity, the first model updated in a synchronous manner, if the number of UEs for which the first model needs to be updated is greater than a first threshold value.

Optionally, the model obtaining module is specifically configured to receive, from a network entity, the first model updated in an asynchronous manner, if the number of UEs for which the first model needs to be updated is not greater than a first threshold value when it is needed to update the first model.

Optionally, whether to update the first model is determined by at least one of the following information:
a detection result of the network performance in using the first model and a second threshold value;
a detection result of the UE performance in using the first model and a third threshold value;
the number of update times of the first model and a fourth threshold value.

Optionally, the UE further includes a transmitting module configured to transmit, to the network entity, information indicative of used first models and/or unused first models.

Optionally, the first execution module is specifically configured to, in at least one of the following situations, obtain a first output result by inputting a first input parameter related to a to-be-monitored time unit into a first model or request the first model from the network entity:
the occurrence ratio of a related signal is less than a fifth threshold value;
the potential energy saving by using the first model is greater than a sixth threshold value; and
the accuracy of the first model is greater than a seventh threshold value.

Optionally, the first execution module is specifically configured to: obtain a first output result by inputting a first input parameter related to a to-be-monitored time unit into a first model, if it is determined that there is no related signal that must be received; and
the monitoring module is further configured to: monitor the first signal within the to-be-monitored time unit, if it is determined that there are related signals that must be received.

An embodiment of the present application provides a network entity. The network entity may include a second execution module and a second determination module, wherein:
the second execution module is configured to obtain a second output result by inputting a second input parameter related to a to-be-monitored time unit of a first user equipment UE into a second model; and
the second determination module is configured to determine, based on the second output result, whether to transmit a second signal to the first UE or whether to select the first UE for scheduling within the to-be-monitored time unit.

Optionally, the second execution module is specifically used in at least one of the following situations:
to obtain a second output result respectively corresponding to at least one service, by respectively inputting the second input parameter related to the at least one service into the second model respectively corresponding to the at least one service; and
to obtain a second output result respectively corresponding to the at least one first UE, by respectively inputting the second input parameter related to the at least one first UE into the second model respectively corresponding to the at least one first UE;
the second determination module is specifically used in at least one of the following situations:
to determine, based on the second output result respectively corresponding to the at least one service, whether to transmit the signal to the first UE or whether to select the first UE for scheduling within the current time unit; and
to determine, based on the second output result respectively corresponding to the at least one first UE, whether to transmit the signal to the at least one first UE or whether to select at least one first UE for scheduling within the current time unit.

Optionally, the network entity further includes a transmitting module configured to: not transmit the second signal to the first UE within the to-be-monitored time unit, if the second output result respectively corresponding to the at least one service indicates not to transmit the second signal to the first UE within the to-be-monitored time unit; otherwise, transmit the second signal to the first UE within the to-be-monitored time unit; or, if the second output results respectively corresponding to the at least one service all indicate not to select the first UE for scheduling within the to-be-monitored time unit, then not select the first UE for scheduling within the to-be-monitored time unit; otherwise, select the first UE for scheduling within the to-be-monitored time unit

Optionally, the network entity further includes a model generation module used for at least one of the following operations:
training, based on collected second data set, to generate a second model; and
training, based on collected third data set, to generate the first model; and

The transmitting module is specifically configured to transmit the first model to the second UE.

Optionally, the transmitting module is further configured to transmit the first message to the second UE.

Optionally, the transmitting module is specifically configured to transmit the first model to the second UE, if it is determined that the model performance of the first model is better than a preset performance standard.

Optionally, the transmitting module is specifically used in at least one of the following situations:
to transmit, to the second UE, the updated first model in a synchronous manner; and
to transmit, to the second UE, the updated first model in an asynchronous manner.
to directly transmit, to the second UE, the updated first model.

Optionally, the transmitting module is specifically used in at least one of the following situations:
to periodically transmit, to the second UE, the updated first model in a synchronous manner; and
to transmit, to the second UE, the updated first model in a synchronous manner, if the number of second UEs for which the first model needs to be updated is greater than a ninth threshold value.

Optionally, the transmitting module is specifically configured to transmit, to the second UE for which the first model needs to be updated, the updated first model in an asynchronous manner, if the number of second UEs for which the first model needs to be updated is not greater than the ninth threshold value.

Optionally, the second determination module is further configured to:
a second UE for which the first model needs to be updated is determined by at least one of the following information:
a detection result of the network performance of the second UE in using the first model and a tenth threshold value;
a detection result of the UE performance of the second UE in using the first model and an eleventh threshold value; and
the number of update times of the first model of the second UE and a twelfth threshold value.

Optionally, the network entity further includes a receiving module configured to receive, from a third UE, information indicative of a first model used by the third UE and/or a first model not used by the third UE.

Optionally, the second execution module is specifically configured to, in at least one of the following situations, obtain a second output result by inputting a second input parameter related to a to-be-monitored time unit into a second model:
the occurrence ratio of a second signal is less than a thirteenth threshold value;
the potential energy saving by using the second model is greater than a fourteenth threshold value; and
the accuracy of the second model is greater than a fifteenth threshold value.

Optionally, the second execution module is specifically configured to obtain a second output result by inputting a second input parameter related to a to-be-monitored time unit of a first UE into a second model, if it is determined that there is no second signal that must be transmitted to the first UE.

The transmitting module is further configured to, if it is determined that there is a second signal that must be transmitted to the first UE, transmit the second signal to the first UE within the to-be-monitored time unit.

Optionally, if it is determined, based on the second output result, not to transmit the second signal to the first UE within the to-be-monitored time unit, the transmitting module is further configured to also transmit the second signal to the first UE or not select the first UE for scheduling within the to-be-monitored time unit in at least one of the following situations:
the predetermined QoS of the first UE is not satisfied; and
the number of times that the related signal is not received continuously by the first UE is greater than a sixteenth threshold value.

The network entity further includes a scheduling module used in at least one of the following situations:
to schedule, by a scheduling algorithm, the multiple UEs and/or UEs for which a first model is not deployed; and
to allocate, by a scheduling algorithm, resources to the multiple UEs and/or UEs for which a first model is not deployed.

An embodiment of the present application further provides a UE. The UE may include a mode determination module, a time unit determination module, and a signal monitoring module, wherein,
the mode determination module is configured to determine a mode for monitoring a first signal transmitted by a network entity;
the time unit determination module is configured to determine, based on the de-termined mode, a time unit for monitoring the first signal; and
the time unit determination module is configured to monitor the first signal within the time unit;
wherein, a mode for monitoring a first signal transmitted by a network entity includes at least one of the following:
a mode indicating a time unit to monitor the first signal; and
a mode indicating whether to monitor the first signal at any time unit.

Optionally, the mode determination module is specifically configured to determine a mode for monitoring a first signal transmitted by a network entity, according to a ratio of the number of time units in which a related signal is found to time units in which the related signal is monitored.

Optionally, the mode determination module is specifically configured to: for at least one service, respectively determine a mode for monitoring a first signal transmitted by a network entity respectively corresponding to at least one service.

The UE or the network entity provided in the embodiments of the present application can execute the methods provided in the embodiments of the present application, and the implementation principles thereof are similar. The actions performed by the modules of the apparatus in the embodiments of the present application correspond to the steps of the method in the embodiments of the present application. For the detailed functional description of the modules of the apparatus and the beneficial effects produced, reference may be made to the description in the corresponding method shown above, and details will not be repeated here.

The UE or network entity provided in the embodiments of the present application may implement at least one module among multiple modules through an AI model. AI-related functions may be performed by non-volatile memories, volatile memories, and processors.

The processor may include one or more processors. In this case, the one or more processors may be general-purpose processors such as central processing units (CPUs), application processors (APs), etc., or pure graphics processing units such as graphics processing units (GPUs), visual processing Units (VPUs), and/or AI-specific processors such as neural processing units (NPUs).

The one or more processors control the processing of input data according to predefined operating rules or artificial intelligence (AI) models stored in non-volatile memories and volatile memories. The predefined operating rules or AI models are provided by training or learning.

Here, providing by learning refers to obtaining predefined operating rules or AI models having desired characteristics by applying learning algorithms to multiple pieces of learning data. This learning may be performed in the apparatus itself in which the AI according to an embodiment is performed, and/or may be implemented by a separate server/system.

The AI model may contain multiple neural network layers. Each layer has multiple weight values. The calculation of a layer is performed by the calculation result of the previous layer and the multiple weights of the current layer. Examples of neural networks include, but not limited to, convolutional neural networks (CNN), deep neural networks (DNN), recurrent neural networks (RNN), restricted Boltzmann machines (RBM), deep belief networks (DBN), bidirectional recurrent deep neural networks (BRDNN), generative adversarial networks (GAN), and deep Q-networks.

A learning algorithm is a method of training a predetermined target apparatus (e.g., a robot) using multiple pieces of learning data to cause, allow or control the target apparatus to make determinations or predictions. Examples of such learning algorithms include, but not limited to, supervised learning, unsupervised learning, semi-supervised learning, or reinforcement learning.

An embodiment of the present application provides an electronic device, including: a transceiver configured to transmit and receive signals; and a controller coupled to the transceiver and configured to execute steps of the foregoing method embodiments. Op-tionally, the electronic device may be a UE, and a processor in the electronic device is configured to perform control to implement steps of the method performed by a UE in the foregoing method embodiments. Optionally, the electronic device may be a network entity, and a processor in the electronic device is configured to perform control to implement steps of the method performed by a network entity in the foregoing method embodiments.

In the embodiment of the present application, for a slot (e.g., slot t), when a base station and a UE perform interference by executing a model, the base station and the UE will perform interference by using the model according to the currently collected data and according to the input parameters required by the model. To enable the base station and the UE to generate a consistent inference result (the UE can determine whether to monitor PDCCHs in the slot t by using the inference result only when a consistent inference result is generated), the parameters input to the model should be the same. However, in an actual system, inconsistent input parameters may be generated on the base station and UE sides. There are many reasons for this phenomenon.
Reason 1: Different time points when the base station side and the UE side judge the correct reception of a data packet.

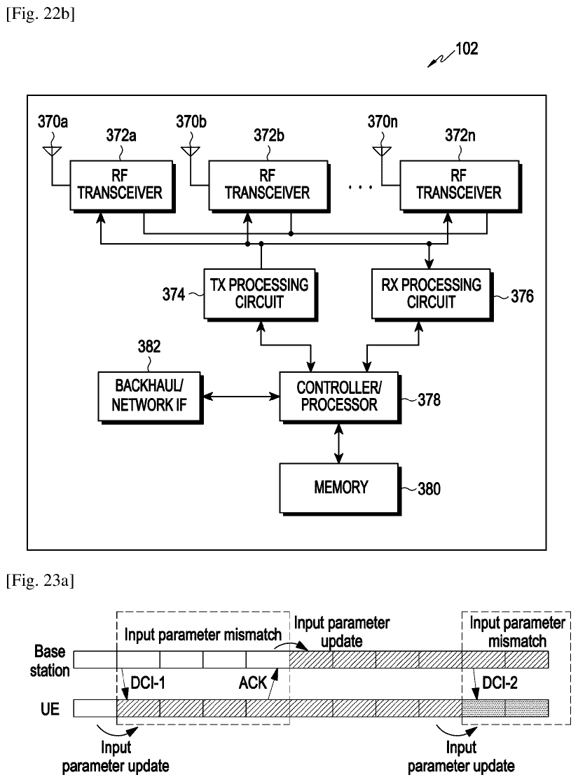

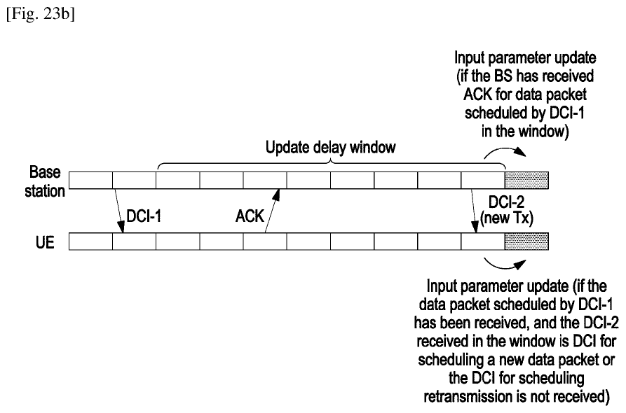

For example, the UE considers that the data packet has been correctly received after the data packet on the resource scheduled by the DCI is correctly received, while the base station can know the correct reception of the data packet only after the acknowl-edgement information (e.g., HARQ ACK) fed back by the UE is received. As shown in FIG. 23a, after the base station transmits DCI-1, the UE sides correctly receives the DCI-1 and correctly receives a data packet scheduled by the DCI-1, and the UE updates the input parameters based on this correctly received data packet. However, the base station updates the input parameters only after the ACK information transmitted by the UE is received. Further, upon receiving DCI-2, the UE will update the input parameters. Thus, there is a mismatch in input parameters between the base station side and the UE side.
Reason 2: Loss of signaling, e.g., loss of DCI, or loss of ACK or NACK information of HARQ.

As a result, in the same slot, since the base station side and the UE side perform inference by using different input parameters, the inference results are different, resulting in unnecessary PDCCH monitoring or missing PDCCH monitoring. To avoid the occurrence of this problem, the embodiment of the present application provides a method for delaying parameter update. Specifically, if a data transmission occurs in the slot t (the base station schedules a new data packet transmission through the DCI), the update of the input parameters (the specific input parameters may be found in the above description of “first input parameter” in FIG. 3) caused by this slot (e.g., the update of the QoS parameter (for example, rate) obtained by the user caused by the data transmission occurring in the slot t; for another example, the update of the obtained scheduling probability; for another example, the update of the obtained non-scheduling indication information) will occur in a slot t+n. In one example, the slot t+n can ensure that the base station and the UE can obtain the same result of the data transmission occurring in the slot n in the slot t+n. The parameter n may be a parameter determined by the base station or a parameter determined by the UE. When the parameter n is a parameter determined by the base station, the base station will transmit this parameter (e.g., “input data update time window” above) to the UE; and, when the parameter n is a parameter determined by the UE, the UE will transmit this parameter (e.g., “input data update time window” above) to the base station. Specifically, on the base station side, after the base station transmits DCI for scheduling a new data packet to the UE, the base station will start a window for the parameter update of the DCI (the length of the window is the length set by the “input data update time window” above). If the base station has received, within the window, the ACK information (e.g., HARQ ACK) for the correct reception of the data packet scheduled by the DCI transmitted by the UE, the base station will update parameters at the end of this window. This update is an update performed after the data packet scheduled by the DCI is correctly received. On the UE side, after the UE receives DCI for scheduling a new data packet, the UE will start a window for the parameter update of the DCI (the length of the window is the length set by the “input data update time window” above). If the UE has transmitted, within the window, the ACK information (e.g., HARQ ACK) for the correct reception of the data packet scheduled by the DCI to the base station and has not received a retransmission scheduling indication for the data packet scheduled by the DCI (e.g., scheduling the retransmitted DCI), the UE will update parameters at the end of this window. This update is an update performed after the data packet scheduled by the DCI is correctly received. To describe the method for delaying parameter update, different implementations will be explained below.
Implementation 1: the base station has transmitted DCI in the slot t, and the UE has received the DCI.

The user has received, and correctly received, the data in the slot t, but the user will not use the correctly received data packet to update the input parameters of the model. The user will use the correctly received data packet to update the input parameters in a slot t+n. Between t and t+n (n is the size of the update delay window), the user transmits HARQ ACK information, and has not received a retransmission scheduling (or DCI for scheduling a new data packet). The base station will not update the input parameters of the model in the slot t, and will use the data packet scheduled in the slot t to update the input parameters in the slot t+n. Between t and t+n, the base station has received the HARQ ACK transmitted by the user. As shown in FIG. 23b, the base station has transmitted DCI-1 to the user in the slot t and the user has received the DCI-1, and both the base station and the UE side start the update delay window. On the base station side, if the ACK information for the data packet scheduled by the DCI-1 has been received in this window, the base station will update the input parameters generated for the data packet scheduled by the DCI-1 at the end of this window; and on the UE side, if the UE has received the data packet scheduled by the DCI-1 and has received DCI-2 (DCI for scheduling a new data packet transmission) or has not received DCI for scheduling retransmission in the window, the base station will update the input parameters generated for the data packet scheduled by the DCI-1 at the end of this window.
Implementation 2: the base station has transmitted DCI in the slot t, and the UE has not received the DCI (DCI lost).

The base station will start a parameter update window for the DCI after transmitting the DCI, but the base station should not receive the ACK information (e.g., HARQ ACK) for the correct reception of the data scheduled by the DCI transmitted by the UE at the end of this window, so the base station will not use the data packet scheduled by the DCI for parameter updating. On the UE side, since the DCI has not been received, the UE will neither start the parameter update window nor perform parameter updating.
Implementation 3: the base station has transmitted DCI in the slot t and the UE has received the DCI, but the ACK information (HARQ ACK) for the correct reception of data fed back by the UE is lost.

The base station will start a parameter update window for the DCI after transmitting the DCI, but the base station should not receive the ACK information (e.g., HARQ ACK) for the correct reception of the data scheduled by the DCI transmitted by the UE at the end of this window, so the base station will transmit DCO for scheduling retransmission to the UE before the end of the window. At the end of the window, the base station will use the data packet scheduled by the DCI for parameter updating. On the UE side, since the DCI has been received, the UE will also start the parameter update window, and then the UE will transmit ACK information (HARQ ACK) for the correct reception of data. However, the UE will receive the DCI information for scheduling retransmission before the end of the window, so the UE will not use the data packet scheduled by the DCI for parameter updating at the end of the window.

In the embodiment of the present application, the model based scheduling can also assist the base station side to indicate the UE to monitor PDCCHs. In one example, the indication may be a window indicating that there is no need for PDCCH monitoring, and this window includes one or more slots. Upon receiving the indication information, the UE does not need to perform PDCCH monitoring in this window. In another example, the indication may be a window indicating that there is a need for PDCCH monitoring, and this window includes one or more slots. Upon receiving the indication information, the UE needs to perform PDCCH monitoring in this window. To acquire the window for PDCCH monitoring or the window without PDCCH monitoring, the base station side needs to continuously perform inference in one or more slots after the slot t, so as to determine whether the UE needs to perform PDCCH monitoring in one or more slots after the slot t. For a user, the specific implementation is described below.

Before the slot t, the base station obtains the inference of the model in the slot t according to the current input parameters, and performs scheduling according to the inference result. If the user is scheduled, the input parameters of the model are updated; and, if the user is not scheduled, the input parameters of the model are not updated. After obtaining the latest input parameters, the base station, after obtaining the inference of the model in slot t+1, and according to the inference result, performs scheduling, and updates the input parameters of the model if the user is scheduled, and not updates the input parameters of the model if it is not scheduled; after obtaining the latest input parameters, the base station, after obtaining the inference of the model in time slot t+2, and according to the inference result, performs scheduling, and updates the input parameters of the model if the user is scheduled, and not updates the input parameters of the model if it is not scheduled; by that analogy, the above process may be terminated after at one of the following conditions is satisfied:
Condition 1: the number of slots for continuous inference exceeds a certain threshold. In one embodiment, the threshold may be preconfigured for the base station; in another embodiment, the threshold may be a time window for channel updating (for example, in the time window, the channel state is not updated); in another embodiment, the threshold may be the time to the next channel state update; in another embodiment, the threshold may be generated by the base station itself.
Condition 2: the continuous interference result is changed, for example, the inference in multiple continuous slots from the slot t is the same. When the inference in a slot t+m is different from the previous inference, the continuous inference is terminated.

After the continuous inference in the above multiple slots, the base station will transmit indication information for PDCCH monitoring to the UE according to the continuous inference result. The user may determine, according to the indication information, whether to perform PDCCH monitoring in one or more candidate slots. This method has the following beneficial effects: model inference does not need to be performed in each slot on the UE side, so the calculation on the UE side is reduced, and the energy consumption of the user is saved.

To calculate the energy consumption of the UE caused by the method provided in the embodiment of the present application, an embodiment of the present application further provides a method for calculating energy consumption. The energy consumed by the UE includes inference using the model and PDCCH monitoring, and may be expressed by the following formula:

$$\frac{{T}_{act} {P}_{DCI} - ( {T}_{act} {P}_{ML} + {T}_{DCI} {P}_{DCI} )}{{T}_{act} {P}_{DCI}} = 1 - \frac{{P}_{ML}}{{P}_{DCI}} - \frac{{τ}_{DCI}}{{T}_{act}} \qquad ( 5 )$$

where, T_{act} and T_{DCI} represent the activation time length (e.g., the number of slots or time length for allowing UE to monitor PDCCHs in the DRC mechanism) or the length for monitoring PDCCHs (or DCI), respectively, and P_{DCI} and P_{ML} represent the energy consumed by the user for PDCCH monitoring and the energy consumed by the user for model inference, respectively.

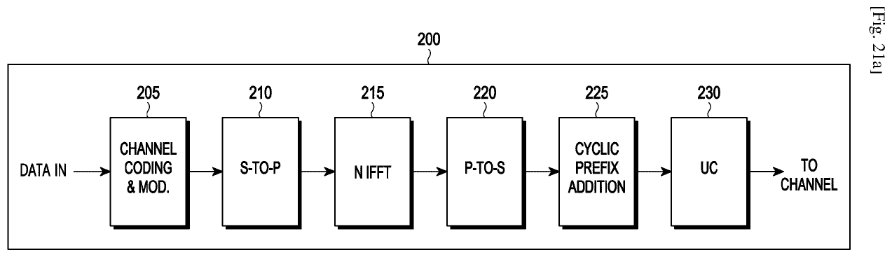

FIG. 20 illustrates an example wireless network 100 according to various embodiments of the present disclosure. The embodiment of the wireless network 100 shown in FIG. 20 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio en-vironment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 20 illustrates an example of the wireless network 100, various changes can be made to FIG. 20. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

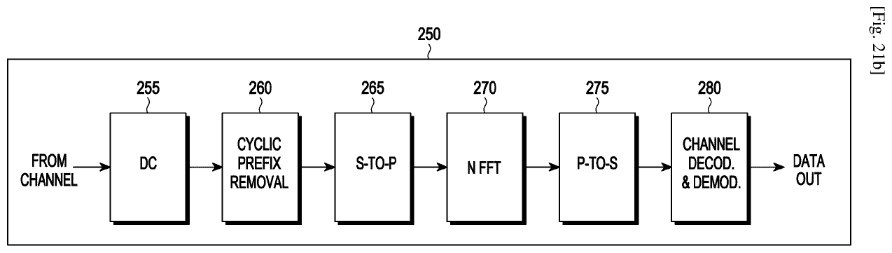

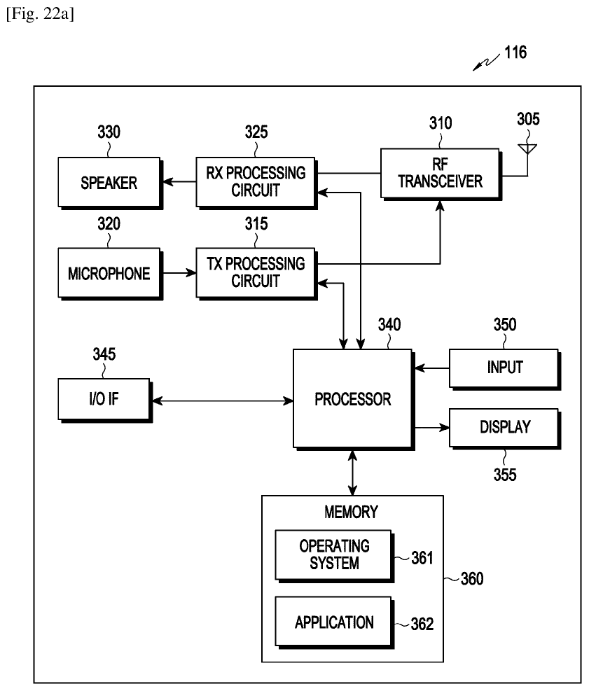

FIGS. 21a and 21b illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N-point Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 21a and 21b can be implemented using only hardware, or using a combination of hardware and software/firmware. As a specific example, at least some of the components in FIGS. 21a and 21b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 21a and 21b illustrate examples of wireless transmission and reception paths, various changes may be made to FIGS. 21a and 21b. For example, various components in FIGS. 21a and 21b can be combined, further subdivided or omitted, and additional components can be added according to specific requirements. Furthermore, FIGS. 21a and 21b are intended to illustrate examples of types of transmission and reception paths that can be used in a wireless network. Any other suitable architecture can be used to support wireless communication in a wireless network.

FIG. 22a illustrates an example UE 116 according to the present disclosure. The embodiment of UE 116 shown in FIG. 22a is for illustration only, and UEs 111-115 of FIG. 20 can have the same or similar configuration. However, a UE has various configurations, and FIG. 22a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these ac-cessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 22a illustrates an example of UE 116, various changes can be made to FIG. 22a. For example, various components in FIG. 22a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 22a illustrates that the UE 116 is configured as a mobile phone or a smart phone, UEs can be configured to operate as other types of mobile or fixed devices.

FIG. 22b illustrates an example gNB 102 according to the present disclosure. The embodiment of gNB 102 shown in FIG. 22b is for illustration only, and other gNBs of FIG. 20 can have the same or similar configuration. However, a gNB has various configurations, and FIG. 22b does not limit the scope of the present disclosure to any specific implementation of a gNB. It should be noted that gNB 101 and gNB 103 can include the same or similar structures as gNB 102.

As shown in FIG. 22b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 22b illustrates an example of gNB 102, various changes may be made to FIG. 22b. For example, gNB 102 can include any number of each component shown in FIG. 22a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In an optional embodiment, an electronic device is provided, including: a processor and a memory. The processor is connected to the memory, for example, via a bus. Op-tionally, the electronic device 4000 may further include a transceiver. The transceiver may be configured for data interaction between the electronic device and other electronic devices, for example, data transmission and/or data reception, etc. It is to be noted that, in practical applications, the number of the transceiver is not limited to 1, and the structure of the electronic device does not constitute any limitation to the embodiments of the present application.

The processor may be a central processing unit (CPU), a general-purpose processor, a digital signal processor (DSP), an application specific integrated circuit (ASIC), a field programmable gate array (FPGA) or other programmable logic devices, transistor logic devices, hardware components or any combination thereof. The processor can implement or execute various exemplary logic blocks, modules and circuits described in the disclosure of the present application. The processor may also be a combination for realizing computing functions, for example, a combination of one or more microprocessors, a combination of DSPs and microprocessors, etc.

The bus may include a passageway for transferring information between the above components. The bus may be a peripheral component interconnect (PCI) bus, an extended industry standard architecture (EISA) bus, etc. The bus may be classified into address bus, data bus, control bus, etc.

The memory may be, but not limited to, read only memories (ROMs) or other types of static storage devices capable of storing static information and instructions, random access memories (RAMs) or other types of dynamic storage devices capable of storing information and instructions, or electrically erasable programmable read only memories (EEPROMs), compact disc read only memories (CD-ROMs) or other optical disc storages, optical disc storages (including compact discs, laser discs, optical discs, digital versatile optical discs, Blue-ray discs, etc.), magnetic disc storage mediums or other magnetic storage devices, or any other media that can be used to carry or store computer programs and can be accessed by a computer.

The memory is configured to store compute programs for executing the embodiments of the present application, and is controlled and executed by the processor 4001. The processor is configured to execute the computer programs stored in the memory to implement the steps in the above method embodiments.

Wherein, the electronic devices include, but not limited to, terminal devices such as fixed terminals and/or mobile terminals, for example, mobile phones, tablet computers, notebook computers, wearable devices, game consoles, desktop computers, all-in-one computers, in-vehicle terminals, robots, etc.

In the embodiments of the present application, among the methods executed in the electronic device, the method for estimating, inferring, or predicting whether to monitor signals or whether to transmit signals may be executed by inputting corresponding parameter data using artificial intelligence models. The processor of the electronic device can preprocess the data to convert it into a form suitable for use as input to the artificial intelligence models. AI models may be obtained by training. Here, “obtained by training” means that predefined operating rules or artificial intelligence models configured to perform desired features (or purposes) are obtained by training a basic artificial intelligence model with multiple pieces of training data by training algorithms. AI models may include multiple neural network layers. Each of the multiple network layers includes a plurality of weight values, and the neural network calculation is performed by calculation between the calculation result of the previous layer and a plurality of weight values.

Estimation, inferring or prediction is a technique for logical reasoning and prediction by determined information, including, but not limited to, for example, knowledge-based inferring, optimization prediction, preference-based planning or recom-mendation, etc.

Embodiments of the present application provide a computer-readable storage medium having computer programs stored thereon that, when executed by a processor, can implement the steps and corresponding contents in the above method embodiments.

Embodiments of the present application further provide a computer program product including computer programs that, when executed by a processor, can implement the steps and corresponding contents in the above method embodiments.

The terms “first”, “second”, “third”, “fourth”, “1”, “2”, etc. in the specification and claims of the present application and the accompanying drawings are used for distinguishing similar objects, rather than describing a particular order or precedence. It should be understood that the used data can be interchanged if appropriate, so that the embodiments of the present application described herein can be implemented in an order other than the orders illustrated or described with text.

It should be understood that, although the operation steps are indicated by arrows in the flowcharts of the embodiments of the present application, the implementation order of these steps is not limited to the order indicated by the arrows. Unless otherwise ex-plicitly stated herein, in some implementation scenarios of the embodiments of the present application, the implementation steps in the flowcharts may be executed in other orders as required. In addition, depending on practical implementation scenarios, some or all of the steps in the flowcharts may include a plurality of sub-steps or a plurality of stages. Some or all of these sub-steps or stages may be executed at the same moment, and each of these sub-steps or stages may be separately executed at a different moment. When each of these sub-steps or stages is executed at a different moment, the execution order of these sub-steps or stages may be flexibly configured as required, and will not be limited in the embodiments of the present application.

The foregoing description merely shows the optional implementations of some implementation scenarios of the present application. It should be pointed out that, for a person of ordinary skill in the art, without departing from the technical idea of the solutions of the present application, other similar implementation means based on the technical idea of the present application shall also fall into the protection scope of the embodiments of the present application.

1. A method performed by a user equipment (UE) in a communication system, comprising:
obtaining a first output result by inputting a first input parameter related to a to-be-monitored time unit into a first model; and
determining, based on the first output result, whether to monitor a first signal transmitted by a network entity within the to-be-monitored time unit.

2. The method according to claim 1, further comprising:
obtaining the first output result respectively corresponding to at least one service, by respectively inputting the first input parameter related to the at least one service into the first model respectively corresponding to the at least one service; and
determining, based on the first output result respectively corresponding to the at least one service, whether to monitor the first signal within the to-be-monitored time unit.

3. The method according to claim 1, further comprising:
obtaining the first model in at least one of the following ways:
training, based on collected first data set, to generate the first model; and
receiving the first model from a network entity.

4. The method according to claim 3, wherein the receiving the first model further comprises:
receiving, a first message transmitted by the network entity, the first message comprising at least one of the following:
information related to models;
indication information of applicable services;
first assistant information, the first assistant information is used to assist the UE to generate an input parameter of the first model and/or to assist the UE to perform the first model;
indication information of applicable UEs;
fallback indication information;
indication information of applicable areas;
indication information of applicable rates; or
activation indication information.

5. The method according to claim 1, the first input parameter related to the to-be-monitored time unit, comprising at least one of the following:
accumulation rate related information;
a predicted accumulation rate;
scheduling probability indication related information;
non-scheduling indication related information;
Quality of Service (QoS) indication related information;
indication information of a service type; or
indication information of predicated QoS.

6. The method according to claim 1, the network entity comprising at least one of the following: a base station, a centralized unit of the base station, a control plane of the centralized unit of the base station, a distribution unit of the base station, a wireless access network intelligent controller near real-time layer, a network data analysis function entity, an operation administration and maintenance entity and an artificial intelligent entity.

7. A method performed by a network entity in a communication system, comprising:
obtaining a second output result by inputting a second input parameter related to a to-be-monitored time unit of a first user equipment UE into a second model; and
determining, based on the second output result, whether to transmit a second signal to the first UE or whether to select the first UE for scheduling within the to-be-monitored time unit.

8. The method according to claim 7, wherein the obtaining the second output result comprises at least one of the following operations:
obtaining the second output result respectively corresponding to at least one service, by respectively inputting the second input parameter related to the at least one service into the second model respectively corresponding to the at least one service; and
obtaining the second output result respectively corresponding to the at least one first UE, by respectively inputting the second input parameter related to the at least one first UE into the second model respectively corresponding to the at least one first UE;
the determining, based on the second output result, whether to transmit the signal to the first UE or whether to select the first UE for scheduling within the current time unit comprises at least one of the following operations:
determining, based on the second output result respectively corresponding to the at least one service, whether to transmit the signal to the first UE or whether to select the first UE for scheduling within the current time unit; and
determining, based on the second output result respectively corresponding to the at least one first UE, whether to transmit the signal to the at least one first UE or whether to select the first UE for scheduling within the current time unit.

9. The method according to claim 7, further comprising:
training, based on collected second data set, to generate the second model; and
training, based on collected third data set, to generate a first model, and transmitting the first model to a second UE.

10. The method according to claim 9, wherein the transmitting the first model to the second UE, further comprises:
transmitting a first message to the second UE, the first message comprising at least one of the following:
information related to models;
indication information of applicable services;
first assistant information, the first assistant information is used to assist the UE to generate an input parameter of the first model and/or to assist the UE to perform the first model;
indication information of applicable UEs;
fallback indication information;
indication information of applicable areas;
indication information of applicable rates; or
activation indication information.

11. The method according to claim 9, the method further comprising:
it is determined, that the second UE for which the first model needs to be updated by the at least one of the following information:
a detection result of a network performance of the second UE in using the first model and a tenth threshold value;
a detection result of the UE performance of the second UE in using the first model and an eleventh threshold value; and
the number of update times of the first model of the second UE and a twelfth threshold value.

12. The method according to claim 7, wherein, if it is determined based on the second output result that the second signal is transmitted to multiple UEs or multiple UEs are selected for scheduling within the to-be-monitored time unit, the method further comprises at least one of the following situations:
scheduling, by a scheduling algorithm, the multiple UEs and/or UEs for which a first model is not deployed; and
allocating, by a scheduling algorithm, resources to the multiple UEs and/or UEs for which a first model is not deployed.

13. The method according to claim 7, wherein a second input parameter related to the to-be-monitored time unit of the first UE comprises at least one of the following:
accumulation rate related information;
a predicted accumulation rate;
scheduling probability indication related information;
non-scheduling indication related information;
Quality of Service (QoS) indication related information;
indication information of a service type; or
indication information of predicated QoS.

14. A user equipment, comprising:
a transceiver configured to transmit and receive signals; and
a controller coupled to the transceiver and configured to control to:
obtain a first output result by inputting a first input parameter related to a to-be-monitored time unit into a first model, and
determine, based on the first output result, whether to monitor a first signal transmitted by a network entity within the to-be-monitored time unit.

15. A network entity, comprising:
a transceiver configured to transmit and receive signals; and
a controller coupled to the transceiver and configured to control to:
obtain a second output result by inputting a second input parameter related to a to-be-monitored time unit of a first user equipment UE into a second model, and
determine, based on the second output result, whether to transmit a second signal to the first UE or whether to select the first UE for scheduling within the to-be-monitored time unit.
